(19) United States
(12) Patent Application Publication
(10) Pub. No.: US 2006/0166149 A1
(43) Pub. Date: Jul. 27, 2006

(54) Silver halide color photosensitive material

(75) Inventors: Ryoji Nishimura, Minamiashigara-shi (JP); Junichiro Hosokawa, Minamiashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/337,509

(22) Filed: Jan. 24, 2006

(30) Foreign Application Priority Data
Jan. 24, 2005 (JP) 2005-016197

(51) Int. Cl. G03C 1/46

(52) U.S. Cl. 430/502

(57) ABSTRACT

A silver halide color photosensitive material containing at least one compound selected from the below defined compound (A-1) and/or (A-2) which does not substantially react with a developing agent oxidation product, and which is capable of substantially enhancing the sensitivity of the photosensitive material by addition thereof as compared with that exhibited when the compound is not added, and at least one compound represented by the below defined general formula (B), compound (A-1): a heterocyclic compound having 1 or 2 hetero atoms; and compound (A-2): a compound selected from an oxadiazole derivative, a thiadiazole derivative and 1,2,4-triazole derivative having an amino group, and general formula (B): Rf-X-M wherein Rf represents an alkyl group having 1 to 6 carbons which is substituted with at least one fluorine atom; X represents a divalent coupling group or a single bond; and M represents an anionic group, a cationic group or a betaine group.

### CROSS-REFERENCE TO RELATED APPLICATIONS

This application is based upon and claims the benefit of priority from prior Japanese Patent Application No. 2005-016197, filed Jan. 24, 2005, the entire contents of which are incorporated herein by reference.

### BACKGROUND OF THE INVENTION

1. Field of the Invention

The present invention relates to a silver halide color photosensitive material, and more specifically, relates to a photosensitive material with high sensitivity and excellent in antistatic property and improving storability.

2. Description of the Related Art

High sensitization has been further required for a silver halide color photosensitive material in order to enhance the user benefit of a color negative film. Since a film with a lens which can easily and simply correspond to various exposure conditions and a compact camera with zooming function become recently widespread, a high sensitive film with a specific sensitivity (ISO sensitivity) of 800 or more has been regularly used.

The sensitization of a film enabled the expansion of photographing area in a photosensitive material such as photographing without using a strobe light in a dark room, photographing for sport photo at high speed shutter using a telescopic lens and photographing for astronomical photo which requires exposure for a long time, and as a result, bring about great merit to a user. Consequently, the sensitization of a film is one of eternal themes which are imposed on the business field.

Since a late high sensitive film has been in situation that it provided only a film with low image quality exceeding the limit of user's patience by far because of seeking high sensitivity, a user made decision to take the choice between sensitivity and image quality and as a result, could not but select the image quality rather than sensitivity.

In order to highly sensitize the photosensitive material, it is a usual measure to increase the size of silver halide particles which are sensitive elements and further, to use it in combination with other high sensitization technique on the business field. When the size of silver halide particles is increased, the sensitivity is raised to a certain degree, but the number of silver halide particles is decreased so far as the content of silver halide is constant; namely, it has defects that the number of the initiation points of development is decreased and graininess is greatly damaged.

Further, considering these defects, when the particle number of silver halide per a unit area is designed to be increased, namely, the amount of silver halide coated in the photosensitive material is increased, problems are generated that the deterioration of photo performance such as the increase of fogging, the lowering of sensitivity and the deterioration of graininess occurs until it is used after production of the photosensitive material. It is the most basic and important subject for the business field to increase sensitivity without deteriorate the graininess in order to improve the image quality of the photosensitive material.

There has been disclosed a technique of increasing the sensitivity without deteriorating the graininess by containing a compound having at least 3 of hetero atoms in a silver halide color photosensitive material (see, for example, Jpn. Pat. Appln. KOKAI Publication No. (hereinafter referred to as JP-A-) 2000-194085 and JP-A-2004-226971).

However, although sensitivity is increased by the above-mentioned method, its effect is not adequate, and undesirable exposure traces called as static mark are occasionally generated, and new problems are cleared that the applicability of high speed coating and the storability of a photosensitive material are deteriorated.

The photosensitive material is brought in contact with various substances during production, photographing and development processing. For example, when the photosensitive material is in a state in which it was wound up at a processing step, a back layer formed on the rear face of a support is occasionally brought in contact with a surface layer. Further, when the photosensitive material is transferred at a processing step, it can be brought in contact with a stainless steel, a rubber roller and the like. When it is brought in contact with these materials, the surface (a gelatin layer) of the photosensitive material is easily charged to positive and since unnecessary electric discharge occurs occasionally, it causes undesirable exposure trace (static mark) on the photosensitive material. A compound containing a fluorine atom is effective for reducing the charging property of gelatin and the addition of a fluorine base surfactant is often carried out. For example, refer to JP-A-49-46733, JP-A-51-32322, JP-A-57-64228, JP-A-60-128434, JP-A-64-536, JP-A-2-141739, JP-A-3-95550, JP-A-4-248543, JP-A-61-173248, and JP-A-62-166334.

A surfactant having a fluorinated alkyl chain can carry out various surface modifications by the peculiar properties of the fluorinated alkyl chain (water-shedding quality, oil-shedding quality, lubricity, antistatic property and the like) and is used for the surface treatment of wide substrates such as a textile, a cloth, a carpet and a resin. Further, when the surfactant having a fluorinated alkyl chain (hereinafter, called as fluorine base surfactant) is added to the aqueous medium solution of various substrates, a uniform film without “splash” can be not only formed at formation of a coating film, but also the adsorption layer of the surfactant can be formed on the surface, and thereby the peculiar property possessed by the above-mentioned fluorinated alkyl chain can be imparted on the surface of a coated film. Here, “splash” means phenomenon in which circular or streak uncoated portions are generated caused by coagulants which were generated at production stage in the coating solution of a protective layer by addition and inclusion of various compounds.

Various surfactants are also used in a photosensitive material and play an important role. The photosensitive material is prepared by respectively coating a plural number of coating solutions containing the aqueous solution of a hydrophilic colloid binder (for example, gelatin), on a support and forming a plural number of layers. A plural number of hydrophilic colloid layers are simultaneously coated in multi-layers. These layers include an antistatic layer, an under-coat layer, a halation preventive layer, a silver halide emulsion layer, an intermediate layer, a filter layer, a protective layer and the like and various materials for expressing respective functions are added to the respective layers. Further, in order to improve the physical property of a film, hydrophilic colloid layers contain also occasionally polymer latex. Further, these materials are emulsified and dispersed in the hydrophilic colloid solution to be used for preparation of coating solutions, as they are, or in a state in which they are dissolved in an organic solvent with high boiling point such as a phosphorate base compound and a phthalic acid ester compound so that the hydrophilic colloid layers contain functional compounds which are hardly soluble in water such as a color coupler, an ultraviolet absorbent, a brightening agent and a lubricant. Thus, the photosensitive material is generally composed of various hydrophilic colloids and it is required that the coating solution containing various materials is uniformly coated in high speed at production without faults such as “splash” and coating unevenness.

Thus, the surfactant, specifically, the fluorine base surfactant is used as material having both functions of a coating aid for imparting the uniformity of a coated film or of imparting the antistatic property of the photosensitive material.

However, these materials have not always performance satisfying the request of high sensitization and storability while having the preferable charging property of the photosensitive material.

### BRIEF SUMMARY OF THE INVENTION

It is the subject of the present invention to provide a photosensitive material excellent in high sensitivity and antistatic property and improving static resistance. Further, it is the subject of the present invention to provide a photosensitive material imparting high speed coating applicability and preservative improvement.

The present inventors have intensively studied and as a result, can provide a photosensitive material with high sensitivity and excellent in charging property, high speed coating applicability and storability.

(1) A silver halide color photosensitive material comprising a support and, superimposed thereon, at least one red-sensitive layer, at least one green-sensitive layer, at least one blue-sensitive layer and at least one protective layer, containing at least one compound selected from the below defined compound (A-1) and/or (A-2) which does not substantially react with a developing agent oxidation product, and which is capable of substantially enhancing the sensitivity of the silver halide photosensitive material by addition thereof as compared with that exhibited when the compound is not added, and at least one compound represented by the below defined general formula (B),

compound (A-1): a heterocyclic compound having 1 or 2 hetero atoms; and

compound (A-2): a compound selected from an oxadiazole derivative, a thiadiazole derivative and 1,2,4-triazole derivative having an amino group, and

general formula (B): Rf-X-M

wherein Rf represents an alkyl group having 1 to 6 carbons which is substituted with at least one fluorine atom; X represents a divalent coupling group or a single bond; and M represents an anionic group, a cationic group or a betaine group.

(2) The silver halide color photosensitive material according to item (1) above, having an ISO sensitivity of 800 or more.

(3) The silver halide color photosensitive material according to item (1) above, wherein the ClogP of compound (A-2) is 6.2 or more.

(4) The silver halide color photosensitive material according to item (3) above, wherein the ClogP of compound (A-2) is 7.8 or more.

(5) The silver halide color photosensitive material according to item (4) above, having an ISO sensitivity of 800 or more.

### DETAILED DESCRIPTION OF THE INVENTION

Compounds (A-1) and (A-2) of the present invention will be described below.

The compound of the present invention is a compound characteristic of substantially unreactive with developing agent oxidation products. Compounds “substantially unreactive with developing agent oxidation products” mean those which induce no marked direct chemical reaction or redox reaction with developing agent oxidation products and further those which are not couplers, being incapable of reacting with developing agent oxidation products to form dyes or other products.

The reactivity (CRV) of compounds of the present invention with developing agent oxidation products is determined in the following manner.

Test sensitive material (T) was exposed to white light and processed in the same manner as described in Example 1 except that the processing time in color development step was changed to 1 min 15 sec. The magenta density and cyan density of the sensitive material were measured, and the respective differences from the magenta density and cyan density of sensitive material containing none of compounds of the present invention were calculated.

CRV of the compound selected from compounds (A-1) and (A-2) of the present invention is preferably 0.01 or less, more preferably 0.

Test sensitive material (T)

(Support) cellulose triacetate

(Emulsion layer)

| | | |
|---|---|---|
| Em-B in terms of Ag | 1.07 | g/m² |
| Gelatin | 2.33 | g/m² |
| ExC-1 | 0.76 | g/m² |
| ExC-4 | 0.42 | g/m² |
| Tricresyl phosphate | 0.62 | g/m² |
| Compound (A-1) or (A-2) | 3.9 × 10⁻⁴ | mol/m² |
| of invention | | |

(Protective layer)

| | | |
|---|---|---|
| Gelatin | 2.00 | g/m² |
| H-1 | 0.33 | g/m² |
| B-1 (diam. 1.7 μm) | 0.10 | g/m² |
| B-2 (diam. 1.7 μm) | 0.30 | g/m² |
| B-3 | 0.10 | g/m² |

The characteristics of emulsion Em-B and structural formulae of compounds employed in the above test sensitive material (A) were specified in Example 1 described later.

The compound of the present invention is characteristic of being capable of substantially enhancing the sensitivity of the silver halide color photographic material by addition thereof as compared with that exhibited when the compound is not added.

As described in the background of the invention, generally, the photographic speed depends on the size of silver halide emulsion grains. The larger the emulsion grains, the higher the photographic speed. However, the graininess is deteriorated in accordance with an increase of the size of silver halide grains. Therefore, the speed and the graininess fall in trade-off relationship.

The speed increase can be accomplished by the method of increasing coupler activity or the method of decreasing the amount of development inhibitor release coupler (DIR coupler) as well as the above increasing of the size of silver halide emulsion grains. However, when the speed increase is effected by these methods, graininess deterioration accompanies the same. These methods of changing of the size of emulsion grains, regulation of coupler activity and regulation of the amount of DIR coupler, in speed/graininess trade-off relationship, provide only “regulatory means” for deteriorating graininess while increasing speed, or improving graininess while lowering speed.

In the present invention, “enhancing the sensitivity” is not intended to provide a method of speed increase accompanied by graininess deterioration matching the speed increase.

According to the present invention, there is provided a method of speed increase not accompanied by graininess deterioration, or a method of speed increase wherein the speed increase is conspicuous as compared with graininess deterioration. In the present invention, when speed increase and graininess deterioration simultaneously occur, speed comparison is effected after graininess matching conducted by the above “regulatory means” to thereby find a substantial speed increase.

The substantial photographic speed increase is defined as exhibiting a speed difference of 0.02 or greater when photosensitive materials are exposed through continuous wedge and the speeds, in terms of the logarithm of inverse number of exposure intensity realizing minimum density+0.15, thereof are compared.

In the present invention, when any specified moiety is referred to as “group”, it is meant that the moiety per se may be unsubstituted or have one or more (up to possible largest number) substituents. For example, the “alkyl group” refers to a substituted or unsubstituted alkyl group. The substituents which can be employed in the compounds of the present invention are not limited irrespective of the existence of substitution.

When these substituents are referred to as W, the substituents represented by W are not particularly limited. As such, there can be mentioned, for example, halogen atoms, alkyl groups (including a cycloalkyl group, a bicycloalkyl group and a tricycloalkyl group), alkenyl groups (including a cycloalkenyl group and a bicycloalkenyl group), alkynyl groups, aryl groups, heterocyclic groups, a cyano group, a hydroxyl group, a nitro group, a carboxyl group, alkoxy groups, aryloxy groups, a silyloxy group, heterocyclic oxy groups, acyloxy groups, a carbamoyloxy group, alkoxycarbonyloxy groups, aryloxycarbonyloxy groups, amino groups (including alkylamino groups, arylamino groups and heterocyclic amino groups), an ammonio group, acylamino groups, an aminocarbonylamino group, alkoxycarbonylamino groups, aryloxycarbonylamino groups, a sulfamoylamino group, alkyl- or arylsulfonylamino group, a mercapto group, alkylthio groups, arylthio groups, heterocyclic thio groups, a sulfamoyl group, a sulfo group, alkyl- or arylsulfinyl groups, alkyl- or arylsulfonyl groups, acyl groups, aryloxycarbonyl groups, alkoxycarbonyl groups, a carbamoyl group, aryl- or heterocyclic azo groups, an imido group, a phosphino group, a phosphinyl group, a phosphinyloxy group, a phosphinylamino group, a phosphono group, a silyl group, a hydrazino group, a ureido group, a borate group (—B(OH)₂), a phosphate group (—OPO(OH)₂), a sulfato group (—OSO₃H) and other common substituents.

More specifically, W can represent any of halogen atoms (e.g., a fluorine atom, a chlorine atom, a bromine atom and an iodine atom); alkyl groups [each being a linear, branched or cyclic substituted or unsubstituted alkyl group, and including an alkyl group (preferably an alkyl group having 1 to 30 carbon atoms, such as methyl, ethyl, n-propyl, isopropyl, t-butyl, n-octyl, eicosyl, 2-chloroethyl, 2-cyanoethyl or 2-ethylhexyl), a cycloalkyl group (preferably a substituted or unsubstituted cycloalkyl group having 3 to 30 carbon atoms, such as cyclohexyl, cyclopentyl or 4-n-dodecylcyclohexyl), a bicycloalkyl group (preferably a substituted or unsubstituted bicycloalkyl group having 5 to 30 carbon atoms, which is a monovalent group corresponding to a bicycloalkane having 5 to 30 carbon atoms from which one hydrogen atom is removed, such as bicyclo[1,2,2]heptan-2-yl or bicyclo[2,2,2]octan-3-yl), and a tricyclo or more cycle structure; the alkyl contained in the following substituents (for example, alkyl of alkylthio group) means the alkyl group of this concept, which however further includes an alkenyl group and an alkynyl group]; alkenyl groups [each being a linear, branched or cyclic substituted or unsubstituted alkenyl group, and including an alkenyl group (preferably a substituted or unsubstituted alkenyl group having 2 to 30 carbon atoms, such as vinyl, allyl, pulenyl, geranyl or oleyl), a cycloalkenyl group (preferably a substituted or unsubstituted cycloalkenyl group having 3 to 30 carbon atoms, which is a monovalent group corresponding to a cycloalkene having 3 to 30 carbon atoms from which one hydrogen atom is removed, such as 2-cyclopenten-1-yl or 2-cyclohexen-1-yl), and a bicycloalkenyl group (substituted or unsubstituted bicycloalkenyl group, preferably a substituted or unsubstituted bicycloalkenyl group having 5 to 30 carbon atoms, which is a monovalent group corresponding to a bicycloalkene having one double bond from which one hydrogen atom is removed, such as bicyclo[2,2,1]hept-2-en-1-yl or bicyclo[2,2,2]oct-2-en-4-yl)]; alkynyl groups (preferably a substituted or unsubstituted alkynyl group having 2 to 30 carbon atoms, such as ethynyl, propargyl or trimethylsilylethynyl); aryl groups (preferably a substituted or unsubstituted aryl group having 6 to 30 carbon atoms, such as phenyl, p-tolyl, naphthyl, m-chlorophenyl or o-hexadecanoylaminophenyl); heterocyclic groups (preferably a monovalent group corresponding to a 5- or 6-membered substituted or unsubstituted aromatic or nonaromatic heterocyclic compound from which one hydrogen atom is removed (the monovalent group may be condensed with a benzene ring, etc.), more preferably a 5- or 6-membered aromatic heterocyclic group having 3 to 30 carbon atoms, such as 2-furyl, 2-thienyl, 2-pyrimidinyl or 2-benzothiazolyl (the heterocyclic group may be a cationic heterocyclic group such as 1-methyl-2-pyridinio or 1-methyl-2-quinolinio)); a cyano group; a hydroxyl group; a nitro group; a carboxyl group; alkoxy groups (preferably a substituted or unsubstituted alkoxy group having 1 to 30 carbon atoms, such as methoxy, ethoxy, isopropoxy, t-butoxy, n-octyloxy or 2-methoxyethoxy); aryloxy groups (preferably a substituted or unsubstituted aryloxy group having 6 to 30 carbon atoms, such as phenoxy, 2-methylphenoxy, 4-t-butylphenoxy, 3-nitrophenoxy or 2-tetradecanoylaminophenoxy); silyloxy groups (preferably a silyloxy group having 3 to 20 carbon atoms, such as trimethylsilyloxy or t-butyldimethylsilyloxy); heterocyclic oxy groups (preferably a substituted or unsubstituted heterocyclic oxy group having 2 to 30 carbon atoms, such as 1-phenyltetrazol-5-oxy or 2-tetrahydropyranyloxy); acyloxy groups (preferably a formyloxy group, a substituted or unsubstituted alkylcarbonyloxy group having 2 to 30 carbon atoms or a substituted or unsubstituted arylcarbonyloxy group having 7 to 30 carbon atoms, such as formyloxy, acetyloxy, pivaloyloxy, stearoyloxy, benzoyloxy or p-methoxyphenylcarbonyloxy); carbamoyloxy groups (preferably a substituted or unsubstituted carbamoyloxy group having 1 to 30 carbon atoms, such as N,N-dimethylcarbamoyloxy, N,N-diethylcarbamoyloxy, morpholinocarbonyloxy, N,N-di-n-octylaminocarbonyloxy or N-n-octylcarbamoyloxy); alkoxycarbonyloxy groups (preferably a substituted or unsubstituted alkoxycarbonyloxy group having 2 to 30 carbon atoms, such as methoxycarbonyloxy, ethoxycarbonyloxy, t-butoxycarbonyloxy or n-octylcarbonyloxy); aryloxycarbonyloxy groups (preferably a substituted or unsubstituted aryloxycarbonyloxy group having 7 to 30 carbon atoms, such as phenoxycarbonyloxy, p-methoxyphenoxycarbonyloxy or p-n-hexadecyloxyphenoxycarbonyloxy); amino groups (preferably an amino group, a substituted or unsubstituted alkylamino group having 1 to 30 carbon atoms or a substituted or unsubstituted arylamino group having 6 to 30 carbon atoms, such as amino, methylamino, dimethylamino, anilino, N-methylanilino or diphenylamino); ammonio groups (preferably an ammonio group or an ammonio group substituted with a substituted or unsubstituted alkyl, aryl or heterocycle having 1 to 30 carbon atoms, such as trimethylammonio, triethylammonio or diphenylmethylammonio), acylamino groups (preferably an formylamino group, a substituted or unsubstituted alkylcarbonylamino group having 1 to 30 carbon atoms or a substituted or unsubstituted arylcarbonylamino group having 6 to 30 carbon atoms, such as formylamino, acetylamino, pivaloylamino, lauroylamino, benzoylamino or 3,4,5-tri-n-octyloxyphenylcarbonylamino); aminocarbonylamino groups (preferably a substituted or unsubstituted aminocarbonylamino group having 1 to 30 carbon atoms, such as carbamoylamino, N,N-dimethylaminocarbonylamino, N,N-diethylaminocarbonylamino or morpholinocarbonylamino); alkoxycarbonylamino groups (preferably a substituted or unsubstituted alkoxycarbonylamino group having 2 to 30 carbon atoms, such as methoxycarbonylamino, ethoxycarbonylamino, t-butoxycarbonylamino, n-octadecyloxycarbonylamino or N-methyl-methoxycarbonylamino); aryloxycarbonylamino groups (preferably a substituted or unsubstituted aryloxycarbonylamino group having 7 to 30 carbon atoms, such as phenoxycarbonylamino, p-chlorophenoxycarbonylamino or m-n-octyloxyphenoxycarbonylamino); sulfamoylamino groups (preferably a substituted or unsubstituted sulfamoylamino group having 0 to 30 carbon atoms, such as sulfamoylamino, N,N-dimethylaminosulfonylamino or N-n-octylaminosulfonylamino); alkyl- or arylsulfonylamino groups (preferably a substituted or unsubstituted alkylsulfonylamino group having 1 to 30 carbon atoms or a substituted or unsubstituted arylsulfonylamino group having 6 to 30 carbon atoms, such as methylsulfonylamino, butylsulfonylamino, phenylsulfonylamino, 2,3,5-trichlorophenylsulfonylamino or p-methylphenylsulfonylamino); a mercapto group; alkylthio groups (preferably a substituted or unsubstituted alkylthio group having 1 to 30 carbon atoms, such as methylthio, ethylthio or n-hexadecylthio); arylthio groups (preferably a substituted or unsubstituted arylthio group having 6 to 30 carbon atoms, such as phenylthio, p-chlorophenylthio or m-methoxyphenylthio); heterocyclic thio groups (preferably a substituted or unsubstituted heterocyclic thio group having 2 to 30 carbon atoms, such as 2-benzothiazolylthio or 1-phenyltetrazol-5-ylthio); sulfamoyl groups (preferably a substituted or unsubstituted sulfamoyl group having 0 to 30 carbon atoms, such as N-ethylsulfamoyl, N-(3-dodecyloxypropyl)sulfamoyl, N,N-dimethylsulfamoyl, N-acetylsulfamoyl, N-benzoylsulfamoyl or N-(N′-phenylcarbamoyl)sulfamoyl); a sulfo group; alkyl- or arylsulfinyl groups (preferably a substituted or unsubstituted alkylsulfinyl group having 1 to 30 carbon atoms or a substituted or unsubstituted arylsulfinyl group having 6 to 30 carbon atoms, such as methylsulfinyl, ethylsulfinyl, phenylsulfinyl or p-methylphenylsulfinyl); alkyl- or arylsulfonyl groups (preferably a substituted or unsubstituted alkylsulfonyl group having 1 to 30 carbon atoms or a substituted or unsubstituted arylsulfonyl group having 6 to 30 carbon atoms, such as methylsulfonyl, ethylsulfonyl, phenylsulfonyl or p-methylphenylsulfonyl); acyl groups (preferably a formyl group, a substituted or unsubstituted alkylcarbonyl group having 2 to 30 carbon atoms, a substituted or unsubstituted arylcarbonyl group having 7 to 30 carbon atoms or a substituted or unsubstituted heterocyclic carbonyl group having 4 to 30 carbon atoms wherein carbonyl is bonded with carbon atom thereof, such as acetyl, pivaloyl, 2-chloroacetyl, stearoyl, benzoyl, p-n-octyloxyphenylcarbonyl, 2-pyridylcarbonyl or 2-furylcarbonyl); aryloxycarbonyl groups (preferably a substituted or unsubstituted aryloxycarbonyl group having 7 to 30 carbon atoms, such as phenoxycarbonyl, o-chlorophenoxycarbonyl, m-nitrophenoxycarbonyl or p-t-butylphenoxycarbonyl); alkoxycarbonyl groups (preferably a substituted or unsubstituted alkoxycarbonyl group having 2 to 30 carbon atoms, such as methoxycarbonyl, ethoxycarbonyl, t-butoxycarbonyl or n-octadecyloxycarbonyl); carbamoyl groups (preferably a substituted or unsubstituted carbamoyl group having 1 to 30 carbon atoms, such as carbamoyl, N-methylcarbamoyl, N,N-dimethylcarbamoyl, N,N-di-n-octylcarbamoyl or N-(methylsulfonyl)carbamoyl); aryl- or heterocyclic azo groups (preferably a substituted or unsubstituted arylazo group having 6 to 30 carbon atoms or a substituted or unsubstituted heterocyclic azo group having 3 to 30 carbon atoms, such as phenylazo, p-chlorophenylazo or 5-ethylthio-1,3,4-thiadiazol-2-ylazo); imido groups (preferably N-succinimido or N-phthalimido); phosphino groups (preferably a substituted or unsubstituted phosphino group having 2 to 30 carbon atoms, such as dimethylphosphino, diphenylphosphino or methylphenoxyphosphino); phosphinyl groups (preferably a substituted or unsubstituted phosphinyl group having 2 to 30 carbon atoms, such as phosphinyl, dioctyloxyphosphinyl or diethoxyphosphinyl); phosphinyloxy groups (preferably a substituted or unsubstituted phosphinyloxy group having 2 to 30 carbon atoms, such as diphenoxyphosphinyloxy or dioctyloxyphosphinyloxy); phosphinylamino groups (preferably a substituted or unsubstituted phosphinylamino group having 2 to 30 carbon atoms, such as dimethoxyphosphinylamino or dimethylaminophosphinylamino); a phospho group; silyl groups (preferably a substituted or unsubstituted silyl group having 3 to 30 carbon atoms, such as trimethylsilyl, t-butyldimethylsilyl or phenyldimethylsilyl); hydrazino groups (preferably a substituted or unsubstituted hydrazino group having 0 to 30 carbon atoms, such as trimethylhydrazino); and ureido groups (preferably a substituted or unsubstituted ureido group having 0 to 30 carbon atoms, such as N,N-dimethylureido).

Two W's can cooperate with each other to thereby form a ring (any of aromatic or nonaromatic hydrocarbon rings and heterocycles (these can be combined into polycyclic condensed rings), for example, a benzene ring, a naphthalene ring, an anthracene ring, a phenanthrene ring, a fluorene ring, a triphenylene ring, a naphthacene ring, a biphenyl ring, a pyrrole ring, a furan ring, a thiophene ring, an imidazole ring, an oxazole ring, a thiazole ring, a pyridine ring, a pyrazine ring, a pyrimidine ring, a pyridazine ring, an indolizine ring, an indole ring, a benzofuran ring, a benzothiophene ring, an isobenzofuran ring, a quinolizine ring, a quinoline ring, a phthalazine ring, a naphthylidine ring, a quinoxaline ring, a quinoxazoline ring, an isoquinoline ring, a carbazole ring, a phenanthridine ring, an acridine ring, a phenanthroline ring, a thianthrene ring, a chromene ring, a xanthene ring, a phenoxathine ring, a phenothiazine ring or a phenazine ring).

With respect to those having hydrogen atoms among the above substituents W, the hydrogen atoms may be replaced with the above substituents. Examples of such hydrogen having substituents include a —CONHSO₂— group (sulfonylcarbamoyl or carbonylsulfamoyl), a —CONHCO-group (carbonylcarbamoyl) and a —SO₂NHSO₂— group (sulfonylsulfamoyl).

More specifically, examples of such hydrogen having substituents include an alkylcarbonylaminosulfonyl group (e.g., acetylaminosulfonyl), an arylcarbonylaminosulfonyl group (e.g., benzoylaminosulfonyl), an alkylsulfonylaminocarbonyl group (e.g., methylsulfonylaminocarbonyl) and an arylsulfonylaminocarbonyl group (e.g., p-methylphenylsulfonylaminocarbonyl).

Compound (A-1) of the present invention will be now described.

Compound (A-1) of the present invention is a heterocyclic compound having one or two heteroatoms. Heteroatom refers to atoms other than carbon and hydrogen atoms. Heterocycle refers to a cyclic compound having at least one heteroatom. The heteroatoms of the “heterocycle having one or two heteroatoms” refer to only atoms as constituents of a heterocyclic ring system, and do not mean atoms positioned outside the ring system, atoms separated through at least one nonconjugated single bond from the ring system and atoms as parts of further substituents of the ring system.

With respect to polynuclear heterocycles, those wherein the number of heteroatoms in all the ring systems is one or two are included.

Although any heterocyclic compounds satisfying the above requirements can be employed, the heteroatom is preferably a nitrogen atom, a sulfur atom, an oxygen atom, a selenium atom, a tellurium atom, a phosphorus atom, a silicon atom or a boron atom. More preferably, the heteroatom is a nitrogen atom, a sulfur atom, an oxygen atom or a selenium atom. Further more preferably, the heteroatom is a nitrogen atom, a sulfur atom or an oxygen atom. Most preferably, the heteroatom is a nitrogen atom or a sulfur atom.

Although the number of members of heterocycles is not limited, a 3- to 8-membered ring is preferred. A 5- to 7-membered ring is more preferred. A 5- or 6-membered ring is most preferred.

Although the heterocycles may be saturated or unsaturated, those having at least one unsaturated moiety are preferred. Those having at least two unsaturated moieties are more preferred. Stated in another way, although the heterocycle may be any of aromatic, pseudo-aromatic and nonaromatic heterocycles, aromatic and pseudo-aromatic heterocycles are preferred.

The specific example of these heterocycles includes a pyrrole ring, a thiophene ring, a furan ring, an imidazole ring, a pyrazole ring, a thiazole ring, an isothiazole ring, an oxazole ring, an isoxazole ring, a pyridine ring, a pyrazine ring, a pyrimidine ring, a pyridazine ring, an indolizine ring; resulting from benzo ring condensation thereof, an indole ring, a benzofuran ring, a benzothiophene ring, an isobenzofuran ring, a quinolizine ring, a quinoline ring, a phthalazine ring, a quinoxaline ring, an isoquinoline ring, a carbazole ring, a phenanthridine ring, a phenanthroline ring, an acridine ring; and resulting from partial or complete saturation thereof, a pyrrolidine ring, a pyrroline ring and an imidazoline ring, etc.

Representative examples of heterocycles will be shown below.

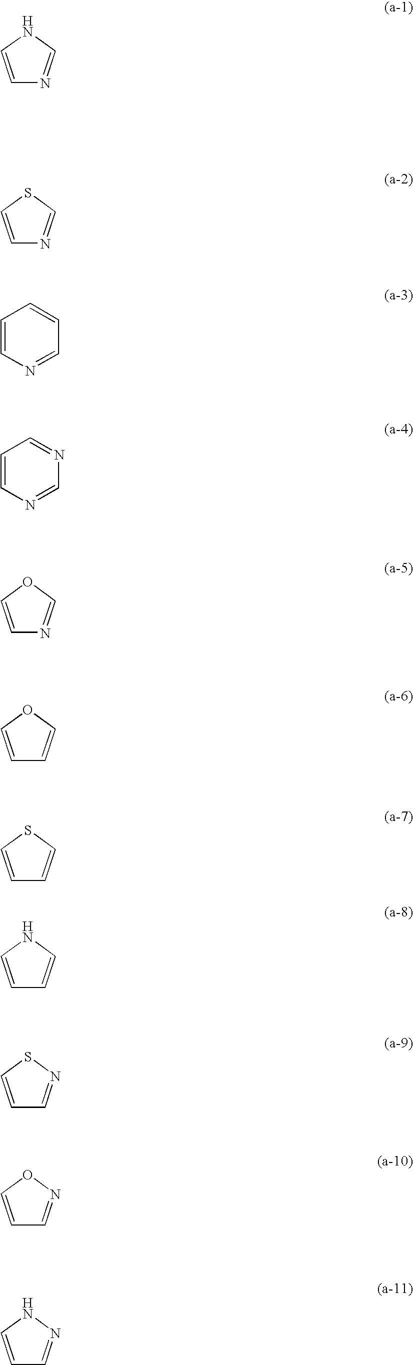

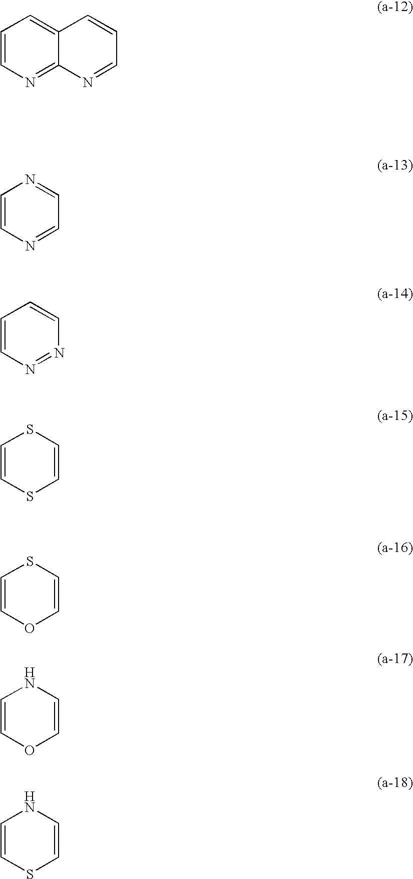

As the heterocycles resulting from benzene ring condensation, for example, the following can be shown.

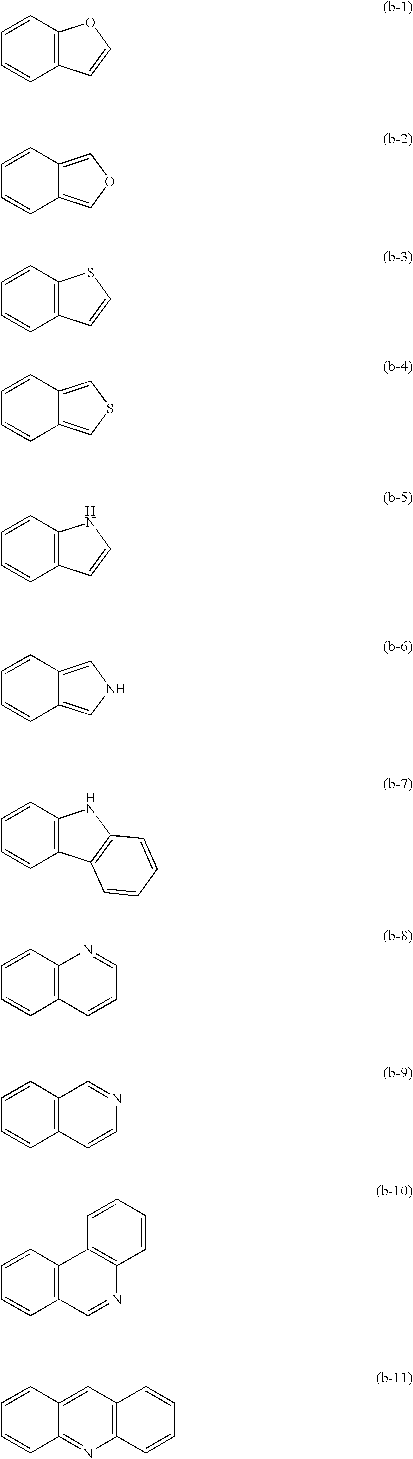

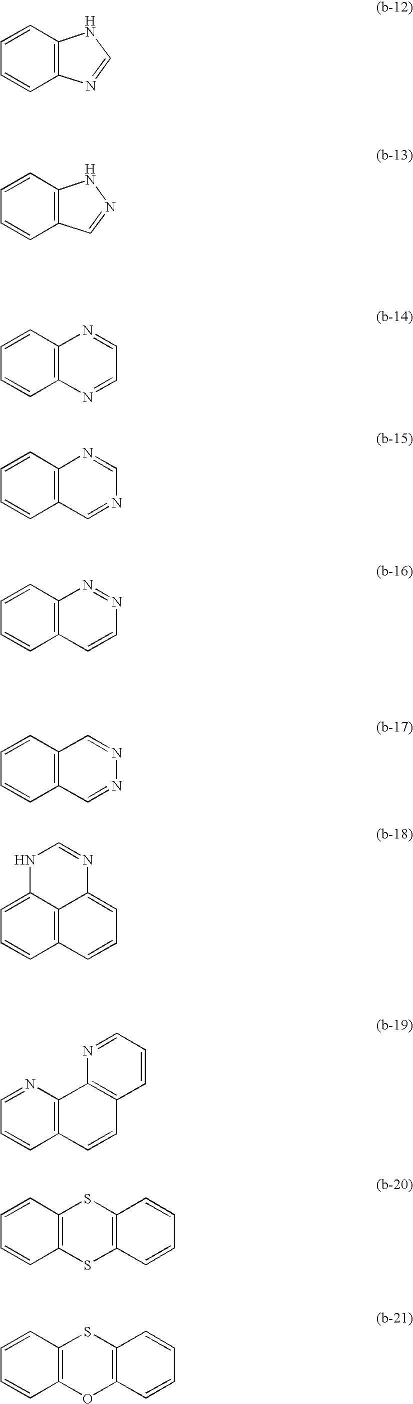

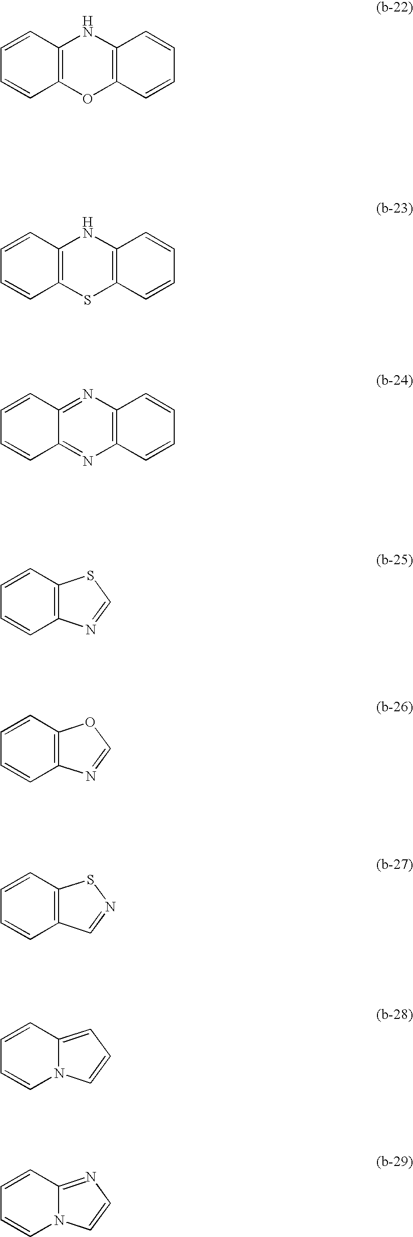

As the heterocycles resulting from partial or complete saturation, for example, the following can be shown.

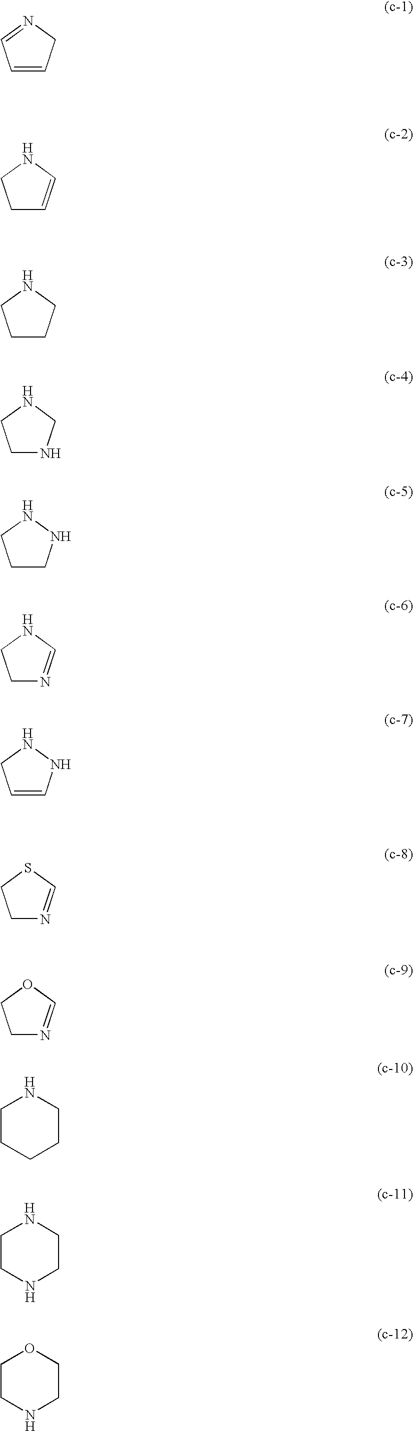

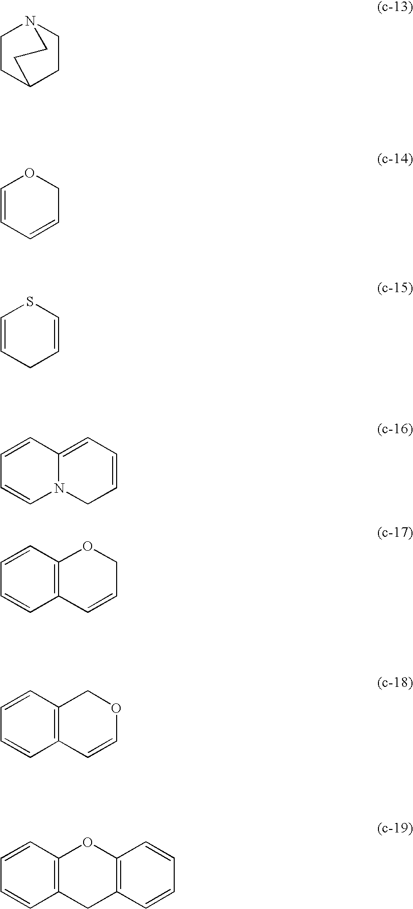

Furthermore, the following heterocycles can be used.

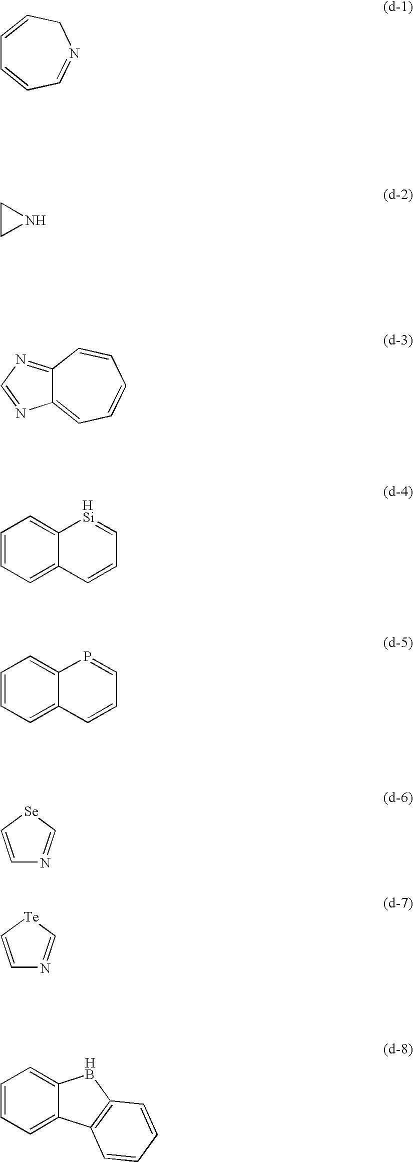

With respect to compound (A-1) of the present invention, these heterocycles, unless contrary to the definition of “heterocycle having one or two heteroatoms”, may have any substituents or may be in the form of any condensed ring. As the substituents, there can be mentioned the aforementioned W. The tertiary nitrogen atom contained in heterocycles may be substituted into a quaternary nitrogen. Moreover, any other tautomeric structures which can be drawn with respect to heterocycles are chemically equivalent to each other.

With respect to the heterocycles of the present invention, it is preferred that free thiol (—SH) and thiocarbonyl (>C═S) be in unsubstituted form.

Among the above heterocycles, heterocycles (a-1) to (a-4) are preferred. Concerning heterocycle (a-2), (b-25), resulting from benzene ring condensation thereof, is more preferred.

Among compound (A-1) of the present invention, those of the following general formula (I) are more preferred.

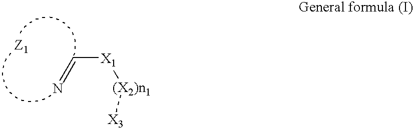

In the general formula (I), Z₁ represents a group for forming a heterocycle having one or two heteroatoms including the nitrogen atom of the formula. X₁ represents a sulfur atom, an oxygen atom, a nitrogen atom (N(Va)) or a carbon atom (C(Vb)(Vc)). Each of Va, Vb and Vc represents a hydrogen atom or a substituent. X₂ has the same meaning as that of X₁. n₁ is 0, 1, 2 or 3. When n₁ is 2 or greater, X₂ becomes multiple. It is not necessary for the multiple groups to be identical with each other. X₃ represents a sulfur atom, an oxygen atom or a nitrogen atom. The bond between X₂ and X₃ is single or double. Accordingly, X₃ may further have a substituent or a charge.

Among compounds (A-1) of the present invention, those of the following general formula (II) are most preferred.

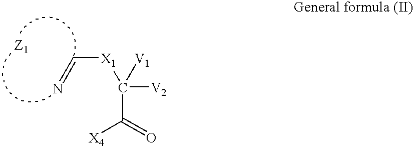

In the general formula (II), Z₁ and X₁ are as defined in the general formula (I). X₄ represents a sulfur atom (S(Vd)), an oxygen atom (O(Ve)) or a nitrogen atom (N(Vf)(Vg)). Each of Vd, Ve, Vf and Vg represents a hydrogen atom, a substituent or a negative charge. Each of V₁ and V₂ represents a hydrogen atom or a substituent.

The general formula (I) and general formula (II) will be described in detail below.

As the heterocycles formed by Zl, there can preferably be mentioned those set forth above with respect to (a-1) to (a-18), (b-1) to (b-29), (c-1) to (c-19) and (d-1) to (d-8), and preferred examples thereof are also the same. These heterocycles, unless contrary to the definition of “heterocycle having one or two heteroatoms”, may further have any substituents (for example, aforementioned W) or may be in the form of any condensed ring.

X₁ preferably represents a sulfur atom, an oxygen atom or a nitrogen atom, more preferably a sulfur atom or a nitrogen atom, and most preferably a sulfur atom. As the substituent represented by Va, Vb and Vc, there can be mentioned the aforementioned W, and preferred substituents are an alkyl group, an aryl group and a heterocyclic group. X₂ preferably represents a carbon atom. n₁ is preferably 0, 1 or 2, more preferably 2. X₃ preferably represents an oxygen atom. The valence of X₃ changes depending on whether the bond between X₂ and X₃ is single or double. For example, when the bond between X₂ and X₃ is double and X₃ is an oxygen atom, X₃ represents a carbonyl group. On the other hand, when the bond between X₂ and X₃ is single and X₃ is an oxygen atom, X₃ represents, for example, a hydroxyl group, an alkoxy group, an oxygen atom having a negative charge or the like.

X₄ preferably represents an oxygen atom. As the substituents represented by Vd, Ve, Vf and Vg, there can be mentioned those aforementioned as being represented by W. Vd, Ve and at least one of Vf and Vg preferably represent hydrogen atoms and negative charges. As the substituent represented by V₁ and V₂, there can be mentioned the aforementioned W. At least one of V₁ and V₂ is preferably not a hydrogen atom, representing a substituent.

As the substituents, there can preferably be mentioned, for example, a halogen atom (e.g., a chlorine atom, a bromine atom or a fluorine atom); an alkyl group (having 1 to 60 carbon atoms, such as methyl, ethyl, propyl, isobutyl, t-butyl, t-octyl, 1-ethylhexyl, nonyl, undecyl, pentadecyl, n-hexadecyl or 3-decanamidopropyl); an alkenyl group (having 2 to 60 carbon atoms, such as vinyl, allyl or oleyl); a cycloalkyl group (having 5 to 60 carbon atoms, such as cyclopentyl, cyclohexyl, 4-t-butylcyclohexyl, 1-indanyl or cyclododecyl); an aryl group (having 6 to 60 carbon atoms, such as phenyl, p-tolyl or naphthyl); an acylamino group (having 2 to 60 carbon atoms, such as acetylamino, n-butanamido, octanoylamino, 2-hexyldecanamido, 2-(2′,4′-di-t-amylphenoxy)butanamido, benzoylamino or nicotinamido); a sulfonamido group (having 1 to 60 carbon atoms, such as methanesulfonamido, octanesulfonamido or benzenesulfonamido); a ureido group (having 2 to 60 carbon atoms, such as decylaminocarbonylamino or di-n-octylaminocarbonylamino); a urethane group (having 2 to 60 carbon atoms, such as dodecyloxycarbonylamino, phenoxycarbonylamino or 2-ethylhexyloxycarbonylamino); an alkoxy group (having 1 to 60 carbon atoms, such as methoxy, ethoxy, butoxy, n-octyloxy, hexadecyloxy or methoxyethoxy); an aryloxy group (having 6 to 60 carbon atoms, such as phenoxy, 2,4-di-t-amylphenoxy, 4-t-octylphenoxy or naphthoxy); an alkylthio group (having 1 to 60 carbon atoms, such as methylthio, ethylthio, butylthio or hexadecylthio); an arylthio group (having 6 to 60 carbon atoms, such as phenylthio or 4-dodecyloxyphenylthio); an acyl group (having 1 to 60 carbon atoms, such as acetyl, benzoyl, butanoyl or dodecanoyl); a sulfonyl group (having 1 to 60 carbon atoms, such as methanesulfonyl, butanesulfonyl or toluenesulfonyl); a cyano group; a carbamoyl group (having 1 to 60 carbon atoms, such as N,N-dicyclohexylcarbamoyl); a sulfamoyl group (having 0 to 60 carbon atoms, such as N,N-dimethylsulfamoyl); a hydroxyl group; a sulfo group; a carboxyl group; a nitro group; an alkylamino group (having 1 to 60 carbon atoms, such as methylamino, diethylamino, octylamino or octadecylamino); an arylamino group (having 6 to 60 carbon atoms, such as phenylamino, naphthylaminor or N-methyl-N-phenylamino); a heterocyclic group (having 0 to 60 carbon atoms, preferably heterocyclic group wherein an atom selected from among a nitrogen atom, an oxygen atom and a sulfur atom is used as a heteroatom being a constituent of the ring, more preferably heterocyclic group wherein not only a heteroatom but also a carbon atom is used as constituent atoms of the ring, and especially heterocyclic group having a 3 to 8-, preferably 5 or 6-membered ring, such as heterocyclic groups listed above as being represented by W); and an acyloxy group (having 1 to 60 carbon atoms, such as formyloxy, acetyloxy, myristoyloxy or benzoyloxy).

Among these groups, the alkyl, cycloalkyl, aryl, acylamino, ureido, urethane, alkoxy, aryloxy, alkylthio, arylthio, acyl, sulfonyl, cyano, carbamoyl and sulfamoyl groups include those having substituents. Examples of such substituents include an alkyl group, a cycloalkyl group, an aryl group, an acylamino group, a ureido group, a urethane group, an alkoxy group, an aryloxy group, an alkylthio group, an arylthio group, an acyl group, a sulfonyl group, a cyano group, a carbamoyl group and a sulfamoyl group.

Among these substituents, an alkyl group, an aryl group, an alkoxy group and an aryloxy group are preferred. An alkyl group, an alkoxy group and an aryloxy group are more preferred. The most preferred substituent is a branched alkyl group.

The sum of carbon atoms of each of these substituents, although not particularly limited, is preferably in the range of 8 to 60, more preferably 10 to 57, still more preferably 12 to 55, and most preferably 16 to 53.

The compounds represented by the general formula (I) and general formula (II) are preferably those suitable for the following immobilization methods (1) to (7), more preferably immobilization method (1), (2) or (3), still more preferably immobilization method (1) or (2), and most preferably immobilization methods (1) and (2) simultaneously employed. That is, compounds simultaneously having specified pKa and ballasting group can most preferably be employed.

The compounds of the present invention can contain, when required for neutralizing the charge thereof, a required number of required cations or anions. As representative cations, there can be mentioned inorganic cations such as proton (H⁺), alkali metal ions (e.g., sodium ion, potassium ion and lithium ion) and alkaline earth metal ions (e.g., calcium ion); and organic ions such as ammonium ions (e.g., ammonium ion, tetraalkylammonium ion, triethylammonium ion, pyridinium ion, ethylpyridinium ion and 1,8-diazabicyclo[5,4,0]-7-undecenium ion). The anions can be inorganic anions or organic anions. As such, there can be mentioned halide anions (e.g., fluoride ion, chloride ion and iodide ion), substituted arylsulfonate ions (e.g., p-toluenesulfonate ion and p-chlorobenzenesulfonate ion), aryldisulfonate ions (e.g., 1,3-benzenedisulfonate ion, 1,5-naphthalenedisulfonate ion and 2,6-naphthalenedisulfonate ion), alkylsulfate ions (e.g., methylsulfate ion), sulfate ion, thiocyanate ion, perchlorate ion, tetrafluoroborate ion, picrate ion, acetate ion and trifluoromethanesulfonate ion. Further, use can be made of ionic polymers and other dyes having charges opposite to those of dyes. CO₂⁻ and SO₃⁻, when having a proton as a counter ion, can be indicated as CO₂H and SO₃H, respectively.

In the present invention, it is preferred to use combinations of individual preferred compounds (especially combinations of individual most preferred compounds) mentioned above.

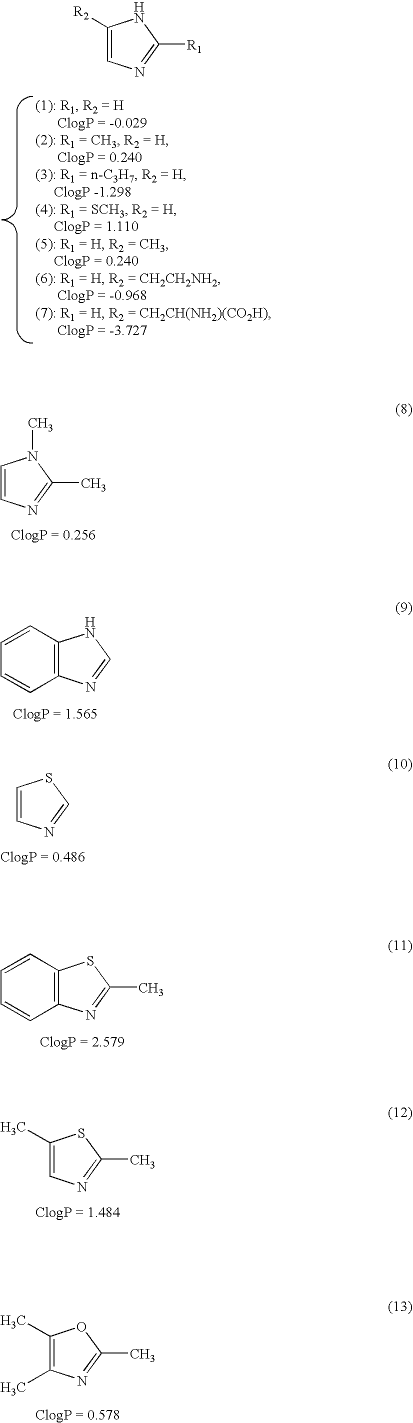

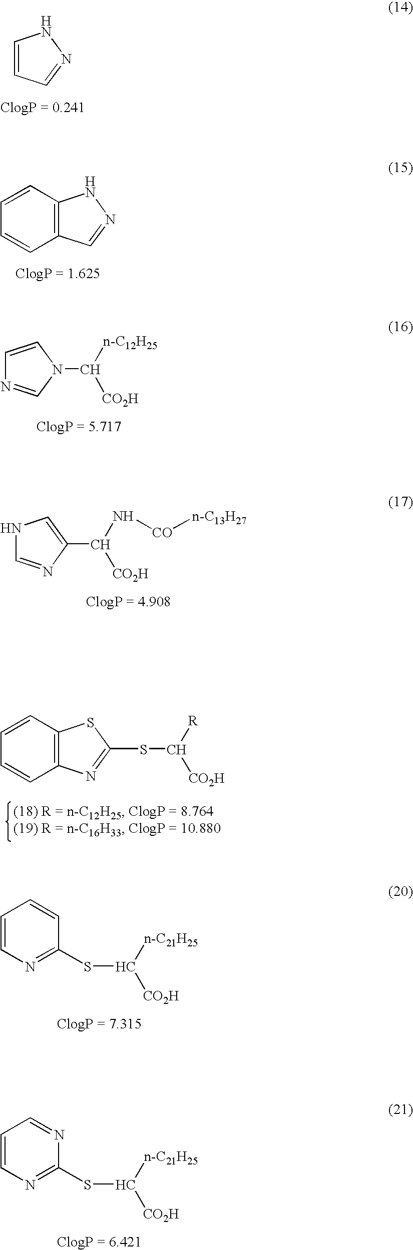

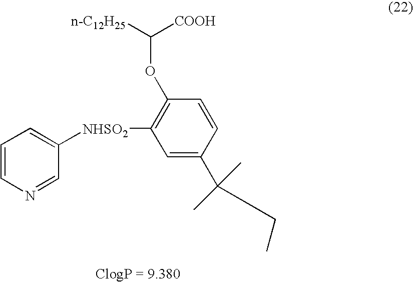

When compounds of the present invention each have two or more asymmetric carbon atoms in the molecule, there are multiple stereoisomers per any particular structure. This description involves all possible stereoisomers. In the present invention, use can be made of any one of multiple stereoisomers, or some thereof in the form of a mixture.

With respect to the compounds of the present invention, any one thereof can be used, or two or more can be used in combination. The number and type of compounds for use can be arbitrarily selected.

As the compounds of the present invention, use can be made of those described in, for example, “The Chemistry of Heterocyclic Compounds—A Series of Monographs” vol. 1-59, edited by Edward C. Taylor and Arnold Weissberger and published by John Wiley & Sons and “Heterocyclic Compounds” vol. 1-6, edited by Robert C. Elderfield and published by John Wiley & Sons. The compounds of the present invention can be synthesized by the processes described therein.

Synthetic Example: synthesis of compound (18)

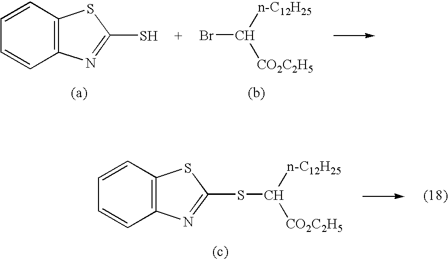

A mixture of 7.4 g of compound (a), 13.4 g of compound (b), 100 milliliters (hereinafter, milliliter also referred to as “mL”) and 10 mL of dimethylacetamide was agitated at an internal temperature of 10° C. or below while cooling with ice. 6.1 mL of triethylamine was dropped into the mixture and agitated at room temperature for 2 hr.

Thereafter, 200 mL of ethyl acetate was added to the reaction solution. Washing with a dilute aqueous NaOH solution and fractionation, washing with a dilute hydrochloric acid and fractionation and washing with a saturated saline solution and fractionation were sequentially performed, and the obtained ethyl acetate layer was dried over magnesium sulfate. Solvent was evaporated in vacuum, and the concentrate was purified through silica gel column chromatography (eluant: 19:1 hexane and ethyl acetate), thereby obtaining 16.2 g of compound (c) (yield 96%). A mixture of 14.8 g of compound (c), 2.8 g of NaOH, 50 mL of ethanol and 5 mL of water was agitated at room temperature for 2 hr, and 200 mL of water was added thereto. The mixture was washed with hexane and fractionated, and the hexane layer was removed. 200 mL of ethyl acetate together with dilute hydrochloric acid was added to the water layer and fractionated, and the water layer was removed. Further, the mixture was washed with a saturated saline solution and fractionated. The ethyl acetate layer was dried over magnesium sulfate and concentrated in vacuum until the amount of solvent became 30 mL. Hexane was added to the concentrate, and agitated. Precipitated crystal was collected by suction filtration and dried. Thus, 13.2 g of colorless crystal (18) (melting point 75 to 77° C.) was obtained (yield 96%).

Compound (A-2) of the present invention will be now described.

In another aspect of the compounds employed in the present invention, there are compounds which have specific 5-membered heterocyclic structure.

The heterocyclic ring portion of the compound of the present invention may optionally have a substituent. As the substituent, all substituents (those mentioned as the fore-mentioned substituent W (provided that a hydroxy group or a thiol group is excluded)) other than a hydroxy group or a thiol group can be applied. The hetero ring substituent is preferably a hydrogen atom, an alkyl, aryl, oxy(alkoxy, aryloxy), thio(alkylthio, arylthio), amino(amino, alkylamino, arylamino), amido, sulfonamido, sulfinylamino, oxycarbonylamino, aminocarbonylamino, aminosulfonylamino, sulfinyl, sulfonyl, sulfamoyl, oxysulfonyl, cyano, acyloxy, a halogen atom, carbonyl, carbamoyl, oxycarbonyl or heterocyclic groups. In particular, thio or amido is preferable.

The compound of the present invention may have 2 or more of heterocyclic ring portions so far as sensitivity can be increased by adding the compound. The substituent which the heterocyclic ring may optionally have can be applied for coupling 2 rings. Further, a group which can be contained in the polymer main chain may be further similarly contained.

A 1,3,4-oxadiazole skeleton is preferable as the oxadiazole derivative, A 1,3,4-thiadiazole skeleton is preferable as the thiadiazole derivative, and a 1,2,4-triazole skeleton is preferable as the triazole derivative.

Among the 1,3,4-oxadiazole derivatives, a compound represented by the general formula (III) is preferable and a compound represented by the general formula (III-a) is more preferable. 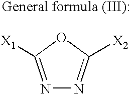
wherein each of X₁ and X₂ represents a substituent selected from a group comprising a hydrogen atom, an alkyl, aryl, oxo, thio, amino, amido, sulfonamido, sulfinylamino, oxycarbonylamino, aminocarbonylamino, aminosulfonylamino, sulfinyl, sulfonyl, sulfamoyl, oxysulfonyl, cyano, acyloxy, a halogen atom, carbonyl, carbamoyl, oxycarbonyl and heterocyclic groups. These substituents may be further substituted. 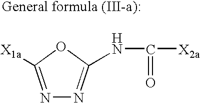
wherein X₁ₐ represents a hydrogen atom, an alkyl group or an alkylthio group; and X₂ₐ represents a substituted or unsubstituted alkyl group or a substituted or unsubstituted aryl group.

Among the 1,3,4-thiadiazole derivatives, a compound represented by the general formula (IV) is preferable, a compound represented by the general formula (IV-a) is more preferable and a compound represented by the general formula (IV-b) is further preferable. 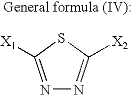
wherein each of X₁ and X₂ has the same meaning as those of the general formula (I). 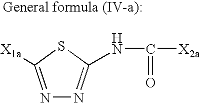
wherein X₁ₐ and X₂ₐ have the same meaning as those of the general formula (III-a). 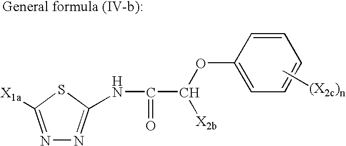
wherein X₁ₐ has the same meaning as those of the general formula (III-a); X_{2b} represents a hydrogen atom or an alkyl group; X_{2c} represents a branched alkyl group; and n is an integer of 0 to 2.

Among the 1,2,4-triazole derivatives, a compound represented by the general formula (V) is preferable, a compound represented by the general formula (V-a) is more preferable and a compound represented by the general formula (V-b) is further preferable. 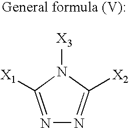
wherein each of X₁ and X₂ has the same meaning as those of the general formula (III); and X₃ represents a hydrogen atom or a substituent.

As the substituent represented by X₃, an alkyl group or an amino group is preferable. 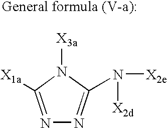
wherein X₁ₐ represents a hydrogen atom, an alkyl group or an alkylthio group; X_{2d} represents a hydrogen atom or an alkyl group; X₂ₑ represents a substituent containing a carbonyl group and a sulfonyl group; and X₃ₐ represents a hydrogen atom or an alkyl group. 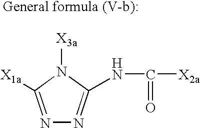
wherein X₁ₐ and X₃ₐ have the same meaning as those of the general formula (V-a); and X₂ₐ has the same meaning as those of the general formula (III-a).

Among the 1,3,4-oxadiazole derivative, 1,3,4-thiadiazole derivative and 1,2,4-triazole derivative, the 1,3,4-thiadiazole derivative and 1,2,4-triazole derivative are preferable and the 1,3,4-thiadiazole derivative is most preferable.

The compound of the present invention can be synthesized by known methods. For example, there are known Journal of Medicinal Chemistry Vol. 35, No. 14, p. 2697 (1992); the same, Vol. 39, No. 22, p. 4382 (1996); the same, Vol. 44, No. 6, p. 931 (2001); Journal of Agricultural and Food Chemistry, Vol. 18, p. 60 (1970); and literatures cited in those literatures etc.

The characteristic of the compound (A-2) of the present invention is high lipophilic property and the physical property is correlated with the distribution coefficient (log P) of octanol/water. When the lipophilic property is too low (distribution to water is enhanced), effect of improving sensitivity is reduced. However, since the measurement of a compound having high lipophilic property with respect to the distribution coefficient is difficult, it was determined by calculation (ClogP). The calculation program of ClogP used the commercially available CLOGP program (ClogP Tool (ver.1.02), algorism=4.01, fragment data base=17) of Daylight Chemical Information Systems Inc. The program is based on a “Hansch-Leo fragment method”.

In the compound (A-2) of the present invention, the preferable value of ClogP is 6.2 or more and 7.8 or more is more preferable.

The examples of the specific compound of the present invention are mentioned below but the present invention is not limited to these.

| Compound No. | | (ClogP) |
|---|---|---|
| III-1 | 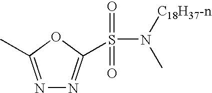 | (7.2) |
| III-2 | 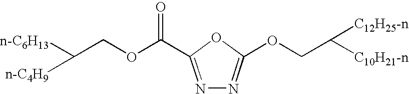 | (16.9) |
| III-3 | 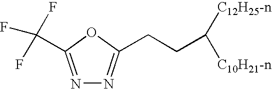 | (12.1) |
| III-4 | 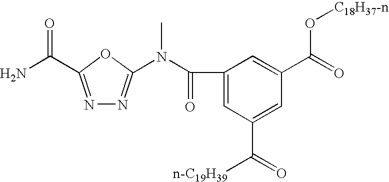 | (16.9) |
| III-5 | 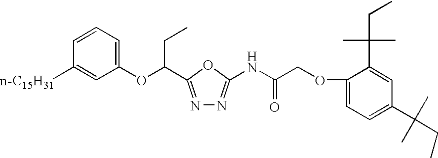 | (15.4) |
| III-6 | 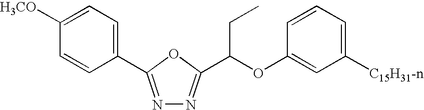 | (11.0) |
| III-7 | 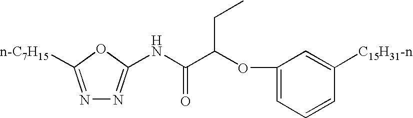 | (12.4) |
| III-8 | 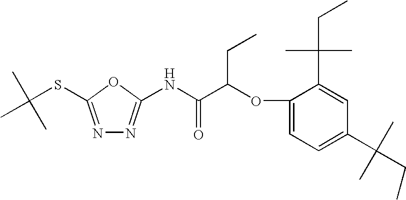 | (7.8) |
| III-9 | 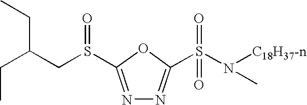 | (8.6) |
| III-10 | 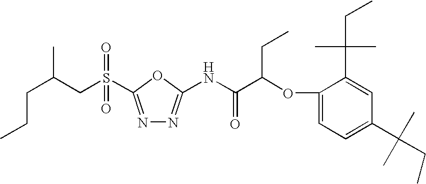 | (7.4) |
| III-11 | 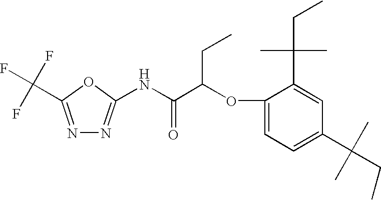 | (6.8) |
| III-12 | 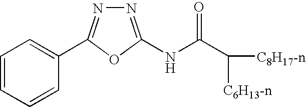 | (8.0) |
| III-13 | 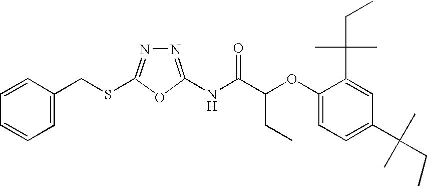 | (8.2) |
| III-14 | 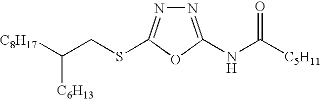 | (9.5) |
| III-15 | 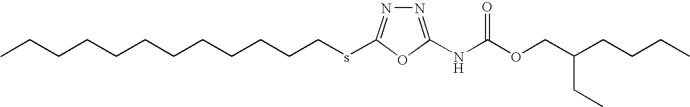 | (9.1) |
| IV-1 | 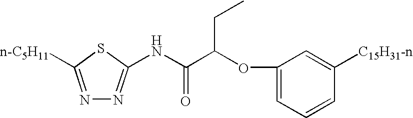 | (12.4) |
| IV-2 | 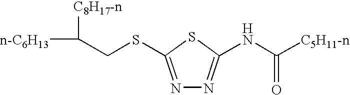 | (10.3) |
| IV-3 | 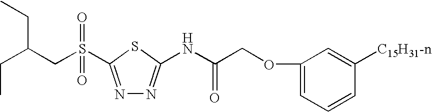 | (10.5) |
| IV-4 | 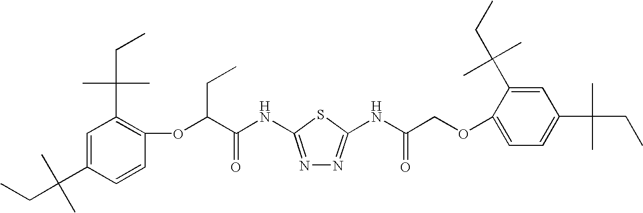 | (13.1) |
| IV-5 | 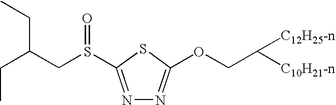 | (13.5) |
| IV-6 | 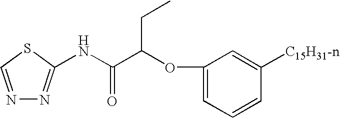 | (9.8) |
| IV-7 | 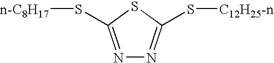 | (10.4) |
| IV-8 | 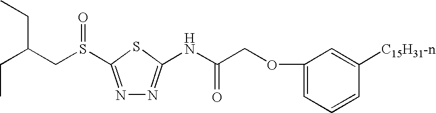 | (10.6) |
| IV-9 | 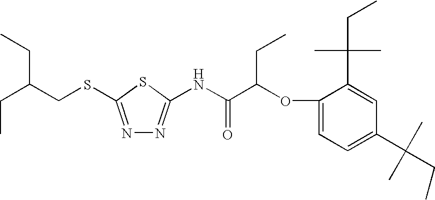 | (9.9) |
| IV-10 | 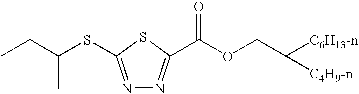 | (7.3) |
| IV-11 | 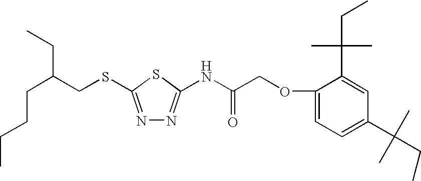 | (10.2) |
| IV-12 | 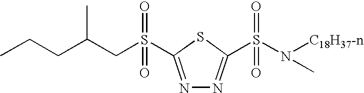 | (9.2) |
| IV-13 | 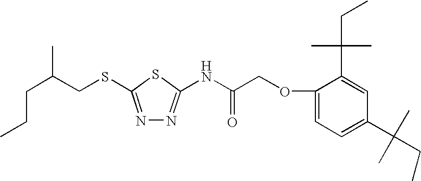 | (9.1) |
| IV-14 | 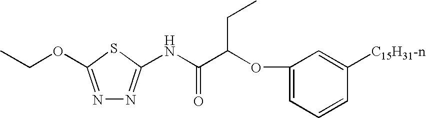 | (10.9) |
| IV-15 | 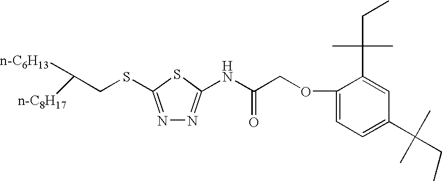 | (14.4) |
| IV-16 | 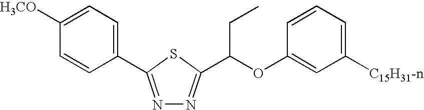 | (11.8) |
| IV-17 | 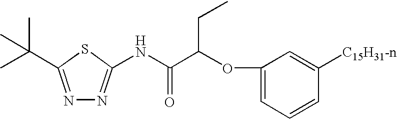 | (11.6) |
| IV-18 | 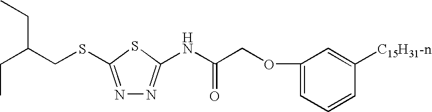 | (12.3) |
| IV-19 | 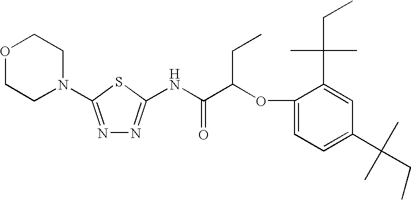 | (7.3) |
| IV-20 | 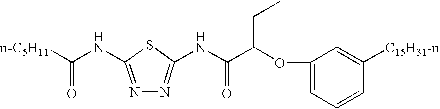 | (12.2) |
| IV-21 | 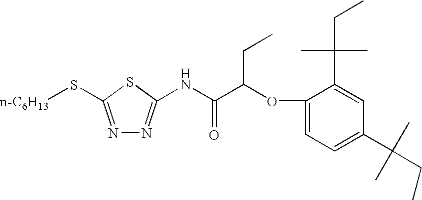 | (10.1) |
| IV-22 | 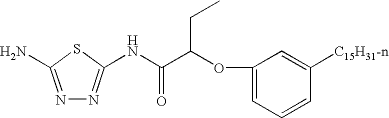 | (9.9) |
| IV-23 | 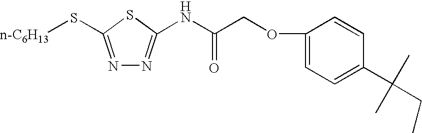 | (6.9) |
| IV-24 | 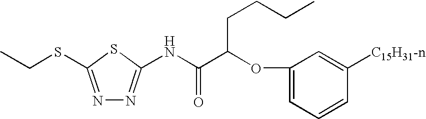 | (12.2) |
| IV-25 | 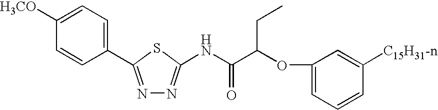 | (11.9) |
| IV-26 | 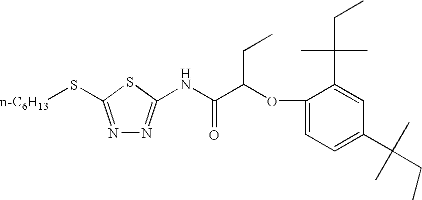 | (10.1) |
| IV-27 | 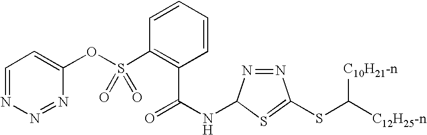 | (13.0) |
| IV-28 | 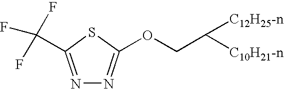 | (12.8) |
| IV-29 | 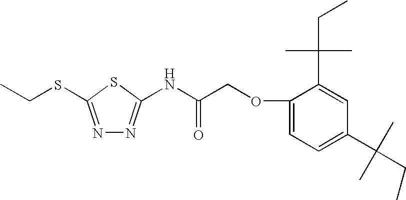 | (7.1) |
| IV-30 | 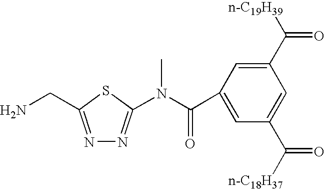 | (16.8) |
| IV-31 | 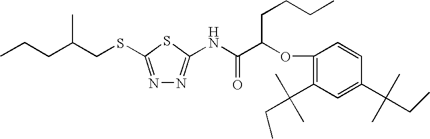 | (11.0) |
| IV-32 | 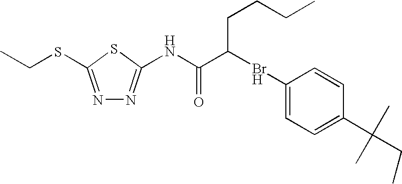 | (6.7) |
| IV-33 | 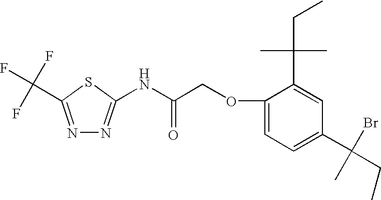 | (6.6) |
| IV-34 | 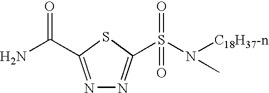 | (6.8) |
| IV-35 | 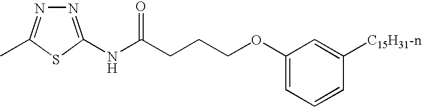 | (10.3) |
| IV-36 | 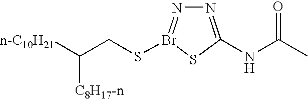 | (10.3) |
| IV-37 | 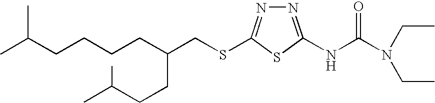 | (7.8) |
| IV-38 | 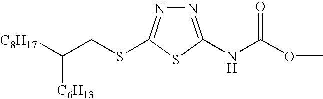 | (8.4) |
| IV-39 | 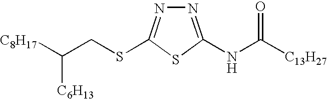 | (14.5) |
| IV-40 | 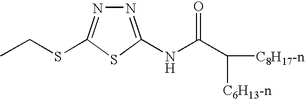 | (8.9) |
| IV-41 | 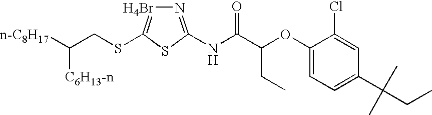 | (13.5) |
| IV-42 | 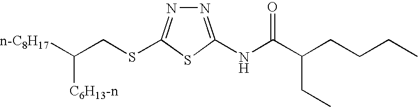 | (11.1) |
| IV-43 | 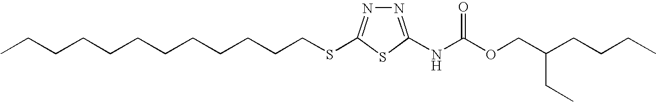 | (10.0) |
| IV-44 | 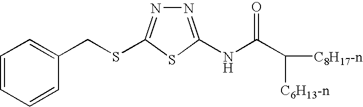 | (9.1) |
| IV-45 | 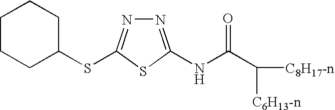 | (9.6) |
| IV-46 | 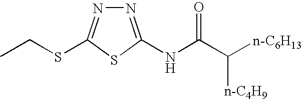 | (6.0) |
| V-1 | 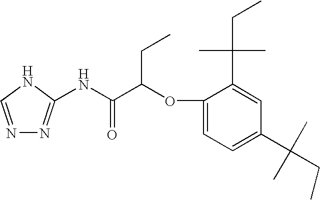 | (6.3) |
| V-2 | 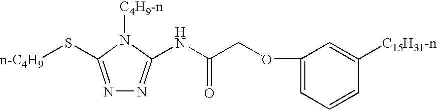 | (12.4) |
| V-3 | 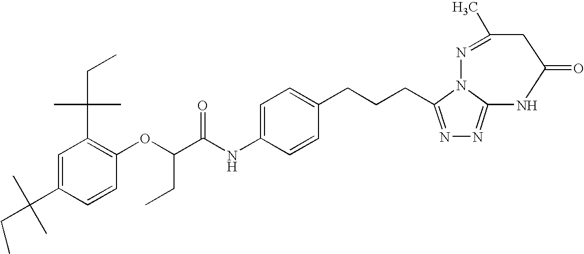 | (7.8) |
| V-4 | 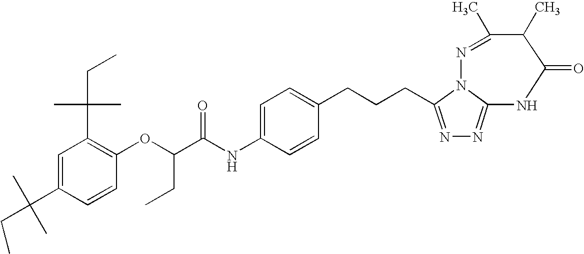 | (8.3) |
| V-5 | 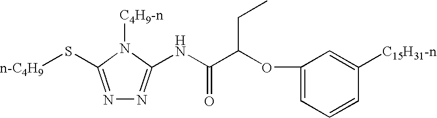 | (11.6) |
| V-6 | 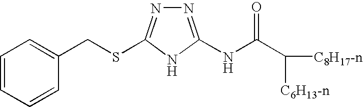 | (8.8) |
| V-7 | 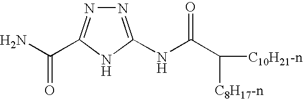 | (8.2) |
| V-8 | 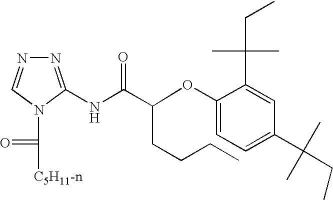 | (8.6) |
| V-9 | 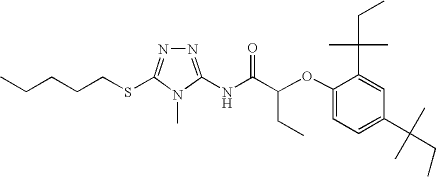 | (9.0) |
| V-10 | 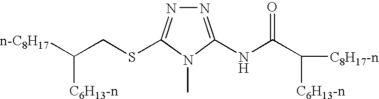 | (14.8) |
| V-11 | 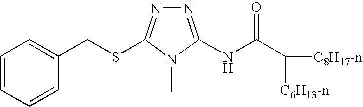 | (8.5) |
| V-12 | 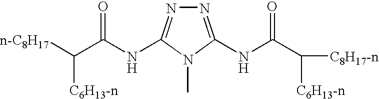 | (13.6) |
| V-13 | 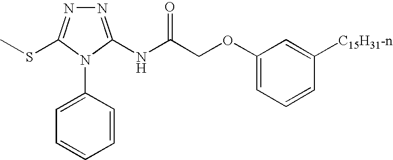 (11.1) | |

When compounds of the present invention each have two or more asymmetric carbon atoms in the molecule, there are multiple stereoisomers per any particular structure. This description involves all possible stereoisomers. In the present invention, use can be made of any one of multiple stereoisomers, or some thereof in the form of a mixture.

With respect to the compounds of the present invention, any one thereof can be used, or two or more can be used in combination. The number and type of compounds for use can be arbitrarily selected.

As substituents for the compounds of the present invention, there can be selected any of those used by persons skilled in the art to which the present invention pertains for attaining desired photographic performance in specified usage. Such substituents include, for example, a hydrophobic group (ballasting group), a solubilizing group, a blocking group and a release or releasable group. With respect to these groups, generally, the number of carbon atoms thereof is preferably in the range of 1 to 60, more preferably 1 to 50.

For controlling the migration in photosensitive material, the compounds of the present invention in the molecules may contain a hydrophobic group or ballasting group of high molecular weight, or may contain a polymer main chain.

The number of carbon atoms of representative ballasting groups is preferably in the range of 8 to 60, more preferably 10 to 57, still more preferably 12 to 55, and most preferably 16 to 53. As these substituents, there can be mentioned substituted or unsubstituted alkyl, aryl and heterocyclic groups having 8 to 60, preferably 10 to 57, more preferably 13 to 55, still more preferably 16 to 53 and most preferably 20 to 50 carbon atoms. These preferably contain branches. Examples of representative substituents on these groups include alkyl, aryl, alkoxy, aryloxy, alkylthio, hydroxyl, halogen, alkoxycarbonyl, aryloxycarbonyl, carboxyl, acyl, acyloxy, amino, anilino, carbonamido, carbamoyl, alkylsulfonyl, arylsulfonyl, sulfonamido and sulfamoyl. These substituents generally each have 1 to 42 carbon atoms. For example, there can be mentioned the aforementioned W. These substituents may have further substituents.

As the specific examples of ballasting groups, there can be mentioned the aforementioned specific substituents represented by V₁ and V₂ in general formula (II) which have 8 or more carbons.

In the incorporating of compounds of the present invention in a silver halide photosensitive material, preferred use may be made of a compound which can be immobilized in specified layer during storage but diffuses at appropriate time (preferably development processing) of photograph processing. Although any compounds and methods can be used for preventing the diffusion of the compounds of the present invention and immobilizing the same during the storage, there can preferably be mentioned the following compounds and methods.

(1) Method wherein a compound of specified pKa value together with a high-boiling organic solvent described later, etc. is emulsified and added so that the compound of the present invention is dissociated and dissolved out from oil only during development.

The pKa value of the compounds of the present invention is preferably 5.5 or higher, more preferably from 6.0 to 10.0, still more preferably 6.5 to 8.4, and most preferably 6.9 to 8.3.

The dissociative group, although not particularly limited, can preferably be selected from among carboxyl, —CONHSO₂— (sulfonylcarbamoyl or carbonylsulfamoyl), —CONHCO— (carbonylcarbamoyl), —SO₂NHSO₂— (sulfonylsulfamoyl), sulfonamido, sulfamoyl and phenolic hydroxyl. Of these, carboxyl, —CONHSO₂—, —CONHCO— and —SO₂NHSO₂— are more preferred. Carboxyl and —CONHSO₂— are most preferred.

(2) Method wherein a ballasting group is introduced in the compounds of the present invention to thereby cause them to be resistant to diffusion.

(3) Method wherein a blocking group is used. Use can be made of compounds whose properties are changed (for example, becoming diffusive) by chemical reactions, such as nucleophilic reaction, electrophilic reaction, oxidation reaction and reduction reaction, during the photographic processing, and, relating to these, chemistry and any techniques publicly known in the photographic field can be utilized.

By way of example, the nucleophilic reaction will be described in detail below. The nucleophilic reaction, although can be induced in arbitrary conditions, is accelerated by bases or heating, especially in the presence of bases. The bases, although not particularly limited, can be selected from among inorganic bases and organic bases. For example, there can be mentioned a tertiary amine such as triethylamine, an aromatic heterocyclic amine such as pyridine and a base having OH anion such as sodium hydroxide or potassium hydroxide. In particular, in the present invention, the nucleophilic reaction is accelerated by high-pH photographic processing, such as developer processing, among the photographic processings, and thus can preferably be employed.

Herein, the nucleophilic agent refers to chemical species having properties to attack atoms of low electron density, such as carbonyl carbon, contained in an atomic group which forms a group split off upon being attacked by the nucleophilic agent, thereby donating or sharing electrons. Although the structure of the nucleophilic agent is not particularly limited, as preferred examples thereof there can be mentioned a hydroxide ion donating reagent (e.g., sodium hydroxide, potassium hydroxide, lithium hydroxide, sodium carbonate or potassium carbonate), a sulfite ion donating reagent (e.g., sodium sulfite or potassium sulfite), a hydroxylamido ion donating reagent (e.g., hydroxyamine), a hydrazido ion donating reagent (e.g., hydrazine hydrate or dialkylhydrazine compound), a hexacyanoiron (II) acid ion donating reagent (e.g., yellow prussiate of potash) and a cyanide ion, tin (II) ion, ammonia ion or alkoxy ion donating reagent (e.g., sodium methoxide). As the group split off as a result of attack by nucleophilic agents, there can be mentioned a group utilizing reverse Michael reaction described in Can. J. Chem. vol. 44, page 2315 (1966) and JP-A's-59-137945 and 60-41034, a group utilizing nucleophilic reaction described in Chem. Lett. page 585 (1988), JP-A-59-218439 and Jpn. pat. Appln. KOKOKU Publication No. (hereinafter referred to as JP-B-)5-78025, a group utilizing ester bond or amido bond hydrolyzing reaction, etc.

For imparting the above functions, the compounds of the present invention may be substituted with a block group capable of releasing compounds of the present invention during the photographic processing. As the block group, there can be employed known block groups, which include block groups such as acyl and sulfonyl groups as described in, for example, JP-B-48-9968, JP-A's-52-8828 and 57-82834, U.S. Pat. No. 3,311,476 and JP-B-47-44805 (U.S. Pat. No. 3,615,617); block groups utilizing the reverse Michael reaction as described in, for example, JP-B-55-17369 (U.S. Pat. No. 3,888,677), JP-B-55-9696 (U.S. Pat. No. 3,791,830), JP-B-55-34927 (U.S. Pat. No. 4,009,029), JP-A-56-77842 (U.S. Pat. No. 4,307,175) and JP-A's-59-105640, 59-105641 and 59-105642; block groups utilizing the formation of a quinone methide or quinone methide homologue through intramolecular electron transfer as described in, for example, JP-B-54-39727, U.S. Pat. Nos. 3,674,478, 3,932,480 and 3,993,661, JP-A-57-135944, JP-A-57-135945 (U.S. Pat. No. 4,420,554), JP-A's-57-136640 and 61-196239, JP-A-61-196240 (U.S. Pat. No. 4,702,999), JP-A-61-185743, JP-A-61-124941 (U.S. Pat. No. 4,639,408) and JP-A-2-280140; block groups utilizing an intramolecular nucleophilic substitution reaction as described in, for example, U.S. Pat. Nos. 4,358,525 and 4,330,617, JP-A-55-53330 (U.S. Pat. No. 4,310,612), JP-A's-59-121328 and 59-218439 and JP-A-63-318555 (EP 0295729); block groups utilizing a ring cleavage reaction of 5- or 6-membered ring as described in, for example, JP-A-57-76541 (U.S. Pat. No. 4,335,200), JP-A-57-135949 (U.S. Pat. No. 4,350,752), JP-A's-57-179842, 59-137945, 59-140445, 59-219741 and 59-202459, JP-A-60-41034 (U.S. Pat. No. 4,618,563), JP-A-62-59945 (U.S. Pat. No. 4,888,268), JP-A-62-65039 (U.S. Pat. No. 4,772,537), and JP-A's 62-80647, 3-236047 and 3-238445; block groups utilizing a reaction of addition of nucleophilic agent to conjugated unsaturated bond as described in, for example, JP-A's-59-201057 (U.S. Pat. No. 4,518,685), 61-43739 (U.S. Pat. No. 4,659,651), 61-95346 (U.S. Pat. No. 4,690,885), 61-95347 (U.S. Pat. No. 4,892,811), 64-7035, 4-42650 (U.S. Pat. No. 5,066,573), 1-245255, 2-207249, 2-235055 (U.S. Pat. No. 5,118,596) and 4-186344; block groups utilizing a β-elimination reaction as described in, for example, JP-A's-59-93442, 61-32839 and 62-163051 and JP-B-5-37299; block groups utilizing a nucleophilic substitution reaction of diarylmethanes as described in JP-A-61-188540; block groups utilizing Lossen rearrangement reaction as described in JP-A-62-187850; block groups utilizing a reaction between an N-acyl derivative of thiazolidine-2-thione and an amine as described in, for example, JP-A's-62-80646, 62-144163 and 62-147457; block groups having two electrophilic groups and capable of reacting with a binucleophilic agent as described in, for example, JP-A's-2-296240 (U.S. Pat. No. 5,019,492), 4-177243, 4-177244, 4-177245, 4-177246, 4-177247, 4-177248, 4-177249, 4-179948, 4-184337 and 4-184338, WO 92/21064, JP-A-4-330438, WO 93/03419 and JP-A-5-45816; and block groups of JP-A's-3-236047 and 3-238445. Of these block groups, block groups having two electrophilic groups and capable of reacting with a binucleophilic agent as described in, for example, JP-A's-2-296240 (U.S. Pat. No. 5,019,492), 4-177243, 4-177244, 4-177245, 4-177246, 4-177247, 4-177248, 4-177249, 4-179948, 4-184337 and 4-184338, WO 92/21064, JP-A-4-330438, WO 93/03419 and JP-A-5-45816 are especially preferred. Moreover, these block groups may be those containing timing groups capable of inducing cleavage reaction with the use of electron transfer reaction as described in U.S. Pat. Nos. 4,409,323 and 4,421,845. With respect to such groups, it is preferred that timing group terminals inducing electron transfer reaction be blocked.

(4) Method wherein use is made of a dimer, trimer or higher polymer compound containing partial structure of compounds of the present invention.

(5) Method wherein immobilization is effected by the use of water-insoluble compounds of the present invention (solid dispersions). As mentioned with respect to method (1), compounds of the present invention exhibiting specified pKa values are preferred from the viewpoint that they are dissolved only at the stage of development. Examples of uses of water-insoluble dye solids (solid dispersions) are disclosed in JP-A's-56-12639, 55-155350, 55-155351, 63-27838 and 63-197943, EP 15601, etc.

Particular methods for solid dispersion will be specified later.

(6) Method wherein compounds of the present invention are immobilized by coexistence of a polymer having an electric charge counter to that thereof as a mordant. Examples of dye immobilizations are disclosed in U.S. Pat. Nos. 2,548,564, 4,124,386 and 3,625,694, etc.

(7) Method wherein compounds of the present invention are immobilized by effecting adsorption thereof on metal salts such as silver halides. Examples of dye immobilizations are disclosed in U.S. Pat. Nos. 2,719,088, 2,496,841 and 2,496,843, JP-A-60-45237, etc.

As representative examples of adsorptive groups on silver halides which can be used in compounds of the present invention, there can be mentioned groups described in JP-A-2003-156823, page 16 right column line 1 to page 17 right column line 12.

As preferred adsorptive groups, there can be mentioned a mercapto-substituted nitrogenous heterocyclic group (e.g., 2-mercaptothiadiazole group, 3-mercapto-1,2,4-triazole group, 5-mercaptotetrazole group, 2-mercapto-1,3,4-oxadiazole group, 2-mercaptobenzoxazole group, 2-mercaptobenzothiazole group or 1,5-dimethyl-1,2,4-triazoium-3-thiolate group) and a nitrogenous heterocyclic group capable of forming an iminosilver (>NAg) and having —NH— as a partial structure of heterocycle (e.g., benzotriazole group, benzimidazole group or indazole group). Among these, a 5-mercaptotetrazole group, a 3-mercapto-1,2,4-triazole group and a benzotriazole group are more preferred. A 3-mercapto-1,2,4-triazole group and a 5-mercaptotetrazole group are most preferred.

An adsorptive group having two or more mercapto groups as a partial structure in the molecule is also especially preferred. The mercapto group (—SH) when tautomerizable may be in the form of a thione group. As preferred examples of adsorptive groups each having two or more mercapto groups as a partial structure (e.g., dimercapto-substituted nitrogenous heterocyclic groups), there can be mentioned a 2,4-dimercaptopyrimidine group, a 2,4-dimercaptotriazine group and a 3,5-dimercapto-1,2,4-triazole group.

Moreover, a quaternary salt structure of nitrogen or phosphorus can preferably be used as the adsorptive group. As the quaternary salt structure of nitrogen, there can be mentioned, for example, an ammonio group (such as trialkylammonio, dialkylaryl(heteroaryl)ammonio or alkyldiaryl(heteroaryl)ammonio) or a group containing a nitrogenous heterocyclic group containing a quaternarized nitrogen atom. As the quaternary salt structure of phosphorus, there can be mentioned, a phosphonio group (such as trialkylphosphonio, dialkylaryl(heteroaryl)phosphonio, alkyldiaryl(heteroaryl)phosphonio or triaryl(heteroaryl)phosphonio). Among these, the quaternary salt structure of nitrogen is more preferred. The 5- or 6-membered nitrogenous aromatic heterocyclic group containing a quaternarized nitrogen atom is still more preferred. A pyridinio group, a quinolinio group and an isoquinolinio group are most preferred. The above nitrogenous heterocyclic group containing a quaternarized nitrogen atom may have any arbitrary substituent.

As examples of counter anions to the quaternary salts, there can be mentioned a halide ion, a carboxylate ion, a sulfonate ion, a sulfate ion, a perchlorate ion, a carbonate ion, a nitrate ion, BF₄⁻, PF₆⁻ and Ph₄B⁻. When in the molecule a group with negative charge is had by carboxylate, etc., an intramolecular salt may be formed therewith. A chloro ion, a bromo ion or a methanesulfonate ion is most preferred as a counter anion not present in the molecule.

Among the above methods for immobilizing compounds of the present invention, there can preferably be employed the method of using a compound of specified pKa (1), the method of using a compound having a ballasting group (2), the method of using a compound having a blocking group (3) and the method of using a solid dispersion (5). It is preferred to employ compounds suitable for the methods. Using the method (1), (2) or (3) together with suitable compounds is more preferred. Using the method (1) or (2) together with suitable compounds is still more preferred. Simultaneously using the methods (1) and (2) is most preferred. That is, compounds simultaneously having specified pKa and ballasting group according to the present invention can most preferably be employed. The compounds of the present invention can be used in combination with one or more arbitrary methods capable of exerting sensitivity enhancing effects or compounds capable of exerting sensitivity enhancing effects. The number and type of employed methods and contained compounds can be arbitrarily selected. Further, the compounds of the present invention may be used in combination with compounds each having at least three heteroatoms as described in JP-A's-2000-194085 and 2003-156823.

In the present invention, as long as the compounds of the present invention can be applied to a silver halide photosensitive sensitive material (preferably a silver halide color photosensitive material), the addition site therefore, etc. are not particularly limited, and the compounds may be added to any of silver halide photosensitive layer and nonsensitive layer.

In the use in a silver halide photosensitive layer consisting of multiple layers of different speeds, although the addition may be effected to any of these layers, it is preferred that the compounds be incorporated in the layer of highest speed.

In the use in nonsensitive layer, the compounds are preferably incorporated in a nonsensitive layer disposed between a red-sensitive layer and a green-sensitive layer or between a green-sensitive layer and a blue-sensitive layer. The nonsensitive layer refers to any of all layers other than the silver halide emulsion layers which include an antihalation layer, an interlayer, a yellow filter layer and a protective layer.

The method of incorporating the compounds of the present invention in a photosensitive material, although not particularly limited, can be selected from among, for example, the method of adding through emulsification dispersion of the compounds together with a high boiling organic solvent or the like, the method of adding through solid dispersion, the method of adding the compounds in solution form to a coating liquid (for example, dissolving the compounds in water, an organic solvent such as methanol or a mixed solvent before addition) and the method of adding during the preparation of silver halide emulsion. Among these, the method of incorporating in a photosensitive material through emulsification dispersion or solid dispersion is preferred. The method of incorporating in a photosensitive material through emulsification dispersion is more preferred.

As the emulsification dispersion method, use can be made of the in-water oil droplet dispersing method wherein the compounds are dissolved in a high-boiling organic solvent (optionally in combination with a low-boiling organic solvent), emulsified and dispersed in an aqueous solution of gelatin and added to a silver halide emulsion.

Examples of the high-boiling organic solvents for use in the in-water oil droplet dispersing method are listed in, for example, U.S. Pat. No. 2,322,027. Particulars of a latex dispersing method as one of polymer dispersing methods are described in, for example, U.S. Pat. No. 4,199,363, DE (OLS) 2,541,274, JP-B-53-41091 and EP's 0,727,703 and 0,727,704. Further, a method of dispersion by an organic solvent soluble polymer is described in WO 88/00723.

Examples of the high-boiling organic solvents which can be employed in the above in-water oil droplet dispersing method include phthalic acid esters (e.g., dibutyl phthalate, dioctyl phthalate and di-2-ethylhexyl phthalate), esters of phosphoric acid or phosphonic acid (e.g., triphenyl phosphate, tricresyl phosphate and tri-2-ethylhexyl phosphate), fatty acid esters (e.g., di-2-ethylhexyl succinate and tributyl citrate), benzoic acid esters (e.g., 2-ethylhexyl benzoate and dodecyl benzoate), amides (e.g., N,N-diethyldodecanamide and N,N-dimethyloleamide, alcohols or phenols (e.g., isostearyl alcohol and 2,4-di-tert-amylphenol), anilines (e.g., N,N-dibutyl-2-butoxy-5-tert-octylaniline), chlorinated paraffins, hydrocarbons (e.g., dodecylbenzene and diisopropylnaphthalene) and carboxylic acids (e.g., 2-(2,4-di-tert-amylphenoxy)butyric acid). Further, as an auxiliary solvent, an organic solvent having a boiling point of 30 to 160° C. (e.g., ethyl acetate, butyl acetate, methyl ethyl ketone, cyclohexanone, methyl cellosolve acetate or dimethylformamide) may be used in combination therewith. The high-boiling organic solvents are preferably used in a mass ratio to compounds of the present invention of 0 to 10, more preferably 0 to 4.

The whole or portion of the auxiliary solvent can be removed from the emulsified dispersion by vacuum distillation, noodle washing, ultrafiltration or other appropriate means according to necessity from the viewpoint of enhancing of aging stability during storage in the state of emulsified dispersion and inhibiting of photographic property change and enhancing of aging stability with respect to a final coating composition after emulsion mixing.

The average particle size of thus obtained lipophilic fine particle dispersion is preferably in the range of 0.04 to 0.50 μm, more preferably 0.05 to 0.30 μm and most preferably 0.08 to 0.20 μm. The average particle size can be measured by the use of, for example, Coulter submicron particle analyzer model N4 (trade name, manufactured by Coulter Electronic).

As means for solid fine particle dispersion, there can be mentioned the method wherein powdery compounds of the present invention are dispersed in an appropriate solvent such as water with the use of a ball mill, a colloid mill, a vibration ball mill, a sand mill, a jet mill, a roller mill or ultrasonic so as to obtain a solid dispersion. During the dispersing, use can be made of a protective colloid (e.g., polyvinyl alcohol) or a surfactant (e.g., anionic surfactant such as sodium triisopropylbutanesulfonate (mixture of those whose three isopropyl substitution sites are different from each other)). In the above mills, beads such as those of zirconia are generally used as dispersing media. Thus, Zr, etc. leached from the beads may be mixed in the dispersion. The amount thereof is generally in the range of 1 to 1000 ppm although depending on dispersing conditions. When the content of Zr in photosensitive material is 0.5 mg or less per g of silver, there would occur practically no adverse effect. The water dispersion can be doped with an antiseptic (e.g., benzoisothiazolinone sodium salt).

In the present invention, in order to obtain a coagulation-free solid dispersion of high S/N and small grain size, use can be made of the dispersing method wherein a water dispersion liquid is converted to a high-velocity stream and thereafter a pressure drop is effected. The solid dispersing apparatus and technology employed for carrying out this dispersing method are described in detail in, for example, “Dispersion Rheology and Dispersing Technology” written by Toshio Kajiuchi and Hiroki Usui, pp. 357-403, Shinzansha Shuppan (1991) and “Progress of Chemical Engineering, 24th Series” edited by the corporate juridical person Society of Chemical Engineering, Tokai Chapter, pp. 184-185, Maki Shoten (1990).

The addition amount of compounds of the present invention is preferably in the range of 0.1 to 1000 mg/m², more preferably 1 to 500 mg/m² and most preferably 5 to 100 mg/m². In the use in photosensitive silver halide emulsion layers, the addition amount is preferably in the range of 1×10⁻⁵ to 1 mol, more preferably 1×10⁻⁴ to 1×10⁻¹ mol and most preferably 1×10⁻³ to 5×10⁻² mol per mol of silver contained in the same layer. Two or more compounds of the present invention may be used in combination. These compounds may be incorporated in the same layer or separate layers.

The pKa values of compounds of the present invention are those determined in the following manner. 0.5 milliliter (hereinafter also expressed as “mL”) of 1 N sodium chloride is added to 100 mL of a solution dissolving 0.01 mmol of compound of the present invention in a 6:4 (mass ratio) mixture of tetrahydrofuran and water, and titrated with a 0.5 N aqueous potassium hydroxide solution under agitation in a nitrogen gas atmosphere. The pKa refers to the pH at the central position of inflexion point of titration curve having an axis of abscissas indicating the amount of aqueous potassium hydroxide solution dropped and an axis of ordinate indicating pH values. With respect to compounds having multiple dissociation sites, multiple inflexion points exist and multiple pKa values can be determined. Also, the inflexion point can be determined by monitoring ultraviolet/visible light absorption spectra and checking absorption changes.

In the enforcement of the present invention, at least one or more of compounds selected from the compounds (A-1) and (A-2) may be preferably added, and a combination of at least one or more of respective compounds (A-1) and (A-2) is further preferably used.

Then, the compound (B) of the present invention is illustrated.

The compound (B) of the present invention is represented by the under-mentioned general formula (B):

General formula (B): Rf-X-M;

wherein Rf represents an alkyl group having 1 or more and 6 or less carbons. Rf may be substituted with at least one of fluorine atoms and may be either of linear, branched and cyclic structures. Further, it may be further optionally substituted with a substituent other than a fluorine atom and may be optionally substituted with only a fluorine atom.

The substituent of Rf other than a fluorine atom includes an alkenyl group, an aryl group, an alkoxyl group, a halogen atom other than fluorine, a carboxylic acid ester group, a carbonamido group, a carbamoyl group, an oxycarbonyl group, and a phosphoric acid ester group.

Rf is preferably a fluorine substituted alkyl group having 2 to 6 carbons and more preferably that having 4 to 6 carbons.

The preferable examples of Rf include:

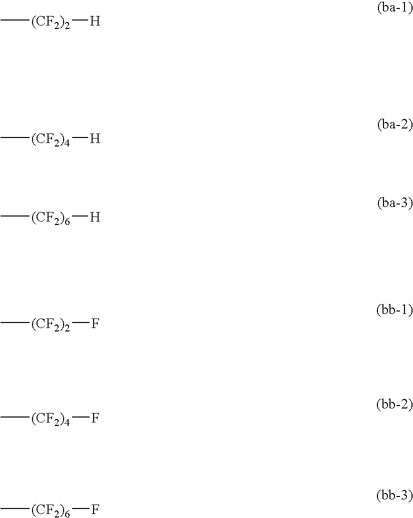

Rf is further preferably an alkyl group having 4 to 6 carbons whose end is substituted with a trifluoromethyl group and in particular, preferably (bb-1) to (bb-3). Among these, (bb-3) is most preferable in particular.

In the fore-mentioned formula, X represents a divalent coupling group or a single bond. The fore-mentioned divalent coupling group is not specifically limited, but preferably a group obtained from an alkylene group, an arylene group, —C(═O)—, —O—, —S—, —S(═O)—, —S(═O)₂—, —NRₚ— or —C(Rₚ)R_{q}— group, alone or by combining those.

The above-mentioned Rₚ and R_{q} represent a hydrogen atom or a substituent and as the substituent, each of them represents independently a hydrogen atom or a substituent. The substituent is, for example, an alkyl group (preferably an alkyl group having 1 to 20 carbons, more preferably 1 to 12 carbons and in particular, preferably 1 to 8 carbons and examples include a methyl group, an ethyl group, an isopropyl group, a tert-butyl group, an n-octyl group, a n-decyl group, a n-hexadecyl group, a cyclopropyl group, a cyclopentyl group, and a cyclohexyl group); an alkenyl group (preferably an alkenyl group having 2 to 20 carbons, more preferably 2 to 12 carbons and in particular, preferably 2 to 8 carbons and examples include a vinyl group, an allyl group, a 2-butenyl group, and a 3-pentenyl group); an alkynyl group (preferably an alkynyl group having 2 to 20 carbons, more preferably 2 to 12 carbons and in particular, preferably 2 to 8 carbons and examples include a propargyl group, and a 3-pentynyl group); an aryl group (preferably an aryl group having 6 to 30 carbons, more preferably 6 to 20 carbons and in particular, preferably 6 to 12 carbons and examples include a phenyl group, a p-methylphenyl group, and a naphthyl group); a substituted or unsubstituted amino group (preferably an amino group having 0 to 20 carbons, more preferably 0 to 10 carbons and in particular, preferably 0 to 6 carbons and examples include an unsubstituted amino group, a methylamino group, a dimethylamino group, a diethylamino group, and a dibenzylamino group); an alkoxy group (preferably an alkoxy group having 1 to 20 carbons, more preferably 1 to 12 carbons and in particular, preferably 1 to 8 carbons and examples include a methoxy group, an ethoxy group, and a butoxy group); an aryloxy group (preferably an aryloxy group having 6 to 20 carbons, more preferably 6 to 16 carbons and in particular, preferably 6 to 12 carbons and examples include a phenyloxy group and a 2-naphthyloxy group); an acyl group (preferably an acyl group having 2 to 20 carbons, more preferably 2 to 16 carbons and in particular, preferably 2 to 12 carbons and examples include an acetyl group, a benzoyl group, a formyl group, and a pivaloyl group); an alkoxycarbonyl group (preferably an alkoxycarbonyl group having 2 to 20 carbons, more preferably 2 to 16 carbons and in particular, preferably 2 to 12 carbons and examples include a methoxycarbonyl group and an ethoxycarbonyl group); an aryloxycarbonyl group (preferably an aryloxycarbonyl group having 7 to 20 carbons, more preferably 7 to 16 carbons and in particular, preferably 7 to 10 carbons and examples include a phenyloxycarbonyl group); an acyloxy group (preferably an acyloxy group having 2 to 20 carbons, more preferably 2 to 16 carbons and in particular, preferably 2 to 10 carbons and examples include an acetoxy group and a benzoyloxy group); an acylamino group (preferably an acylamino group having 2 to 20 carbons, more preferably 2 to 16 carbons and in particular, preferably 2 to 10 carbons and examples include an acetylamino group and a benzoylamino group); an alkoxycarbonylamino group (preferably an alkoxycarbonylamino group having 2 to 20 carbons, more preferably 2 to 16 carbons and in particular, preferably 2 to 12 carbons and examples include a methoxycarbonylamino group); an aryloxycarbonylamino group (preferably an aryloxycarbonylamino group having 7 to 20 carbons, more preferably 7 to 16 carbons and in particular, preferably 7 to 12 carbons and examples include a phenyloxycarbonylamino group); a sulfonylamino group (preferably a sulfonylamino group having 1 to 20 carbons, more preferably 1 to 16 carbons and in particular, preferably 1 to 12 carbons and examples include a methanesulfonylamino group and a benzenesulfonylamino group); a sulfamoyl group (preferably a sulfamoyl group having 0 to 20 carbons, more preferably 0 to 16 carbons and in particular, preferably 0 to 12 carbons and examples include a sulfamoyl group, a methylsulfamoyl group, a diethylsulfamoyl group, and a phenylsulfamoyl group); a carbamoyl group (preferably a carbamoyl group having 1 to 20 carbons, more preferably 1 to 16 carbons and in particular, preferably 1 to 12 carbons and examples include an unsubstituted carbamoyl group, a methylcarbamoyl group, a diethylcarbamoyl group, and a phenylcarbamoyl group); an alkylthio group (preferably an alkylthio group having 1 to 20 carbons, more preferably 1 to 16 carbons and in particular, preferably 1 to 12 carbons and examples include a methylthio group and an ethylthio group); an arylthio group (preferably an arylthio group having 6 to 20 carbons, more preferably 6 to 16 carbons and in particular, preferably 6 to 12 carbons and examples include a phenylthio group); a sulfonyl group (preferably a sulfonyl group having 1 to 20 carbons, more preferably 1 to 16 carbons and in particular, preferably 1 to 12 carbons and examples include a mesyl group and a tosyl group); a sulfinyl group (preferably a sulfinyl group having 1 to 20 carbons, more preferably 1 to 16 carbons and in particular, preferably 1 to 12 carbons and examples include a methanesulfinyl group and a benzenesulfinyl group); an ureido group (preferably an ureido group having 1 to 20 carbons, more preferably 1 to 16 carbons and in particular, preferably 1 to 12 carbons and examples include an unsubstituted ureido group, a methylureido group, and a phenylureido group); a phosphoric amide group (preferably a phosphoric amide group having 1 to 20 carbons, more preferably 1 to 16 carbons and in particular, preferably 1 to 12 carbons and examples include a diethylphosphoric amide group and a phenylphosphoric amide group); a hydroxy group, a mercapto group, a halogen atom (for example, a fluorine atom, a chlorine atom, a bromine atom and an iodine atom), a cyano group, a sulfo group, a carboxyl group, a nitro group, a hydroxamic acid group, a sulfino group, a hydrazino group, an imino group, a heterocyclic ring group (preferably a heterocyclic ring group having 1 to 30 carbons and more preferably 1 to 12 carbons, for example, a heterocyclic ring group having hetero atoms such as a nitrogen atom, an oxygen atom and a sulfur atom, and examples include an imidazolyl group, a pyridyl group, a quinolyl group, a furyl group, a piperidyl group, a morpholino group, a benzoxazolyl group, a benzimidazolyl group, and a benzothiazolyl group), a silyl group (preferably a silyl group having 3 to 40 carbons, more preferably 3 to 30 carbons and in particular, preferably 3 to 24 carbons and examples include a trimethylsilyl group and a triphenylsilyl group); etc. These substituents may be further substituted. Further, when there are 2 or more of substituents, they may be the same or different. Furthermore, the substituents may be mutually coupled, if possible, to form a ring.

The preferable examples of X include:

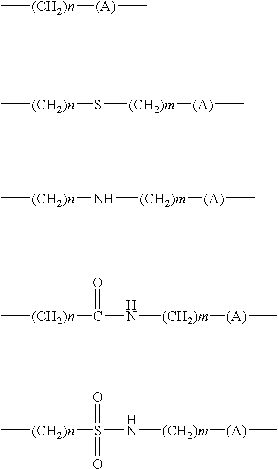

In the above formulas, A represents a coupling group in which groups similarly defined as the fore-mentioned Rₚ and R_{q} are alone and combined respectively, or may not exist. Further, n represents an integer of 1 or more and preferably 2 or 3.

m represents an integer of 0 or more and preferably 0 to 3.

In the above formulas, M represents an anionic group, a cationic group or a betaine group which is necessary for imparting surface action.

The cationic group is preferably an organic cationic substituent and more preferably an organic cationic group containing a nitrogen atom or a phosphorous atom. Pyridinium cation or ammonium cation is further preferable and trialkylammonium cation represented by the under-mentioned general formula (C) is more preferable: 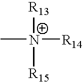
wherein each of R₁₃, R₁₄ and R₁₅ represents independently a substituted or unsubstituted alkyl group. As the substituent, those mentioned as the substituent of Rₚ and R_{q} can be applied. Further, R₁₃, R₁₄ and R₁₅ are mutually bound, if possible, to form a ring. R₁₃, R₁₄ and R₁₅ are preferably an alkyl group having 1 to 12 carbons, more preferably an alkyl group having 1 to 6 carbons, further preferably a methyl group, an ethyl group and a methylcarboxyl group, and in particular, preferably a methyl group.

The preferable examples of the compound (B) having a cationic group include:

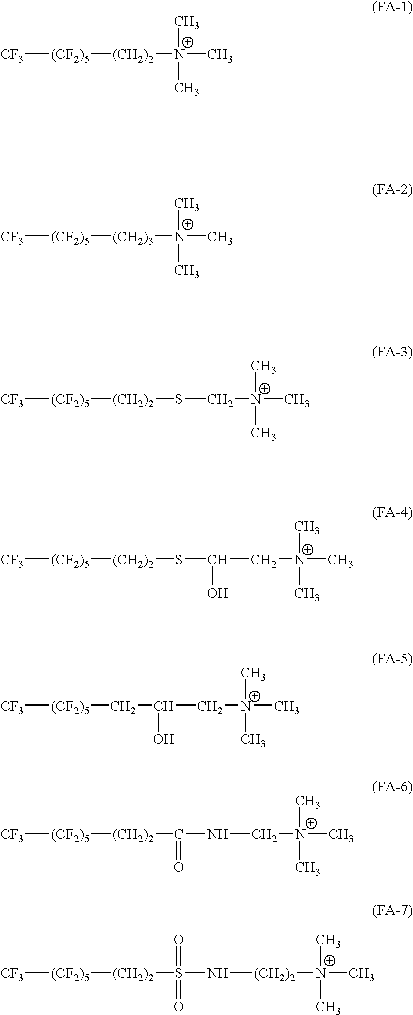

The example of an anionic group includes a sulfonic acid group and its ammonium or metal salt, a carboxylic acid group and its ammonium or metal salt, a phosphonic acid group and its ammonium or metal salt, a sulfuric acid ester group and its ammonium or metal salt, and a phosphoric acid ester group and its ammonium or metal salt. Among these, a sulfonic acid group and its ammonium or metal salt are preferable.

The preferable examples of the compound (B) having an anionic group include:

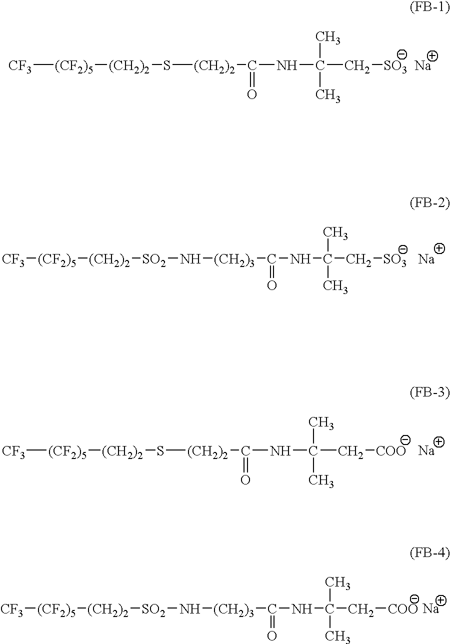

The examples of the betaine group include:

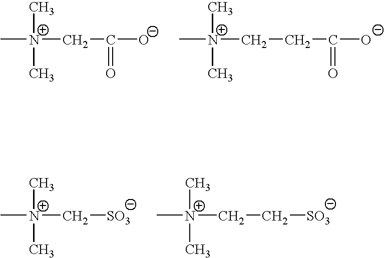

The preferable examples of the compound (B) having a betaine group include:

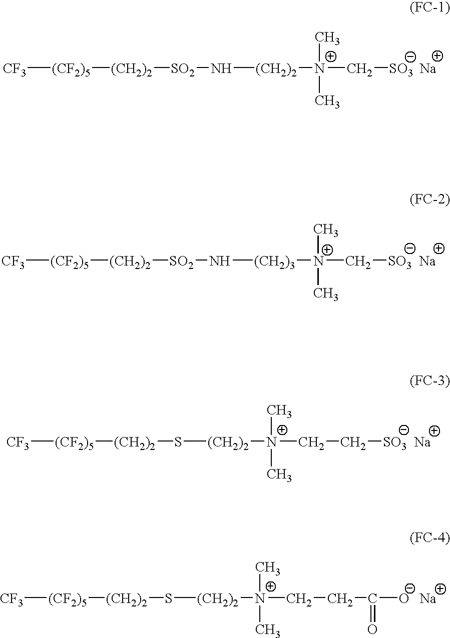

The compound (B) of the present invention is preferably used for the coating composition for forming layers (in particular, a protective layer, an under-coat layer, a back layer and the like) which compose the silver halide photosensitive material. Particularly, when it is used for forming the hydrophilic colloid layer at the uppermost layer of the photosensitive material, it is preferable in particular because effective antistatic ability and coating uniformity can be obtained, but may be also added to a layer having spectral sensitivity other that and an intermediary layer. Further, it may be also added to a plural number of layers and may be also added to either one of layers. The fluorine base surfactants of the present invention may be used respectively singly and a plural number of respective different compounds may be simultaneously used. The use amount is preferably 10⁻⁶ mol/m² to 10⁻⁷ mol/m². Further, other anionic, nonionic and cationic surfactants may be used in combination with the compound of the present invention.

The present inventors have intensively studied the deterioration of the antistatic property, high speed coating adaptability and storability of the photosensitive material using the compounds (A-1) and/or (A-2) and as a result, have surprisingly found effect in combination with the compound (B). Further, it was cleared that the effect of the present invention is remarkable in a high sensitive photosensitive material having a specific photo sensitivity of ISO 800 or more.

In the light-sensitive material to which the method of the present invention can be employed, at least one blue-sensitive layer, at least one green-sensitive layer, at least one red-sensitive layer and at least one non-light-sensitive layer need only be formed on a support. A typical example is a silver halide photosensitive material having, on a support, at least one blue, green and red sensitive layer each consisting of a plurality of silver halide emulsion layers sensitive to substantially the same color but different in sensitivity, and at least one non-light-sensitive layer. This sensitive layer is a unit sensitive layer sensitive to one of blue light, green light, and red light. In a multilayered silver halide color photographic light-sensitive material, sensitive layers are generally arranged in the order of red-, green-, and blue-sensitive layers from a support. However, according to the intended use, this order of arrangement can be reversed, or sensitive layers sensitive to the same color can sandwich another sensitive layer sensitive to a different color. Non-light-sensitive layers can be formed between the silver halide sensitive layers and as the uppermost layer and the lowermost layer. These non-light-sensitive layers can contain, e.g., couplers, DIR compounds, and color amalgamation inhibitors to be described later. As a plurality of silver halide emulsion layers constituting each unit sensitive layer, as described in DE1,121,470 or GB923,045, the disclosures of which are incorporated herein by reference, high- and low-speed emulsion layers are preferably arranged such that the sensitivity is sequentially decreased toward a support. Also, as described in JP-A's-57-112751, 62-200350, 62-206541, and 62-206543, layers can be arranged such that a low-speed emulsion layer is formed apart from a support and a high-speed layer is formed close to the support.

More specifically, layers can be arranged, from the one farthest from a support, in the order of a low-speed blue-sensitive layer (BL)/high-speed blue-sensitive layer (BH)/high-speed green-sensitive layer (GH)/low-speed green-sensitive layer (GL)/high-speed red-sensitive layer (RH)/low-speed red-sensitive layer (RL), the order of BH/BL/GL/GH/RH/RL, or the order of BH/BL/GH/GL/RL/RH.

In addition, as described in JP-B-55-34932, layers can be arranged in the order of a blue-sensitive layer/GH/RH/GL/RL from the one farthest from a support. Furthermore, as described in JP-A's-56-25738 and 62-63936, layers can be arranged in the order of a blue-sensitive layer/GL/RL/GH/RH from the one farthest from a support.

As described in JP-B-49-15495, three layers can be arranged such that a silver halide emulsion layer having the highest sensitivity is arranged as an upper layer, a silver halide emulsion layer having sensitivity lower than that of the upper layer is arranged as an interlayer, and a silver halide emulsion layer having sensitivity lower than that of the interlayer is arranged as a lower layer, i.e., three layers having different sensitivities can be arranged such that the sensitivity is sequentially decreased toward a support. When the layer structure is thus constituted by three layers having different sensitivities, these three layers can be arranged, in the same color-sensitive layer, in the order of a medium-speed emulsion layer/high-speed emulsion layer/low-speed emulsion layer from the one farthest from a support as described in JP-A-59-202464.

In addition, the order of a high-speed emulsion layer/low-speed emulsion layer/medium-speed emulsion layer or low-speed emulsion layer/medium-speed emulsion layer/high-speed emulsion layer can be used. Furthermore, the arrangement can be changed as described above even when four or more layers are formed.

As a means for improving the color reproduction, the use of an interlayer inhibiting effect is preferred.

It is further preferable to form a donor layer which donates the interlayer effect to a red-sensitive layer. It is particularly preferable that a weight-average sensitivity wavelength λ_{G}, represented by the following equation (III), of the spectral sensitivity distribution of a green-sensitive silver halide emulsion layer be 520 nm<λ_{G}≦580 nm, that the weight-average wavelength (λ_{-R}) of the spectral sensitivity distribution of the interlayer effect, which a red-sensitive silver halide emulsion layer is given from other silver halide emulsion layers within the range of 500 to 600 nm, be 500 nm<λ_{-R}<560 nm, and that λ_{G}-λ_{-R} be preferably 5 nm or more, more preferably 10 nm or more.

$${λ}_{G} = \frac{{\int }_{500}^{600} λ {s}_{G} ( λ ) ⅆ λ}{{\int }_{500}^{600} {s}_{G} ( λ ) ⅆ λ}$$

where S_{G}(λ) is the spectral sensitivity distribution curve of the green-sensitive silver halide emulsion layer, and S_{G} at a specific wavelength λ is represented by the reciprocal of an exposure amount by which a cyan density is fog+0.5 when exposed to the specific wavelength.

To obtain the interlayer effect to a red-sensitive layer as described above in a specific wavelength region, it is preferable to separately form an interlayer effect donor layer containing silver halide grains spectrally sensitized to a predetermined degree.

To implement the spectral sensitivity of the present invention, the weight-average sensitivity wavelength of this interlayer effect donor layer is set between 510 and 540 nm.

The weight-average wavelength λ_{-R} of the wavelength distribution of the magnitude of the interlayer effect, which a red-sensitive silver halide emulsion layer is given from other silver halide emulsion layers in the range of 500 nm to 600 nm, can be calculated by a method described in JP-B-3-10287, the disclosure of which is incorporated herein by reference.

In the present invention, it is preferred that the weight-average wavelength of red-sensitive layer λ_{R} be 630 nm or less. Herein, the weight-average wavelength of red-sensitive layer λ_{R} is defined by the following formula (I).

$${λ}_{R} = \frac{{\int }_{550}^{700} λ {s}_{R} ( λ ) ⅆ λ}{{\int }_{550}^{700} {s}_{R} ( λ ) ⅆ λ} \qquad ( I )$$

In the formula, S_{R}(λ) refers to the spectral sensitivity distribution curve of red-sensitive layer, and the S_{R} at specified wavelength λ is expressed as the inverse number of exposure intensity with which the cyan density becomes fog+0.5 at the application of exposure of the specified wavelength.

As a material for imparting the interlayer effect, a compound which releases a development inhibitor or its precursor by reacting with the oxidized form of a developing agent produced by development is used. Examples are a DIR (development inhibitor releasing) coupler, DIR-hydroquinone, and a coupler which releases DIR-hydroquinone or its precursor. For a development inhibitor having high diffusivity, the development inhibiting effect can be obtained regardless of the position of the donor layer in a multilayered interlayer arrangement. However, a development inhibiting effect in an unintended direction also occurs. To correct this effect, therefore, it is preferable to make the donor layer generate a color (e.g., to make the donor layer generate the same color as a layer which undergoes the influence of the undesired development inhibiting effect). Generation of magenta is preferable to obtain the spectral sensitivity of the present invention.

The size and shape of silver halide grains to be used in the layer having the interlayer effect on red-sensitive layers are not particularly restricted. It is, however, favorable to use so-called tabular grains having a high aspect ratio, a monodisperse emulsion which is uniform in grain size, or silver iodobromide grains having a layered structure of iodide. In addition, to enlarge the exposure latitude, it is preferable to mix two or more types of emulsions different in grain size.

Although the donor layer which donates the interlayer effect to a red-sensitive layer can be formed in any position on a support, it is preferable to form this layer closer to the support than a blue-sensitive layer and farther from the support than a green-sensitive layer. It is more preferable that the donor layer be located closer to the support than a yellow filter layer.

It is further preferable that the donor layer which donates the interlayer effect to a red-sensitive layer be located closer to a support than a green-sensitive layer and farther from the support than the red-sensitive layer. It is most preferable that the donor layer be located adjacent to the side of a green-sensitive layer close to a support. “Adjacent” means that there is no interlayer or the like in between.

The layer which donates the interlayer effect to a red-sensitive layer can include a plurality of layers. In that case, these layers can be either adjacent to or separated from each other.

Solid disperse dyes described in JP-A-11-305396, the disclosure of which is incorporated herein by reference can be used in the present invention.

The emulsion of the present invention relates to a silver iodobromide, silver bromide or silver chloroiodobromide tabular grain emulsion.

With respect to the color photographic lightsensitive material of the present invention, preferably, each unit lightsensitive layer is constituted of a plurality of silver halide emulsion layers which exhibit substantially identical color sensitivity but are different in speed, and 50% or more of the total projected area of silver halide grains contained in at least one layer of the emulsion layers with the highest photographic speed among the silver halide emulsion layers constituting each of the unit lightsensitive layers consists of tabular silver halide grains (hereinafter also referred to as “tabular grains”). In the present invention, the average aspect ratio of such tabular grains is preferably 8 or higher, more preferably 12 or higher, and most preferably 15 or higher.

With respect to tabular grains, the aspect ratio refers to the ratio of diameter to thickness of silver halides. That is, the aspect ratio is the quotient of diameter divided by thickness with respect to each individual silver halide grain. Herein, the diameter refers to the diameter of a circle with an area equal to the projected area of grain exhibited when silver halide grains are observed through a microscope or an electron microscope. Further, herein, the average aspect ratio refers to the average of aspect ratios regarding all the tabular grains of each emulsion.

The method of taking a transmission electron micrograph by the replica technique and measuring the equivalent circle diameter and thickness of each individual grain can be mentioned as an example of aspect ratio determining method. In the mentioned method, the thickness is calculated from the length of replica shadow.

The configuration of tabular grains of the present invention is generally hexagonal. The terminology “hexagonal configuration” means that the shape of the main planes of tabular grains is hexagonal, the adjacent side ratio (maximum side length/minimum side length) thereof being 2 or less. The adjacent side ratio is preferably 1.6 or less, more preferably 1.2 or less. It is needless to mention that the lower limit thereof is 1.0. In the grains of high aspect ratio, especially, triangular tabular grains are increased in the tabular grains. The triangular tabular grains are produced when the Ostwald ripening has excessively been advanced. From the viewpoint of obtaining substantially hexagonal tabular grains, it is preferred that the period of this ripening be minimized. For this purpose, it is requisite to endeavor to raise the tabular grain ratio by nucleation. It is preferred that one or both of an aqueous silver ion solution and an aqueous bromide ion solution contain gelatin for the purpose of raising the probability of occurrence of hexagonal tabular grains at the time of adding silver ions and bromide ions to a reaction mixture according to the double jet technique, as described in JP-A-63-11928 by Saito.

The hexagonal tabular grains contained in the lightsensitive material of the present invention are formed through the steps of nucleation, Ostwald ripening and growth. Although all of these steps are important for suppressing the spread of grain size distribution, attention should be paid so as to avoid the spread of size distribution at the first nucleation step because the spread of size distribution brought about in the above steps cannot be narrowed by an ensuing step. What is important in the nucleation step is the relationship between the temperature of reaction mixture and the period of time of nucleation comprising adding silver ions and bromide ions to a reaction mixture according to the double jet technique and producing precipitates. JP-A-63-92942 by Saito describes that it is preferred that the temperature of the reaction mixture at the time of nucleation be in the range of from 20 to 45° C. for realizing a monodispersity enhancement. Further, JP-A-2-222940 by Zola et al describes that the suitable temperature at nucleation is 60° C. or below.

Supplemental addition of gelatin may be effected during the grain formation in order to obtain monodisperse tabular grains of high aspect ratio. The added gelatin is preferably a chemically modified gelatin as described in JP-A's-10-148897 and 11-143002. This chemically modified gelatin is a gelatin characterized in that at least two carboxyl groups have newly been introduced at a chemical modification of amino groups contained in the gelatin, and it is preferred that gelatin trimellitate be used as the same. Also, gelatin succinate is preferably used. The chemically modified gelatin is preferably added prior to the growth step, more preferably immediately after the nucleation.

The addition amount thereof is preferably 60% or greater, more preferably 80% or greater, and most preferably 90% or greater, based on the total mass of dispersion medium used in grain formation.

The tabular grain emulsion is constituted of silver iodobromide or silver chloroiodobromide. Although silver chloride may be contained, the silver chloride content is preferably 8 mol % or less, more preferably 3 mol % or less, and most preferably 0 mol %. With respect to the silver iodide content, it is preferably 20 mol % or less inasmuch as the variation coefficient of the grain size distribution of the tabular grain emulsion is preferably 30% or less. The lowering of the variation coefficient of the distribution of equivalent circle diameter of the tabular grain emulsion can be facilitated by decreasing the silver iodide content. It is especially preferred that the variation coefficient of the grain size distribution of the tabular grain emulsion be 20% or less while the silver iodide content be 10 mol % or less.

Furthermore, it is preferred that the tabular grain emulsion have some intragranular structure with respect to the silver iodide distribution. The silver iodide distribution may have a double structure, a treble structure, a quadruple structure or a structure of higher order.

In the present invention, tabular grains have dislocation lines. Dislocation lines in tabular grains can be observed by a direct method performed using a transmission electron microscope at a low temperature, as described in, e.g., J. F. Hamilton, Phot. Sci. Eng., 11, 57, (1967) or T. Shiozawa, J. Soc. Phot. Sci. Japan, 3, 5, 213, (1972). That is, silver halide grains, carefully extracted from an emulsion so as not to apply any pressure by which dislocations are produced in the grains, are placed on a mesh for electron microscopic observation. Observation is performed by a transmission method while the sample is cooled to prevent damage (e.g., print out) due to electron rays. In this observation, as the thickness of a grain is increased, it becomes more difficult to transmit electron rays through it. Therefore, grains can be observed more clearly by using an electron microscope of a high voltage type (200 kV or more for a grain having a thickness of 0.25 μm). From photographs of grains obtained by the above method, it is possible to obtain the positions and the number of dislocations in each grain viewed in a direction perpendicular to the principal planes of the grain.

The average number of dislocation lines is preferably 10 or more, and more preferably, 20 or more per grain. If dislocation lines are densely present or cross each other, it is sometimes impossible to correctly count dislocation lines per grain. Even in these situations, however, dislocation lines can be roughly counted to such an extent that their number is approximately 10, 20, or 30. This makes it possible to distinguish these grains from those in which obviously only a few dislocation lines are present. The average number of dislocation lines per grain is obtained as a number average by counting dislocation lines of 100 or more grains. Several hundreds of dislocation lines are sometimes found.

Dislocation lines can be introduced to, e.g., a portion near the peripheral region of a tabular grain. In this case, dislocations are substantially perpendicular to the peripheral region and produced from a position x % of the length between the center and the edge (peripheral region) of a tabular grain to the peripheral region. The value of x is preferably 10 to less than 100, more preferably, 30 to less than 99, and most preferably, 50 to less than 98. Although the shape obtained by connecting the start positions of the dislocations is almost similar to the shape of the grain, this shape is not perfectly similar but sometimes distorted. Dislocations of this type are not found in the central region of a grain. The direction of dislocation lines is crystallographically, approximately a (211) direction. Dislocation lines, however, are often zigzagged and sometimes cross each other.

A tabular grain can have dislocation lines either almost uniformly across the whole peripheral region or at a particular position of the peripheral region. That is, in the case of a hexagonal tabular silver halide grain, dislocation lines can be limited to either portions near the six corners or only a portion near one of the six corners. In contrast, it is also possible to limit dislocation lines to only portions near the edges except for the portions near the six corners.

Dislocation lines can also be formed across a region containing the centers of two principal planes of a tabular grain. When dislocation lines are formed across the entire region of the principal planes, the direction of the dislocation lines is sometimes crystallographically, approximately a (211) direction with respect to a direction perpendicular to the principal planes. In some cases, however, the direction is a (110) direction or random. The lengths of the individual dislocation lines are also random; the dislocation lines are sometimes observed as short lines on the principal planes and sometimes observed as long lines reaching the edges (peripheral region). Although dislocation lines are sometimes straight, they are often zigzagged. In many cases, dislocation lines cross each other.

As described above, the position of dislocation lines can be either limited on the peripheral region or the principal planes or a local position on at least one of them. That is, dislocation lines can be present on both the peripheral region and the principal planes.

Introducing dislocation lines to a tabular grain can be achieved by forming a specific silver iodide rich phase inside the grain. This silver iodide rich phase can include a discontinuous silver iodide rich region. More specifically, after a substrate grain is prepared, the silver iodide rich phase is formed and covered with a layer having a silver iodide content lower than that of the silver iodide rich phase. The silver iodide content of the substrate tabular grain is lower than that of the silver iodide rich phase, and is preferably 0 to 20 mol %, and more preferably, 0 to 15 mol %.

In this specification, the silver iodide rich phase inside a grain is a silver halide solid solution containing silver iodide. This silver halide is preferably silver iodide, silver iodobromide, or silver bromochloroiodide, and more preferably, silver iodide or silver iodobromide (the silver iodide content with respect to a silver halide contained in this silver iodide rich phase is 10 to 40 mol %). To cause this silver iodide rich phase inside a grain (to be referred to as an internal silver iodide rich phase hereinafter) to selectively exist on the edge, the corner, or the surface of a substrate grain, it is desirable to control the formation conditions of the substrate grain, the formation conditions of the internal silver iodide rich phase, and the formation conditions of a phase covering the outside of the internal silver iodide rich phase. Important factors as the formation conditions of a substrate grain are the pAg (the logarithm of the reciprocal of a silver ion concentration), the presence/absence, type, and amount of a silver halide solvent, and the temperature. By controlling the pAg to preferably 8.5 or less, more preferably, 8 or less during the growth of substrate grains, the internal silver iodide rich phase can be made to selectively exist in portions near the corners or on the surface of the substrate grain, when this silver iodide rich phase is formed later.

On the other hand, by controlling the pAg to preferably 8.5 or more, more preferably, 9 or more during the growth of substrate grains, the internal silver iodide rich phase can be made to exist on the edges of the substrate grain. The threshold value of the pAg rises and falls depending on the temperature and the presence/absence, type, and amount of a silver halide solvent. When thiocyanate is used as the silver halide solvent, this threshold value of the pAg shifts to higher values. The value of the pAg at the end of the growth of substrate grains is particularly important, among other pAg values during the growth. On the other hand, even if the pAg during the growth does not meet the above value, the position of the internal silver iodide rich phase can be controlled by performing ripening by controlling the pAg to the above proper value after the growth of substrate grains. In this case, ammonia, an amine compound, a thiourea derivative, or thiocyanate salt can be effectively used as the silver halide solvent. The internal silver iodide rich phase can be formed by a so-called conversion method.

This method includes a method which, at a certain point during grain formation, adds halogen ion smaller in solubility for salt for forming silver ion than halogen ion that forms grains or portions near the surfaces of grains at that point. In the present invention, the amount of halogen ion having a smaller solubility to be added preferably takes a certain value (related to a halogen composition) with respect to the surface area of grains at that point. For example, at a given point during grain formation, it is preferable to add a certain amount or more of KI with respect to the surface area of silver halide grains at that point. More specifically, it is preferable to add 8.2×10⁻⁵ mol/m² or more of iodide salt.

A more preferable method of forming the internal silver iodide rich phase is to add an aqueous silver salt solution simultaneously with addition of an aqueous silver halide solution containing iodide salt.

As an example, an aqueous AgNO₃ solution is added simultaneously with addition of an aqueous KI solution by the double-jet method. In this case, the addition start timings and the addition end timings of the aqueous KI solution and the aqueous AgNO₃ solution can be shifted from each other. The addition molar ratio of the aqueous AgNO₃ solution to the aqueous KI solution is preferably 0.1 or more, more preferably, 0.5 or more, and most preferably, 1 or more. The total addition molar quantity of the aqueous AgNO₃ solution can exit in a silver excess region with respect to halogen ion in the system and iodine ion added. During the addition of the aqueous silver halide solution containing iodine ion and the addition of the aqueous silver salt solution by the double-jet method, the pAg preferably decreases with the addition time by the double-jet. The pAg before the addition is preferably 6.5 to 13, and more preferably, 7.0 to 11. The pAg at the end of the addition is most preferably 6.5 to 10.0.

In carrying out the above method, the solubility of a silver halide in the mixing system is preferably as low as possible. Therefore, the temperature of the mixing system at which the silver iodide rich phase is formed is preferably 30° C. to 80° C., and more preferably, 30° C. to 70° C.

The formation of the internal silver iodide rich phase is most preferably performed by adding fine-grain silver iodide, fine-grain silver iodobromide, fine-grain silver chloroiodide, or fine-grain silver bromochloroiodide. The addition of fine-grain silver iodide is particularly preferred. These fine grains normally have a grain size of 0.01 to 0.1 μm, but those having a grain size of 0.01 μm or less or 0.1 μm or more can also be used. Methods of preparing these fine silver halide grains are described in JP-A's-1-183417, 2-44335, 1-183644, 1-183645, 2-43534, and 2-43535, the disclosures of which are incorporated herein by reference. The internal silver iodide rich phase can be formed by adding and ripening these fine silver halide grains.

In dissolving the fine grains by ripening, the silver halide solvent described above can also be used. These fine grains added need not immediately, completely dissolve to disappear but need only disappear by dissolution when the final grains are completed.

The internal silver iodide rich phase is located in a region of, when measuring from the center of, e.g., a hexagon formed in a plane by projecting a grain thereon, preferably 5 to less than 100 mol %, more preferably, 20 to less than 95 mol %, and most preferably, 50 to less than 90 mol % with respect to the total silver amount of the grain. The amount of a silver halide which forms the internal silver iodide rich phase is, as a silver amount, preferably 50 mol % or less, and more preferably, 20 mol % or less of the total silver amount of a grain. These values of amounts of the silver iodide rich phase are not those obtained by measuring the halogen composition of the final grain by using various analytical methods but formulated values in the producing of a silver halide emulsion. The internal silver iodide rich phase often disappears from the final grain owing to, e.g., recrystallization, and so all silver amounts described above are related to their formulated values.

It is, therefore, readily possible to observe dislocation lines in the final grains by the above method, but the internal silver iodide rich phase introduced to introduce dislocation lines cannot be observed as a definite phase in many cases because the silver iodide composition in the boundary continuously changes. The halogen compositions in each portion of a grain can be checked by combining X-ray diffraction, an EPMA (also called an XMA) method (a method of scanning a silver halide grain by electron rays to detect its silver halide composition), and an ESCA (also called an XPS) method (a method of radiating X-rays to spectroscopically detect photoelectrons emitted from the surface of a grain).

The silver iodide content of an outer phase covering the internal silver iodide rich phase is lower than that of the silver iodide rich phase, and is preferably 0 to 30 mol %, more preferably, 0 to 20 mol %, and most preferably, 0 to 10 mol % with respect to a silver halide amount contained in the outer phase.

Although the temperature and the pAg, at which the outer phase covering the internal silver iodide rich phase is formed, can take arbitrary values, the temperature is preferably 30° C. to 80° C., and most preferably, 35° C. to 70° C., and the pAg is preferably 6.5 to 11.5. The use of the silver halide solvents described above is sometimes preferable, and the most preferable silver halide solvent is thiocyanate salt.

Another method of introducing dislocation lines to tabular grains is to use an iodide ion releasing agent as described in JP-A-6-11782, the disclosure of which is incorporated herein by reference. This method is also preferably used.

Dislocation lines can also be introduced by appropriately combining this dislocation line introducing method with the above-mentioned dislocation line introducing method.

The variation coefficient of the inter-grain iodide distribution of silver halide grains contained in a light-sensitive material of the present invention is preferably 20% or less, more preferably, 15% or less, and most preferably, 10% or less. If the variation coefficient of the iodide content distribution of each individual silver halide is larger than 20%, no high contrast can be obtained, and a reduction of the sensitivity upon application of a pressure increases.

Any known method can be used as a method of producing silver halide grains contained in a light-sensitive material of the present invention and having a narrow inter-grain iodide distribution. Examples are a method of adding fine grains as disclosed in JP-A-1-183417 and a method which uses an iodide ion releasing agent as disclosed in JP-A-2-68538, the disclosures of which are incorporated herein by reference. These methods can be used alone or in combination.

The variation coefficient of the inter-grain iodide distribution of silver halide grains of the present invention is preferably 20% or less. The most preferred method of monodispersing the inter-grain iodide distribution is a method described in JP-A-3-213845, the disclosure of which is incorporated herein by reference. That is, fine silver halide grains containing 95 mol % or more of silver iodide are formed by mixing an aqueous solution of a water-soluble silver salt and an aqueous solution of a water-soluble halide (containing 95 mol % or more of iodide ions) in a mixer placed outside a reaction vessel, and supplied to the reaction vessel immediately after the formation. In this manner, a monodisperse inter-grain iodide distribution can be achieved. The reaction vessel is a vessel which causes nucleation and/or crystal growth of tabular silver halide grains.

As described in JP-A-3-213845, the disclosure of which is incorporated herein by reference, the following three technologies can be used as a method of adding the silver halide grains prepared in the mixer and as a preparing means used in the method.

(1) After being formed in the mixer, the fine grains are immediately added to the reaction vessel.

(2) Strong and efficient stirring is performed in the mixer.

(3) An aqueous protective colloid solution is poured into the mixer.

The protective colloid used in method (3) above can be singly poured into the mixer or can be poured into the mixer after being contained in an aqueous halogen salt solution or aqueous silver nitrate solution. The concentration of the protective colloid is 1 mass % or more, preferably 2 to 5 mass %. Examples of a polymer compound having a protective colloid function with respect to silver halide grains used in the present invention are a polyacrylamide polymer, an amino polymer, a polymer having a thioether group, polyvinyl alcohol, an acrylic acid polymer, a polymer having hydroxyquinoline, cellulose, starch, acetal, polyvinylpyrrolidone, and a ternary polymer. The use of low-molecular-weight gelatin is preferred. The weight-average molecular weight of this low-molecular-weight gelatin is preferably 30,000 or less, and more preferably, 10,000 or less.

When fine silver halide grains are to be prepared, the grain formation temperature is preferably 35° C. or less, and particularly preferably, 25° C. or less. The temperature of the reaction vessel to which fine silver halide grains are added is 50° C. or more, preferably 60° C. or more, and more preferably, 70° C. or more.

The grain size of a fine silver halide used in the present invention can be directly confirmed by a transmission electron microscope by placing the grain on a mesh. The size of fine grains of the present invention is preferably 0.3 μm or less, more preferably, 0.1 μm or less, and most preferably, 0.01 μm or less. This fine silver halide can be added simultaneously with another halogen ion or silver ion or can be added alone. The mixing amount of the fine silver halide grains is 0.005 to 20 mol %, preferably 0.01 to 10 mol % with respect to a total silver halide.

The silver iodide content of each grain can be measured by analyzing the composition of the grain by using an X-ray microanalyzer. The variation coefficient of an inter-grain iodide distribution is a value defined by (standard deviation/average silver iodide content)×100=variation coefficient (%)

by using the standard deviation of silver iodide contents and the average silver iodide content when the silver iodide contents of at least 100, more preferably, 200, and most preferably, 300 emulsion grains are measured. The measurement of the silver iodide content of each individual grain is described in, e.g., European Patent 147,868. A silver iodide content Yi [mol %] and an equivalent-sphere diameter Xi [μm] of each grain sometimes have a correlation and sometimes do not. However, Yi and Xi desirably have no correlation. The halogen composition structure of a tabular grain of the present invention can be checked by combining, e.g., X-ray diffraction, an EPMA (also called an XMA) method (a method of scanning a silver halide grain by electron rays to detect its silver halide composition), and an ESCA (also called an XPS) method (a method of radiating X-rays to spectroscopically detect photoelectrons emitted from the surface of a grain). When the silver iodide content is measured in the present invention, the grain surface is a region about 5 nm deep from the surface, and the grain interior is a region except for the surface. The halogen composition of this grain surface can usually be measured by the ESCA method.

In the present invention, regular-crystal grains such as cubic, octahedral, and tetradecahedral grains and irregular twinned-crystal grains can be used in addition to aforementioned tabular grains.

Silver halide emulsions of the present invention are preferably subjected to selenium sensitization or gold sensitization.

As selenium sensitizers usable in the present invention, selenium compounds disclosed in conventionally known patents can be used. Usually, a labile selenium compound and/or a non-labile selenium compound is used by adding it to an emulsion and stirring the emulsion at a high temperature, preferably 40° C. or more for a predetermined period of time. As non-labile selenium compounds, it is preferable to use compounds described in, e.g., JP-B-44-15748, JP-B-43-13489, and JP-A's-4-25832 and 4-109240, the disclosures of which are incorporated herein by reference.

Practical examples of a labile selenium sensitizer are isoselenocyanates (e.g., aliphatic isoselenocyanates such as allylisoselenocyanate), selenoureas, selenoketones, selenoamides, selenocarboxylic acids (e.g., 2-selenopropionic acid and 2-selenobutyric acid), selenoesters, diacylselenides (e.g., bis(3-chloro-2,6-dimethoxybenzoyl)selenide), selenophosphates, phosphineselenides, and colloidal metal selenium.

Although preferred examples of a labile selenium compound are described above, the present invention is not limited to these examples. It is generally agreed by those skilled in the art that the structure of a labile selenium compound used as a sensitizer for a photographic emulsion is not so important as long as selenium is labile, and that the organic part of a molecule of a selenium sensitizer has no important role except the role of carrying selenium and keeping it in a labile state in an emulsion. In the present invention, therefore, labile selenium compounds in this extensive concept are advantageously used.

Examples of a non-labile selenium compound usable in the present invention are compounds described in JP-B's-46-4553, 52-34491, and 52-34492, the disclosures of which are incorporated herein by reference. Practical examples of a non-labile selenium compound are selenious acid, potassium selenocyanide, selenazoles, quaternary ammonium salts of selenazoles, diarylselenide, diaryldiselenide, dialkylselenide, dialkyldiselenide, 2-selenazolidinedione, 2-selenoxazolidinethione, and derivatives of these compounds.

These selenium sensitizers are dissolved in water, an organic solvent such as methanol or ethanol, or a solvent mixture of such organic solvents, and the resultant solution is added during chemical sensitization, preferably before the start of chemical sensitization. A selenium sensitizer to be used is not limited to one type, but two or more types of the selenium sensitizers described above can be used together. Combining a labile selenium compound and a non-labile selenium compound is preferred.

The addition amount of selenium sensitizers usable in the present invention changes in accordance with the activity of each selenium sensitizer used, the type or grain size of a silver halide, and the temperature and time of ripening. The addition amount, however, is preferably 2×10⁻⁶ to 5×10⁻⁶ mol per mol of a silver halide. When selenium sensitizers are used, the temperature of chemical sensitization is preferably 40° C. to 80° C. The pAg and pH can take given values. For example, the effect of the present invention can be obtained in a wide pH range of 4 to 9.

Selenium sensitization can be achieved more effectively in the presence of a silver halide solvent.

Examples of a silver halide solvent usable in the present invention are (a) organic thioethers described in U.S. Pat. Nos. 3,271,157, 3,531,289, and 3,574,628, and JP-A's-54-1019 and 54-158917, the disclosures of which are incorporated herein by reference, (b) thiourea derivatives described in JP-A's-53-82408, 55-77737, and 55-2982, the disclosures of which are incorporated herein by reference, (c) a silver halide solvent having a thiocarbonyl group sandwiched between an oxygen or sulfur atom and a nitrogen atom, described in JP-A-53-144319, the disclosure of which is incorporated herein by reference, (d) imidazoles described in JP-A-54-100717, the disclosure of which is incorporated herein by reference, (e) sulfite, and (f) thiocyanate.

Most preferred examples of a silver halide solvent are thiocyanate and tetramethylthiourea. Although the amount of a solvent to be used changes in accordance with its type, a preferred amount is 1×10⁻⁴ to 1×10⁻² mol per mol of a silver halide.

A gold sensitizer for use in gold sensitization of the present invention can be any compound having an oxidation number of gold of +1 or +3, and it is possible to use gold compounds normally used as gold sensitizers. Representative examples are chloroaurate, potassium chloroaurate, aurictrichloride, potassium auricthiocyanate, potassium iodoaurate, tetracyanoauric acid, ammonium aurothiocyanate, pyridyltrichloro gold, gold sulfide, and gold selenide. Although the addition amount of gold sensitizers changes in accordance with various conditions, the amount is preferably 1×10⁻⁷ to 5×10⁻⁵ mol per mol of a silver halide.

Emulsions of the present invention are preferably subjected to sulfur sensitization during chemical sensitization.

This sulfur sensitization is commonly performed by adding sulfur sensitizers and stirring the emulsion for a predetermined time at a high temperature, preferably 40° C. or more.

Sulfur sensitizers known to those skilled in the art can be used in sulfur sensitization. Examples are thiosulfate, allylthiocarbamidothiourea, allylisothiacyanate, cystine, p-toluenethiosulfonate, and rhodanine. It is also possible to use sulfur sensitizers described in, e.g., U.S. Pat. Nos. 1,574,944, 2,410,689, 2,278,947, 2,728,668, 3,501,313, and 3,656,955, German Patent 1,422,869, JP-B-56-24937, and JP-A-55-45016, the disclosures of which are incorporated herein by reference. The addition amount of sulfur sensitizers need only be large enough to effectively increase the sensitivity of an emulsion. This amount changes over a wide range in accordance with various conditions, such as the pH, the temperature, and the size of silver halide grains. However, the amount is preferably 1×10⁻⁷ to 5×10⁻⁵ mol per mol of a silver halide.

Silver halide emulsions of the present invention can also be subjected to reduction sensitization during grain formation, after grain formation and before or during chemical sensitization, or after chemical sensitization.

Reduction sensitization can be selected from a method of adding reduction sensitizers to a silver halide emulsion, a method called silver ripening in which grains are grown or ripened in a low-pAg ambient at pAg 1 to 7, and a method called high-pH ripening in which grains are grown or ripened in a high-pH ambient at pH 8 to 11. Two or more of these methods can also be used together.

The method of adding reduction sensitizers is preferred in that the level of reduction sensitization can be finely adjusted.

Known examples of reduction sensitizers are stannous salt, ascorbic acid and its derivative, amines and polyamines, a hydrazine derivative, formamidinesulfinic acid, a silane compound, and a borane compound. In reduction sensitization of the present invention, it is possible to selectively use these known reduction sensitizers or to use two or more types of compounds together. Preferred compounds as reduction sensitizers are stannous chloride, thiourea dioxide, dimethylamineborane, and ascorbic acid and its derivative. Although the addition amount of reduction sensitizers must be so selected as to meet the emulsion producing conditions, a preferable amount is 10⁻⁷ to 10⁻³ mol per mol of a silver halide.

Reduction sensitizers are dissolved in water or an organic solvent such as alcohols, glycols, ketones, esters, or amides, and the resultant solution is added during grain growth. Although adding to a reactor vessel in advance is also preferred, adding at a given timing during grain growth is more preferred. It is also possible to add reduction sensitizers to an aqueous solution of a water-soluble silver salt or of a water-soluble alkali halide to precipitate silver halide grains by using this aqueous solution. Alternatively, a solution of reduction sensitizers can be added separately several times or continuously over a long time period with grain growth.

It is preferable to use an oxidizer for silver during the process of producing emulsions of the present invention. An oxidizer for silver is a compound having an effect of converting metal silver into silver ion. A particularly effective compound is the one that converts very fine silver grains, formed as a by-product in the process of formation and chemical sensitization of silver halide grains, into silver ion. The silver ion produced can form a silver salt hard to dissolve in water, such as a silver halide, silver sulfide, or silver selenide, or a silver salt easy to dissolve in water, such as silver nitrate. An oxidizer for silver can be either an inorganic or organic substance. Examples of an inorganic oxidizer are ozone, hydrogen peroxide and its adduct (e.g., NaBO₂.H₂O₂.3H₂O, 2NaCO₃.3H₂O₂, Na₄P₂O₇.2H₂O₂, and 2Na₂SO₄.H₂O₂.2H₂O), peroxy acid salt (e.g., K₂S₂O₈, K₂C₂O₆, and K₂P₂O₈), a peroxy complex compound (e.g., K₂[Ti(O₂)C₂O₄].3H₂O, 4K₂SO₄.Ti(O₂)OH.SO₄.2H₂O, and Na₃[VO(O₂)(C₂H₄)₂.6H₂O]), permanganate (e.g., KMnO₄), an oxyacid salt such as chromate (e.g., K₂Cr₂O₇), a halogen element such as iodine and bromine, perhalogenate (e.g., potassium periodate), a salt of a high-valence metal (e.g., potassium hexacyanoferrate(II)), and thiosulfonate.

Examples of an organic oxidizer are quinones such as p-quinone, an organic peroxide such as peracetic acid and perbenzoic acid, and a compound for releasing active halogen (e.g., N-bromosuccinimide, chloramine T, and chloramine B).

Preferable oxidizers of the present invention are inorganic oxidizers such as ozone, hydrogen peroxide and its adduct, a halogen element, and thiosulfonate, and organic oxidizers such as quinones.

It is preferable to use the reduction sensitization described above and the oxidizer for silver together. In this case, the reduction sensitization can be performed after the oxidizer is used or vice versa, or the oxidizer can be used simultaneously with the reduction sensitization. These methods can be applied to both the grain formation step and the chemical sensitization step.

Photographic emulsions of the present invention can achieve high color saturation when spectrally sensitized by preferably methine dyes and the like. Usable dyes involve a cyanine dye, merocyanine dye, composite cyanine dye, composite merocyanine dye, holopolar cyanine dye, hemicyanine dye, styryl dye, and hemioxonole dye. Most useful dyes are those belonging to a cyanine dye, merocyanine dye, and composite merocyanine dye. These dyes can contain any nucleus commonly used as a basic heterocyclic nucleus in cyanine dyes.

Examples are a pyrroline nucleus, oxazoline nucleus, thiazoline nucleus, pyrrole nucleus, oxazole nucleus, thiazole nucleus, selenazole nucleus, imidazole nucleus, tetrazole nucleus, and pyridine nucleus; a nucleus in which an aliphatic hydrocarbon ring is fused to any of the above nuclei; and a nucleus in which an aromatic hydrocarbon ring is fused to any of the above nuclei, e.g., an indolenine nucleus, benzindolenine nucleus, indole nucleus, benzoxadole nucleus, naphthoxazole nucleus, benzthiazole nucleus, naphthothiazole nucleus, benzoselenazole nucleus, benzimidazole nucleus, and quinoline nucleus. These nuclei can be substituted on a carbon atom.

It is possible to apply to a merocyanine dye or a composite merocyanine dye a 5- or 6-membered heterocyclic nucleus as a nucleus having a ketomethylene structure. Examples are a pyrazoline-5-one nucleus, thiohydantoin nucleus, 2-thiooxazolidine-2,4-dione nucleus, thiazolidine-2,4-dione nucleus, rhodanine nucleus, and thiobarbituric acid nucleus.

Although these sensitizing dyes can be used singly, they can also be combined. The combination of sensitizing dyes is often used for a supersensitization purpose. Representative examples of the combination are described in U.S. Pat. Nos. 2,688,545, 2,977,229, 3,397,060, 3,522,0523, 3,527,641, 3,617,293, 3,628,964, 3,666,480, 3,672,898, 3,679,4283, 3,703,377, 3,769,301, 3,814,609, 3,837,862, and 4,026,707, British Patents 1,344,281 and 1,507,803, JP-B's-43-4936 and 53-12375, and JP-A's-52-110618 and 52-109925, the disclosures of which are incorporated herein by reference.

In addition to sensitizing dyes, emulsions can contain dyes having no spectral sensitizing effect or substances not substantially absorbing visible light and presenting supersensitization.

The present invention is preferably combined with a technique of increasing a light absorption factor by the addition of a spectral sensitizing dye. For example, there can be mentioned more than monolayer saturated adsorption (namely, single-layer adsorption) of a sensitizing dye onto the surface of silver halide grains by means of intermolecular force, or adsorption of a so-called connected dye, comprising a plurality of chromophores connected to each other by covalent bonds without separate conjugation. As the techniques, there can be mentioned the following patent publications: JP-A's-10-239789, 11-133531, 2000-267216, 2000-275772, 2001-75222, 2001-75247, 2001-75221, 2001-75226, 2001-75223, 2001-255615, 2002-23294, 2002-99053, 2002-148767, 2002-287309, 2002-351004, 2002-365752, 2003-121956, 2004-184596, 2004-191926, 2004-219784, 2004-280062, 10-171058, 10-186559, 10-197980, 2000-81678, 2001-5132, 2001-13614, 2001-166413, 2002-49113, 2003-177486, 64-91134, 10-110107, 10-226758, 10-307358, 10-307359, 10-310715, 2000-231174, 2000-231172, 2000-231173, 2001-356442, 2002-55406, 2002-169258 and 2003-121957 and EP's 985965A, 985964A, 985966A, 985967A, 1085372A, 1085373A, 1172688A, 1199595A, 887700A1 and 1439417A1 and U.S. Pat. Nos. 6,699,652B1, 6,790,602B2, 6,794,121B2, 6,787,297B1, 2004/0142288A1 and 2004/0146818A1.

It is still more preferred to combine the present invention with techniques described in the following patent publications:

JP-A's-10-239789, 10-171058, 2001-75222, 2002-287309, 2004-184596 and 2004-191926.

Sensitizing dyes can be added to an emulsion at any point conventionally known to be useful during the preparation of an emulsion. Most ordinarily, sensitizing dyes are added after the completion of chemical sensitization and before coating. However, it is possible to perform the addition simultaneously with the addition of chemical sensitizing dyes to thereby perform spectral sensitization and chemical sensitization at the same time, as described in U.S. Pat. Nos. 3,628,969 and 4,225,666, the disclosures of which are incorporated herein by reference. It is also possible to perform the addition prior to chemical sensitization, as described in JP-A-58-113928, the disclosure of which is incorporated herein by reference, or before the completion of the formation of a silver halide grain precipitate to thereby start spectral sensitization. Alternatively, as disclosed in U.S. Pat. No. 4,225,666, these sensitizing dyes can be added separately; a portion of the sensitizing dyes is added prior to chemical sensitization, and the rest is added after that. That is, sensitizing dyes can be added at any timing during the formation of silver halide grains, including the method disclosed in U.S. Pat. No. 4,183,756, the disclosure of which is incorporated herein by reference.

When a plurality of sensitizing dyes are to be added, these sensitizing dyes can be separately added with predetermined pauses between them or added mixedly, or a portion of one sensitizing dye is previously added and the rest is added together with the other sensitizing dyes. That is, it is possible to select an optimum method in accordance with the types of the chosen sensitizing dyes and with the desired spectral sensitivity.

The addition amount of sensitizing dyes can be 4×10⁻⁶ to 8×10⁻³ mol per mol of a silver halide. However, for a more favorable silver halide grain size of 0.2 to 1.2 μm, an addition amount of about 5×10⁻⁵ to 2×10⁻³ mol is more effective.

The twin plane spacing of a silver halide grain of the present invention is preferably 0.017 μm or less, more preferably, 0.007 to 0.017 μm, and most preferably, 0.007 to 0.015 μm.

Fog occurring while a silver halide emulsion of the present invention is aged can be improved by adding and dissolving a previously prepared silver iodobromide emulsion during chemical sensitization. This silver iodobromide emulsion can be added at any timing during chemical sensitization. However, it is preferable to first add and dissolve the silver iodobromide emulsion and then add sensitizing dyes and chemical sensitizers in this order. The silver iodobromide emulsion used has an iodide content lower than the surface iodide content of a host grain, and is preferably a pure silver bromide emulsion. The size of this silver iodobromide emulsion is not limited as long as the emulsion can be completely dissolved. However, the equivalent-sphere diameter is preferably 0.1 μm or less, and more preferably, 0.05 μm or less. Although the addition amount of the silver iodobromide emulsion changes in accordance with a host grain used, the amount is basically preferably 0.005 to 5 mol %, and more preferably, 0.1 to 1 mol % per mol of silver.

Common dopants known to be useful to silver halide emulsions can be used in emulsions used in the present invention. Examples of common dopants are Fe, Co, Ni, Ru, Rh, Pd, Re, Os, Ir, Pt, Au, Hg, Pb, and Tl. In the present invention, a hexacyano iron(II) complex and hexacyanoruthenium complex (to be simply referred to as “metal complexes” hereinafter) are preferably used.

The addition amount of these metal complexes is preferably 10⁻⁷ to 10⁻³ mol, and more preferably, 1.0×10⁻⁵ to 5×10⁻⁴ mol per mol of a silver halide.

Metal complexes used in the present invention can be added in any stage of the preparation of silver halide grains, i.e., before or after nucleation, growth, physical ripening, or chemical sensitization. Also, metal complexes can be divisionally added a plurality of times. However, 50% or more of the total content of metal complexes contained in a silver halide grain are preferably contained in a layer ½ or less as a silver amount from the outermost surface of the grain. A layer not containing metal complexes can also be formed on the outside, i.e., on the side away from a support, of the layer containing metal complexes herein mentioned.

These metal complexes are preferably contained by dissolving them in water or an appropriate solvent and directly adding the solution to a reaction solution during the formation of silver halide grains, or by forming silver halide grains by adding them to an aqueous silver salt solution, aqueous silver salt solution, or some other solution for forming the grains. Alternatively, these metal complexes are also favorably contained by adding and dissolving fine silver halide grains previously made to contain the metal complexes, and depositing these grains on other silver halide grains. When these metal complexes are to be added, the hydrogen ion concentration in a reaction solution is such that the pH is preferably 1 to 10, and more preferably, 3 to 7.

It is preferred that the photosensitive material of the present invention contain “a compound which undergoes a one-electron oxidation so as to form a one-electron oxidation product capable of releasing one or more electrons”.

This compound is preferably selected from among the following compounds of type 1 and type 2.

(Type 1)

Compound which undergoes a one-electron oxidation so as to form a one-electron oxidation product capable of, through subsequent bond cleavage reaction, releasing one or more electrons.

(Type 2)

Compound which undergoes a one-electron oxidation so as to form a one-electron oxidation product capable of, after subsequent bond formation reaction, releasing one or more electrons.

With respect to the compound of type 1, as the compound which undergoes a one-electron oxidation so as to form a one-electron oxidation product capable of, through subsequent bond cleavage reaction, releasing one electron, there can be mentioned compounds referred to as “one photon two electrons sensitizers” or “deprotonating electron donating sensitizers”, as described in, for example, JP-A-9-211769 (examples: compounds PMT-1 to S-37 listed in Tables E and F on pages 28 to 32), JP-A-9-211774, JP-A-11-95355 (examples: compounds INV 1 to 36), PCT Japanese Translation Publication 2001-500996 (examples: compounds 1 to 74, 80 to 87 and 92 to 122), U.S. Pat. Nos. 5,747,235 and 5,747,236, EP 786692A1 (examples: compounds INV 1 to 35), EP 893732A1 and U.S. Pat. Nos. 6,054,260 and 5,994,051. Preferred ranges of these compounds are the same as described in the cited patent specifications.

With respect to the compound of type 1, as the compound which undergoes a one-electron oxidation so as to form a one-electron oxidation product capable of, through subsequent bond cleavage reaction, releasing one or more electrons, there can be mentioned compounds of the general formula (1) (identical with the general formula (1) described in JP-A-2003-114487), the general formula (2) (identical with the general formula (2) described in JP-A-2003-114487), the general formula (3) (identical with the general formula (3) described in JP-A-2003-114487), the general formula (3) (identical with the general formula (1) described in JP-A-2003-114488), the general formula (4) (identical with the general formula (2) described in JP-A-2003-114488), the general formula (5) (identical with the general formula (3) described in JP-A-2003-114488), the general formula (6) (identical with the general formula (1) described in JP-A-2003-75950), the general formula (8) (identical with the general formula (1) described in JP-A-2004-239943) and the general formula (9) (identical with the general formula (3) described in JP-A-2004-245929) among the compounds of inducing the reaction represented by the chemical reaction formula (1) (identical with the chemical reaction formula (1) described in JP-A-2004-245929). Preferred ranges of these compounds are the same as described in the cited patent specifications.

As the compounds of type 2, namely, compounds which undergo a one-electron oxidation so as to form a one-electron oxidation product capable of, through subsequent bond formation reaction, releasing one or more electrons, there can be mentioned compounds of the general formula (10) (identical with the general formula (1) described in JP-A-2003-140287) and compounds of the general formula (11) (identical with the general formula (2) described in JP-A-2004-245929) capable of inducing the reaction represented by the chemical reaction formula (1) (identical with the chemical reaction formula (1) described in JP-A-2004-245929). Preferred ranges of these compounds are the same as described in the cited patent specifications.

Among the compounds of types 1 and 2, “compounds having in the molecule an adsorptive group on silver halides” and “compounds having in the molecule a partial structure of spectral sensitizing dye” are preferred. As representative examples of adsorptive groups on silver halides, there can be mentioned groups described in JP-A-2003-156823, page 16 right column line 1 to page 17 right column line 12. The partial structure of spectral sensitizing dye is as described in the same reference, page 17 right column line 34 to page 18 left column line 6.

Among the compounds of types 1 and 2, “compounds having in the molecule at least one adsorptive group on silver halides” are more preferred. “Compounds having in the same molecule two or more adsorptive groups on silver halides” are still more preferred. When two or more adsorptive groups are present in a single molecule, they may be identical with or different from each other.

The compounds of type 1 and type 2 may be added at any stage during the emulsion preparation or photosensitive material production. For example, the addition may be effected at grain formation, desalting, chemical sensitization or coating. The compounds may be divided and added in multiple times during the above stages. The addition stage is preferably after completion of grain formation but before desalting, during chemical sensitization (just before initiation of chemical sensitization to just after termination thereof) or prior to coating. The addition stage is more preferably during chemical sensitization or prior to coating.

The compounds of type 1 and type 2 are preferably dissolved in water, a water soluble solvent such as methanol or ethanol or a mixed solvent thereof before addition. In the dissolving in water, with respect to compounds whose solubility is higher at higher or lower pH value, the dissolution is effected at pH value raised or lowered before addition.

The compounds of type 1 and type 2 according to the present invention, although preferably incorporated in emulsion layers, may be added to not only an emulsion layer but also a protective layer or an interlayer so as to realize diffusion at the time of coating operation. The timing of addition of compounds of the present invention may be before or after sensitizing dye addition, and at either stage the compounds are preferably incorporated in silver halide emulsion layers in an amount of 1×10⁻⁹ to 5×10⁻² mol, more preferably 1×10⁻⁸ to 2×10⁻³ mol per mol of silver halides.

Photographic additives usable in the present invention are also described in RDs, and the relevant portions are summarized in the following table.

| Additives | | RD17643 | RD18716 | RD307105 |
|---|---|---|---|---|
| 1. | Chemical | page 23 | page 648, right | page 866 |
| | sensitizers | | column | |
| 2. | Sensitivity | | page 648, right | |
| | increasing agents | | column | |
| 3. | Spectral | pages 23-24 | page 648, right | pages 866-868 |
| | sensitizers, | | column to page | |
| | super sensitizers | | 649, right column | |
| 4. | Brighteners | page 24 | page 647, right | page 868 |
| | | | column | |
| 5. | Light absorbents, | pages 25-26 | page 649, right | page 873 |
| | filter dyes, | | column to page | |
| | ultraviolet | | 650, left column | |
| | absorbents | | | |
| 6. | Binders | page 26 | page 651, left | pages 873-874 |
| | | | column | |
| 7. | Plasticizers, | page 27 | page 650, right | page 876 |
| | lubricants | | column | |
| 8. | Coating aids, | pages 26-27 | page 650, right | pages 875-876 |
| | surface active | | column | |
| | agents | | | |
| 9. | Antistatic agents | page 27 | page 650, right | pages 876-877 |
| | | | column | |
| 10. | Matting agents | | | pages 878-879 |

Various dye forming couplers can be used in a light-sensitive material of the present invention, and the following couplers are particularly preferable.

Yellow couplers: couplers represented by formulas (I) and (II) in EP502,424A; couplers (particularly Y-28 on page 18) represented by formulas (1) and (2) in EP513,496A; a coupler represented by formula (I) in claim 1 of EP568,037A; a coupler represented by formula (I) in column 1, lines 45 to 55 of U.S. Pat. No. 5,066,576; a coupler represented by formula (I) in paragraph 0008 of JP-A-4-274425; couplers (particularly D-35 on page 18) described in claim 1 on page 40 of EP498,381A1; couplers (particularly Y-1 (page 17) and Y-54 (page 41)) represented by formula (Y) on page 4 of EP447,969A1; and couplers (particularly II-17 and II-19 (column 17), and II-24 (column 19)) represented by formulas (II) to (IV) in column 7, lines 36 to 58 of U.S. Pat. No. 4,476,219, the disclosures of which are incorporated herein by reference.

Magenta couplers: JP-A-3-39737 (L-57 (page 11, lower right column), L-68 (page 12, lower right column), and L-77 (page 13, lower right column); [A-4]-63 (page 134), and [A-4]-73 and [A-4]-75 (page 139) in EP456,257; M-4 and M-6 (page 26), and M-7 (page 27) in EP486,965; M-45 (page 19) in EP571,959A; (M−1) (page 6) in JP-A-5-204106; and M-22 in paragraph 0237 of JP-A-4-362631, the disclosures of which are incorporated herein by reference.

Cyan couplers: CX-1, CX-3, CX-4, CX-5, CX-11, CX-12, CX-14, and CX-15 (pages 14 to 16) in JP-A-4-204843; C-7 and C-10 (page 35), C-34 and C-35 (page 37), and (1-1) and (1-17) (pages 42 and 43) in JP-A-4-43345; and couplers represented by formulas (Ia) and (Ib) in claim 1 of JP-A-6-67385, the disclosures of which are incorporated herein by reference.

Polymer couplers: P-1 and P-5 (page 11) in JP-A-2-44345, the disclosure of which is incorporated herein by reference.

Couplers for forming a colored dye with proper diffusibility are preferably those described in U.S. Pat. No. 4,366,237, GB2,125,570, EP96,873B, and DE3,234,533, the disclosures of which are incorporated herein by reference.

Couplers for correcting unnecessary absorption of a colored dye are preferably yellow colored cyan couplers (particularly YC-86 on page 84) represented by formulas (CI), (CII), (CIII), and (CIV) described on page 5 of EP456,257A1; yellow colored magenta couplers ExM-7 (page 202), EX-1 (page 249), and EX-7 (page 251) described in EP456,257A1; magenta colored cyan couplers CC-9 (column 8) and CC-13 (column 10) described in U.S. Pat. No. 4,833,069; (2) (column 8) in U.S. Pat. No. 4,837,136; and colorless masking couplers (particularly compound examples on pages 36 to 45) represented by formula (A) in claim 1 of WO92/11575, the disclosures of which are incorporated herein by reference.

Examples of compounds (including a coupler) which react with a developing agent in an oxidized form to thereby release a photographically useful compound residue are as follows.

Development inhibitor release compounds: compounds (particularly T-101 (page 30), T-104 (page 31), T-113 (page 36), T-131 (page 45), T-144 (page 51), and T-158 (page 58)) represented by formulas (I), (II), (III), (IV) described on page 11 of EP378,236A1, compounds (particularly D-49 (page 51)) represented by formula (I) described on page 7 of EP436,938A2, compounds (particularly (23) (page 11)) represented by formula (1) in EP568,037A, and compounds (particularly 1-(1) on page 29) represented by formulas (I), (II), and (III) described on pages 5 and 6 of EP440,195A2; bleaching accelerator release compounds: compounds (particularly (60) and (61) on page 61) represented by formulas (I) and (I′) on page 5 of EP310,125A2, and compounds (particularly (7) (page 7)) represented by formula (I) in claim 1 of JP-A-6-59411; ligand release compounds: compounds (particularly compounds in column 12, lines 21 to 41) represented by LIG-X described in claim 1 of U.S. Pat. No. 4,555,478; leuco dye release compounds: compounds 1 to 6 in columns 3 to 8 of U.S. Pat. No. 4,749,641; fluorescent dye release compounds: compounds (particularly compounds 1 to 11 in columns 7 to 10) represented by COUP-DYE in claim 1 of U.S. Pat. No. 4,774,181; development accelerator or fogging agent release compounds: compounds (particularly (1-22) in column 25) represented by formulas (1), (2), and (3) in column 3 of U.S. Pat. No. 4,656,123, and ExZK-2 on page 75, lines 36 to 38 of EP450,637A2; compounds which release a group which does not function as a dye unless it splits off: compounds (particularly Y-1 to Y-19 in columns 25 to 36) represented by formula (I) in claim 1 of U.S. Pat. No. 4,857,447, the disclosures of which are incorporated herein by reference.

Preferred examples of additives other than couplers are as follows.

Dispersants of oil-soluble organic compounds: P-3, P-5, P-16, P-19, P-25, P-30, P-42, P-49, P-54, P-55, P-66, P-81, P-85, P-86, and P-93 (pages 140 to 144) in JP-A-62-215272; impregnating latexes of oil-soluble organic compounds: latexes described in U.S. Pat. No. 4,199,363; developing agent oxidized form scavengers: compounds (particularly I-(1), I-(2), I-(6), and I-(12) (columns 4 and 5)) represented by formula (I) in column 2, lines 54 to 62 of U.S. Pat. No. 4,978,606, and formulas (particularly a compound 1 (column 3)) in column 2, lines 5 to 10 of U.S. Pat. No. 4,923,787; stain inhibitors: formulas (I) to (III) on page 4, lines 30 to 33, particularly I-47, I-72, III-1, and III-27 (pages 24 to 48) in EP298321A; discoloration inhibitors: A-6, A-7, A-20, A-21, A-23, A-24, A-25, A-26, A-30, A-37, A-40, A-42, A-48, A-63, A-90, A-92, A-94, and A-164 (pages 69 to 118) in EP298321A, II-1 to III-23, particularly III-10 in columns 25 to 38 of U.S. Pat. No. 5,122,444, I-1 to III-4, particularly II-2 on pages 8 to 12 of EP471347A, and A-1 to A-48, particularly A-39 and A-42 in columns 32 to 40 of U.S. Pat. No. 5,139,931; materials which reduce the use amount of a color enhancer or a color amalgamation inhibitor: I-1 to II-15, particularly I-46 on pages 5 to 24 of EP411324A; formalin scavengers: SCV-1 to SCV-28, particularly SCV-8 on pages 24 to 29 of EP477932A; film hardeners: H-1, H-4, H-6, H-8, and H-14 on page 17 of JP-A-1-214845, compounds (H-1 to H-54) represented by formulas (VII) to (XII) in columns 13 to 23 of U.S. Pat. No. 4,618,573, compounds (H-1 to H-76), particularly H-14 represented by formula (6) on page 8, lower right column of JP-A-2-214852, and compounds described in claim 1 of U.S. Pat. No. 3,325,287; development inhibitor precursors: P-24, P-37, and P-39 (pages 6 and 7) in JP-A-62-168139; compounds described in claim 1, particularly 28 and 29 in column 7 of U.S. Pat. No. 5,019,492;

antiseptic agents and mildewproofing agents: I-1 to III-43, particularly II-1, II-9, II-10, II-18, and III-25 in columns 3 to 15 of U.S. Pat. No. 4,923,790; stabilizers and antifoggants: I-1 to (14), particularly I-1, I-60, (2), and (13) in columns 6 to 16 of U.S. Pat. No. 4,923,793, and compounds 1 to 65, particularly the compound 36 in columns 25 to 32 of U.S. Pat. No. 4,952,483; chemical sensitizers: triphenylphosphine selenide and a compound 50 in JP-A-5-40324; dyes: a-1 to b-20, particularly a-1, a-12, a-18, a-27, a-35, a-36, and b-5 on pages 15 to 18 and V-1 to V-23, particularly V-1 on pages 27 to 29 of JP-A-3-156450, F-I-1 to F-II-43, particularly F-1-11 and F-II-8 on pages 33 to 55 of EP445627A, III-1 to III-36, particularly III-1 and III-3 on pages 17 to 28 of EP457153A, fine-crystal dispersions of Dye-1 to Dye-124 on pages 8 to 26 of WO88/04794, compounds 1 to 22, particularly the compound 1 on pages 6 to 11 of EP319999A, compounds D-1 to D-87 (pages 3 to 28) represented by formulas (1) to (3) in EP519306A, compounds 1 to 22 (columns 3 to 10) represented by formula (I) in U.S. Pat. No. 4,268,622, and compounds (1) to (31) (columns 2 to 9) represented by formula (I) in U.S. Pat. No. 4,923,788; UV absorbents: compounds (18b) to (18r) and 101 to 427 (pages 6 to 9) represented by formula (1) in JP-A-46-3335, compounds (3) to (66) (pages 10 to 44) and compounds HBT-1 to HBT-10 (page 14) represented by formula (III) in EP520938A, and compounds (1) to (31) (columns 2 to 9) represented by formula (1) in EP521823A, the disclosures of which are incorporated herein by reference.

The present invention can be applied to various color photosensitive materials such as color negative films for general purposes or cinemas, color reversal films for slides and TV, color paper, color positive films and color reversal paper. Moreover, the present invention is suitable to lens equipped film units described in JP-B-2-32615 and Jpn. Utility Model Appln. KOKOKU Publication No. 3-39784.

Supports which can be suitably used in the present invention are described in, e.g., RD. No. 17643, page 28; RD. No. 18716, from the right column of page 647 to the left column of page 648; and RD. No. 307105, page 879.

The specified photographic speed referred to in the present invention is determined by the method described in JP-A-63-236035. The determining method is substantially in accordance with JIS K 7614-1981 except that the development processing is completed within 30 min to 6 hr after exposure for sensitometry and that the development processing is performed according to Fuji Color standard processing recipe CN-16.

In the photosensitive material of the present invention, the thickness of photosensitive silver halide layer closest to the support through surface of the photosensitive material is preferably 24 μm or less, more preferably 22 μm or less. Film swelling speed T_{1/2} is preferably 30 sec or less, more preferably 20 sec or less. The film swelling speed T_{1/2} is defined as the time that when the saturation film thickness refers to 90% of the maximum swollen film thickness attained by the processing in a color developer at 30° C. for 3 min 15 sec, is spent for the film thickness to reach ½ of the saturation film thickness. The film thickness means one measured under moisture conditioning at 25° C. in a relative humidity of 55% (two days). The film swelling speed T_{1/2} can be measured by using a swellometer described in A. Green et al., Photogr. Sci. Eng., Vol. 19, No. 2, pp. 124 to 129. The film swelling speed T_{1/2} can be regulated by adding a film hardener to gelatin as a binder, or by changing aging conditions after coating. The swelling ratio preferably ranges from 150 to 400%. The swelling ratio can be calculated from the maximum swollen film thickness measured under the above conditions in accordance with the formula:
[(maximum swollen film thickness−film thickness)/film thickness]×100 (%).

In the light-sensitive material of the present invention, hydrophilic colloid layers (referred to as “back layers”) having a total dry film thickness of 2 to 20 μm are preferably provided on the side opposite to the side having emulsion layers. These back layers preferably contain the aforementioned light absorbent, filter dye, ultraviolet absorbent, antistatic agent, film hardener, binder, plasticizer, lubricant, coating aid and surfactant. The swelling ratio of these back layers is preferably in the range of 150 to 500%.

The light-sensitive material according to the present invention can be developed by conventional methods described in the aforementioned RD. No. 17643, pages 28 and 29; RD. No. 18716, page 651, left to right columns; and RD No. 307105, pages 880 and 881.

The color negative film processing solution for use in the present invention will be described below.

The compounds listed in page 9, right upper column, line 1 to page 11, left lower column, line 4 of JP-A-4-121739 can be used in the color developing solution for use in the present invention. Preferred color developing agents for use in especially rapid processing are 2-methyl-4-[N-ethyl-N-(2-hydroxyethyl)amino]aniline, 2-methyl-4-[N-ethyl-N-(3-hydroxypropyl)amino]aniline and 2-methyl-4-[N-ethyl-N-(4-hydroxybutyl)amino]aniline.

These color developing agents are preferably used in an amount of 0.01 to 0.08 mol, more preferably 0.015 to 0.06 mol, and most preferably 0.02 to 0.05 mol per liter (hereinafter also referred to as “L”) of the color developing solution. The replenisher of the color developing solution preferably contains the color developing agent in an amount corresponding to 1.1 to 3 times the above concentration, more preferably 1.3 to 2.5 times the above concentration.

Hydroxylamine can widely be used as a preservative of the color developing solution. When enhanced preserving properties are required, it is preferred to use hydroxylamine derivatives having substituents such as alkyl, hydroxyalkyl, sulfoalkyl and carboxyalkyl groups. Preferred examples thereof include N,N-di(sulfoehtyl)hydroxylamine, monomethylhydroxylamine, dimethylhydroxylamine, monoethylhydroxylamine, diethylhydroxylamine and N,N-di(carboxyethyl)hydroxylamine. Of these, N,N-di(sulfoehtyl)hydroxylamine is most preferred. Although these may be used in combination with hydroxylamine, it is preferred that one or two or more members thereof be used in place of hydroxylamine.

These preservatives are preferably used in an amount of 0.02 to 0.2 mol, more preferably 0.03 to 0.15 mol, and most preferably 0.04 to 0.1 mol per L of the color developing solution. The replenisher of the color developing solution preferably contains the preservatives in an amount corresponding to 1.1 to 3 times the concentration of the mother liquor (processing tank solution) as in the color developing agent.

Sulfurous salts are used as tarring preventives for the color developing agent oxidation products in the color developing solution. Sulfurous salts are preferably used in the color developing solution in an amount of 0.01 to 0.05 mol, more preferably 0.02 to 0.04 mol per L. In the replenisher, sulfurous salts are preferably used in an amount corresponding to 1.1 to 3 times the above concentration.

The pH value of the color developing solution preferably ranges from 9.8 to 11.0, more preferably from 10.0 to 10.5. The pH of the replenisher is preferably set for a value 0.1 to 1.0 higher than the above value. Common buffers, such as carbonic acid salts, phosphoric acid salts, sulfosalicylic acid salts and boric acid salts, are used for stabilizing the above pH value.

Although the amount of the replenisher of the color developing solution preferably ranges from 80 to 1300 mL per m² of the lightsensitive material, the employment of smaller amount is desirable from the viewpoint of reduction of environmental pollution load. Specifically, the amount of the replenisher more preferably ranges from 80 to 600 mL, most preferably from 80 to 400 mL.

The bromide ion concentration in the color developer is usually 0.01 to 0.06 mol per L. However, this bromide ion concentration is preferably set at 0.015 to 0.03 mol per L in order to suppress fog and improve discrimination and graininess while maintaining sensitivity. To set the bromide ion concentration in this range, it is only necessary to add bromide ions calculated by the following equation to a replenisher. If C represented by formula below takes a negative value, however, no bromide ions are preferably added to a replenisher.
C=A−W/V
where C: the bromide ion concentration (mol/L) in a color developer replenisher
A: the target bromide ion concentration (mol/L) in a color developer
W: the amount (mol) of bromide ions dissolving into the color developer from 1 m² of a light-sensitive material when the sensitive material is color-developed
V: the replenishment rate (L) of the color developer replenisher for 1 m² of the light-sensitive material

As a method of increasing the sensitivity when the replenishment rate is decreased or high bromide ion concentration is set, it is preferable to use a development accelerator such as pyrazolidones represented by 1-phenyl-3-pyrazolidone and 1-phenyl-2-methyl-2-hydroxylmethyl-3-pyrazolidone, or a thioether compound represented by 3,6-dithia-1,8-octandiol.

Compounds and processing conditions described on page 4, left lower column, line 16 to page 7, left lower column, line 6 of JP-A-4-125558 can be applied to the processing solution having bleaching capability for use in the present invention.

Bleaching agents having redox potentials of at least 150 mV are preferably used. Specifically, suitable examples thereof are those described in JP-A-5-72694 and JP-A-5-173312, and especially suitable examples thereof are 1,3-diaminopropanetetraacetic acid, Example 1 compounds listed on page 7 of JP-A-5-173312 and ferric complex salts.

For improving the biodegradability of bleaching agent, it is preferred that ferric complex salts of compounds listed in JP-A-4-251845, JP-A-4-268552, EP 588289, EP 591934 and JP-A-6-208213 be used as the bleaching agent. The concentration of these bleaching agents preferably ranges from 0.05 to 0.3 mol per liter of solution having bleaching capability, and it is especially preferred that a design be made at 0.1 to 0.15 mol per liter for the purpose of reducing the discharge to the environment. When the solution having bleaching capability is a bleaching solution, a bromide is preferably incorporated therein in an amount of 0.2 to 1 mol, more preferably 0.3 to 0.8 mol per liter.

Each component is incorporated in the replenisher of the solution having bleaching capability fundamentally at a concentration calculated by the following formula. This enables keeping the concentration in the mother liquor constant.
C_{R}=C_{T}×(V₁+V₂)/V₁+C_{P}
C_{R}: concentration of each component in the replenisher,
C_{T}: concentration of the component in the mother liquor (processing tank solution),
C_{P}: component concentration consumed during processing,
V₁: amount of replenisher having bleaching capability supplied per m² of photosensitive material (mL), and
V₂: amount carried from previous bath by 1 m² of photosensitive material (mL).

In addition, a pH buffer is preferably incorporated in the bleaching solution, and it is especially preferred to incorporate a dicarboxylic acid of low order such as succinic acid, maleic acid, malonic acid, glutaric acid or adipic acid. It is also preferred to use common bleaching accelerators listed in JP-A-53-95630, RD No. 17129 and U.S. Pat. No. 3,893,858.

The bleaching solution is preferably replenished with 50 to 1000 mL, more preferably 80 to 500 mL, and most preferably 100 to 300 mL of a bleaching replenisher per m² of photosensitive material.

Further, the bleaching solution is preferably aerated.

Compounds and processing conditions described on page 7, left lower column, line 10 to page 8, right lower column, line 19 of JP-A-4-125558 can be applied to a processing solution having fixing capability.

For enhancing the fixing velocity and preservability, it is especially preferred to incorporate compounds represented by the general formulae (I) and (II) of JP-A-6-301169 either individually or in combination in the processing solution having fixing capability. Further, the use of not only p-toluenesulfinic salts but also sulfinic acids listed in JP-A-1-224762 is preferred from the viewpoint of enhancing the preservability.

Although the incorporation of an ammonium as a cation in the solution having bleaching capability or solution having fixing capability is preferred from the viewpoint of enhancing the desilvering, it is preferred that the amount of ammonium be reduced or brought to nil from the viewpoint of minimizing environmental pollution.

Conducting jet agitation described in JP-A-1-309059 is especially preferred in the bleach, bleach-fix and fixation steps.

The amount of replenisher supplied in the bleach-fix or fixation step is in the range of 100 to 1000 mL, preferably 150 to 700 mL, and more preferably 200 to 600 mL per m² of the photosensitive material.

Silver is preferably recovered by installing any of various silver recovering devices in an in-line or off-line mode in the bleach-fix or fixation step. In-line installation enables processing with the silver concentration of solution lowered, so that the amount of replenisher can be reduced. It is also suitable to conduct an off-line silver recovery and recycle residual solution for use as a replenisher.

The bleach-fix and fixation steps can each be accomplished by the use of multiple processing tanks. Preferably, the tanks are provided with cascade piping and a multistage counterflow system is adopted. A 2-tank cascade structure is generally effective from the viewpoint of a balance with the size of the developing machine. The ratio of processing time in the former-stage tank to that in the latter-stage tank is preferably in the range of 0.5:1 to 1:0.5, more preferably 0.8:1 to 1:0.8.

From the viewpoint of enhancing the preservability, it is preferred that a chelating agent which is free without forming any metal complex be present in the bleach-fix and fixing solutions. Biodegradable chelating agents described in connection with the bleaching solution are preferably used as such a chelating agent.

Descriptions made on page 12, right lower column, line 6 to page 13, right lower column, line 16 of JP-A-4-125558 mentioned above can preferably be applied to the washing and stabilization steps. In particular, with respect to the stabilizing solution, the use of azolylmethylamines described in EP 504609 and EP 519190 and N-methylolazoles described in JP-A-4-362943 in place of formaldehyde and the conversion of magenta coupler to two-equivalent form so as to obtain a surfactant solution not containing any image stabilizer such as formaldehyde are preferred from the viewpoint of protecting working environment.

Further, stabilizing solutions described in JP-A-6-289559 can preferably be used for reducing the adhesion of refuse to a magnetic recording layer applied to the photosensitive material.

The replenishing amount of washing and stabilizing solutions is preferably in the range of 80 to 1000 mL, more preferably 100 to 500 mL, and most preferably 150 to 300 mL, per m² of the photosensitive material from the viewpoint that washing and stabilizing functions are ensured and that the amount of waste solution is reduced to contribute to environment protection. In the processing conducted with the above replenishing amount, known mildewproofing agents such as thiabendazole, 1,2-benzoisothiazolin-3-one and 5-chloro-2-methylisothiazolin-3-one, antibiotics such as gentamicin, and water deionized by the use of, for example, an ion exchange resin are preferably used for preventing the breeding of bacteria and mildew. The joint use of deionized water, a mildewproofing agent and an antibiotic is more effective than single use thereof.

With respect to the solution placed in the washing or stabilizing solution tank, it is also preferred that the replenishing amount be reduced by conducting a reverse osmosis membrane treatment as described in JP-A's-3-46652, 3-53246, 3-55542, 3-121448 and 3-126030. A low-pressure reverse osmosis membrane is preferably used as the reverse osmosis membrane of the above treatment.

In the processing of the present invention, it is especially preferred that an evaporation correction of processing solution be carried out as disclosed in JIII (Japan Institute of Invention and Innovation) Journal of Technical Disclosure No. 94-4992. In particular, the method in which a correction is effected with the use of information on the temperature and humidity of developing machine installation environment in accordance with Formula 1 on page 2 thereof is preferred. Water for use in the evaporation correction is preferably procured from the washing replenishing tank. In that instance, deionized water is preferably used as the washing replenishing water.

Processing agents set forth on page 3, right column, line 15 to page 4, left column, line 32 of the above journal of technical disclosure are preferably used in the present invention. Film processor described on page 3, right column, lines 22 to 28 thereof is preferably used as the developing machine in the processing of the present invention.

Specific examples of processing agents, automatic developing machines and evaporation correction schemes preferably employed in carrying out of the present invention are described on page 5, right column, line 11 to page 7, right column, last line of the above journal of technical disclosure.

The processing agent for use in the present invention may be supplied in any form, for example, form of a liquid agent with the same concentration as in use or concentrated one, granules, powder, tablets, a paste or an emulsion. For example, a liquid agent stored in a container of low oxygen permeability is disclosed in JP-A-63-17453, vacuum packed powder or granules in JP-A's-4-19655 and 4-230748, granules containing a water soluble polymer in JP-A-4-221951, tablets in JP-A's-51-61837 and 6-102628 and a paste processing agent in PCT National Publication 57-500485. Although any of these can be suitably used, from the viewpoint of easiness in use, it is preferred to employ a liquid prepared in the same concentration as in use in advance.

Any one or a composite of polyethylene, polypropylene, polyvinyl chloride, polyethylene terephthalate, nylon, etc. is molded into the container for storing the above processing agents. These materials are selected in accordance with the required level of oxygen permeability. A material of low oxygen permeability is preferably used for storing an easily oxidized liquid such as a color developing solution, which is, for example, polyethylene terephthalate or a composite material of polyethylene and nylon. It is preferred that each of these materials be used in the container at a thickness of 500 to 1500 μm so that the oxygen permeability therethrough is 20 mL/m²•24 hrs•atm or less.

A magnetic recording layer preferably used in the present invention will be described below. This magnetic recording layer is formed by coating the surface of a support with an aqueous or organic solvent-based coating solution which is prepared by dispersing magnetic grains in a binder.

As the magnetic grains used in the present invention, it is possible to use, e.g., ferromagnetic iron oxide such as γFe₂O₃, Co-deposited γFe₂O₃, Co-deposited magnetite, Co-containing magnetite, ferromagnetic chromium dioxide, a ferromagnetic metal, a ferromagnetic alloy, Ba ferrite of a hexagonal system, Sr ferrite, Pb ferrite, and Ca ferrite. Co-deposited ferromagnetic iron oxide such as Co-deposited γFe₂O₃ is preferred. The grain can take the shape of any of, e.g., a needle, rice grain, sphere, cube, and plate. The specific area is preferably 20 m²/g or more, and more preferably, 30 m²/g or more as S_{BET}.

The saturation magnetization (as) of the ferromagnetic substance is preferably 3.0×10⁴ to 3.0×10⁵ A/m, and most preferably, 4.0×10⁴ to 2.5×10⁵ A/m. A surface treatment can be performed for the ferromagnetic grains by using silica and/or alumina or an organic material. Also, the surface of the ferromagnetic grain can be treated with a silane coupling agent or a titanium coupling agent as described in JP-A-6-161032, the disclosure of which is incorporated herein by reference. A ferromagnetic grain whose surface is coated with an inorganic or organic substance described in JP-A-4-259911 or JP-A-5-81652, the disclosures of which are incorporated herein by reference, can also be used.

As a binder used in the magnetic grains, it is possible to use a thermoplastic resin, thermosetting resin, radiation-curing resin, reactive resin, acidic, alkaline, or biodegradable polymer, natural polymer (e.g., a cellulose derivative and sugar derivative), and their mixtures. These examples are described in JP-A-4-219569, the disclosure of which is incorporated herein by reference. The Tg of the resin is preferably −40% to 300%, and its weight average molecular weight is preferably 2,000 to 1,000,000. Examples are a vinyl-based copolymer, cellulose derivatives such as cellulosediacetate, cellulosetriacetate, celluloseacetatepropionate, celluloseacetatebutylate, and cellulosetripropionate, acrylic resin, and polyvinylacetal resin. Gelatin is also preferred. Cellulosedi(tri)acetate is particularly preferred. This binder can be hardened by the addition of an epoxy-, aziridine-, or isocyanate-based crosslinking agent. Examples of the isocyanate-based crosslinking agent are isocyanates such as tolylenediisocyanate, 4,4′-diphenylmethanediisocyanate, hexamethylenediisocyanate, and xylylenediisocyanate, reaction products of these isocyanates and polyalcohol (e.g., a reaction product of 3 mols of tolylenediisocyanate and 1 mol of trimethylolpropane), and polyisocyanate produced by condensation of any of these isocyanates. These examples are described in JP-A-6-59357, the disclosure of which is incorporated herein by reference.

As a method of dispersing the magnetic substance in the binder, as described in JP-A-6-35092, the disclosure of which is incorporated herein by reference, a kneader, pin type mill, and annular mill are preferably used singly or together. Dispersants described in JP-A-5-088283, the disclosure of which is incorporated herein by reference, and other known dispersants can be used. The thickness of the magnetic recording layer is 0.1 to 10 μm, preferably 0.2 to 5 μm, and more preferably, 0.3 to 3 μm. The mass ratio of the magnetic grains to the binder is preferably 0.5:100 to 60:100, and more preferably, 1:100 to 30:100. The coating amount of the magnetic grains is 0.005 to 3 g/m², preferably 0.01 to 2 g/m², and more preferably, 0.02 to 0.5 g/m². The transmission yellow density of the magnetic recording layer is preferably 0.01 to 0.50, more preferably, 0.03 to 0.20, and most preferably, 0.04 to 0.15. The magnetic recording layer can be formed in the whole area of, or into the shape of stripes on, the back surface of a photographic support by coating or printing. As a method of coating the magnetic recording layer, it is possible to use any of an air doctor, blade, air knife, squeegee, impregnation, reverse roll, transfer roll, gravure, kiss, cast, spray, dip, bar, and extrusion. A coating solution described in JP-A-5-341436, the disclosure of which is incorporated herein by reference is preferred.

The magnetic recording layer can be given a lubricating property improving function, curling adjusting function, antistatic function, adhesion preventing function, and head polishing function. Alternatively, another functional layer can be formed and these functions can be given to that layer. A polishing agent in which at least one type of grains are aspherical inorganic grains having a Mohs hardness of 5 or more is preferred. The composition of this aspherical inorganic grain is preferably an oxide such as aluminum oxide, chromium oxide, silicon dioxide, titanium dioxide, and silicon carbide, a carbide such as silicon carbide and titanium carbide, or a fine powder of diamond. The surfaces of the grains constituting these polishing agents can be treated with a silane coupling agent or titanium coupling agent. These grains can be added to the magnetic recording layer or overcoated (as, e.g., a protective layer or lubricant layer) on the magnetic recording layer. A binder used together with the grains can be any of those described above and is preferably the same binder as in the magnetic recording layer. Light-sensitive materials having the magnetic recording layer are described in U.S. Pat. No. 5,336,589, U.S. Pat. No. 5,250,404, U.S. Pat. No. 5,229,259, U.S. Pat. No. 5,215,874, and EP 466,130, the disclosures of which are incorporated herein by reference.

A polyester support used in the present invention will be described below. Details of the polyester support and light-sensitive materials, processing, cartridges, and examples (to be described later) are described in Journal of Technical Disclosure No. 94-6023 (JIII; 1994, March 15), the disclosure of which is incorporated herein by reference. Polyester used in the present invention is formed by using diol and aromatic dicarboxylic acid as essential components. Examples of the aromatic dicarboxylic acid are 2,6-, 1,5-, 1,4-, and 2,7-naphthalenedicarboxylic acids, terephthalic acid, isophthalic acid, and phthalic acid. Examples of the diol are diethyleneglycol, triethyleneglycol, cyclohexanedimethanol, bisphenol A, and bisphenol. Examples of the polymer are homopolymers such as polyethyleneterephthalate, polyethylenenaphthalate, and polycyclohexanedimethanolterephthalate. Polyester containing 50 to 100 mol % of 2,6-naphthalenedicarboxylic acid is particularly preferred.

Polyethylene-2,6-naphthalate is most preferred among other polymers. The average molecular weight ranges between about 5,000 and 200,000. The Tg of the polyester of the present invention is 50° C. or higher, preferably 90 or higher.

To give the polyester support a resistance to curling, the polyester support is heat-treated at a temperature of preferably 40° C. to less than Tg, and more preferably, Tg-20° C. to less than Tg. The heat treatment can be performed at a fixed temperature within this range or can be performed together with cooling. The heat treatment time is preferably 0.1 to 1500 hr. and more preferably, 0.5 to 200 hr. The heat treatment can be performed for a roll-like support or while a support is conveyed in the form of a web. The surface shape can also be improved by roughening the surface (e.g., coating the surface with conductive inorganic fine grains such as SnO₂ or Sb₂O₅). It is desirable to knurl and slightly raise the end portion, thereby preventing the cut portion of the core from being photographed. These heat treatments can be performed in any stage after support film formation, after surface treatment, after back layer coating (e.g., an antistatic agent or lubricating agent), and after undercoating. A favorable timing is after the antistatic agent is coated.

An ultraviolet absorbent can be incorporated into this polyester. Also, to prevent light piping, dyes or pigments such as Diaresin manufactured by Mitsubishi Kasei Corp. or Kayaset manufactured by NIPPON KAYAKU CO. LTD. commercially available for polyester can be incorporated.

In the present invention, it is preferable to perform a surface treatment in order to adhere the support and the light-sensitive material constituting layers. Examples of the surface treatment are surface activation treatments such as a chemical treatment, mechanical treatment, corona discharge treatment, flame treatment, ultraviolet treatment, high-frequency treatment, glow discharge treatment, active plasma treatment, laser treatment, mixed acid treatment, and ozone oxidation treatment. Among other surface treatments, the ultraviolet radiation treatment, flame treatment, corona treatment, and glow treatment are preferred.

An undercoat layer can include a single layer or two or more layers. Examples of an undercoat layer binder are copolymers formed by using, as a starting material, a monomer selected from vinyl chloride, vinylidene chloride, butadiene, methacrylic acid, acrylic acid, itaconic acid, and maleic anhydride. Other examples are polyethyleneimine, an epoxy resin, grafted gelatin, nitrocellulose, and gelatin. Resorcin and p-chlorophenol are examples of a compound which swells a support. Examples of a gelatin hardener added to the undercoat layer are chromium salt (e.g., chromium alum), aldehydes (e.g., formaldehyde and glutaraldehyde), isocyanates, an active halogen compound (e.g., 2,4-dichloro-6-hydroxy-s-triazine), an epichlorohydrin resin, and an active vinylsulfone compound. SiO₂, TiO₂, inorganic fine grains, or polymethylmethacrylate copolymer fine grains (0.01 to 10 μm) can also be contained as a matting agent.

In the present invention, an antistatic agent is preferably used. Examples of this antistatic agent are carboxylic acid, carboxylate, a macromolecule containing sulfonate, cationic macromolecule, and ionic surfactant compound.

As the antistatic agent, it is most preferable to use fine grains of at least one crystalline metal oxide selected from ZnO, TiO₂, SnO₂, Al₂O₃, In₂O₃, SiO₂, MgO, BaO, MoO₃, and V₂O₅, and having a volume resistivity of preferably 10⁷Ω·cm or less, and more preferably, 10⁵Ω·cm or less and a grain size of 0.001 to 1.0 μm, fine grains of composite oxides (e.g., Sb, P, B, In, S, Si, and C) of these metal oxides, fine grains of sol metal oxides, or fine grains of composite oxides of these sol metal oxides.

The content in a light-sensitive material is preferably 5 to 500 mg/m², and particularly preferably, 10 to 350 mg/m². The ratio of a conductive crystalline oxide or its composite oxide to the binder is preferably 1/300 to 100/1, and more preferably, 1/100 to 100/5.

A light-sensitive material of the present invention preferably has a slip property. Slip agent-containing layers are preferably formed on the surfaces of both a light-sensitive layer and back layer. A preferable slip property is 0.01 to 0.25 as a coefficient of kinetic friction. This represents a value obtained when a stainless steel sphere 5 mm in diameter is conveyed at a speed of 60 cm/min (25° C., 60% RH). In this evaluation, a value of nearly the same level is obtained when the surface of a light-sensitive layer is used as a sample to be measured.

Examples of a slip agent usable in the present invention are polyorganocyloxane, higher fatty acid amide, higher fatty acid metal salt, and ester of higher fatty acid and higher alcohol. As the polyorganocyloxane, it is possible to use, e.g., polydimethylcyloxane, polydiethylcyloxane, polystyrylmethylcyloxane, or polymethylphenylcyloxane. A layer to which the slip agent is added is preferably the outermost emulsion layer or back layer. Polydimethylcyloxane or ester having a long-chain alkyl group is particularly preferred.

A light-sensitive material of the present invention preferably contains a matting agent. This matting agent can be added to either the emulsion surface or back surface and is most preferably added to the outermost emulsion layer. The matting agent can be either soluble or insoluble in processing solutions, and the use of both types of matting agents is preferred. Favorable examples are polymethylmethacrylate grains, poly(methylmethacrylate/methacrylic acid=9/1 or 5/5 (molar ratio)) grains, and polystyrene grains. The grain size is preferably 0.8 to 10 μm, and a narrow grain size distribution is favored. It is preferable that 90% or more of all grains have grain sizes 0.9 to 1.1 times the average grain size. To increase the matting property, it is preferable to simultaneously add fine grains with a grain size of 0.8 μm or smaller. Examples are polymethylmethacrylate grains (0.2 μm), poly(methylmethacrylate/methacrylic acid=9/1 (molar ratio, 0.3 μm) grains, polystyrene grains (0.25 μm), and colloidal silica grains (0.03 μm).

A film cartridge used in the present invention will be described below. The principal material of the cartridge used in the present invention can be a metal or synthetic plastic.

Preferable plastic materials are polystyrene, polyethylene, polypropylene, and polyphenylether. The cartridge of the present invention can also contain various antistatic agents. For this purpose, carbon black, metal oxide grains, nonion-, anion-, cation-, and betaine-based surfactants, or a polymer can be preferably used. These cartridges subjected to the antistatic treatment are described in JP-A-1-312537 and JP-A-1-312538, the disclosures of which are incorporated herein by reference. It is particularly preferable that the resistance be 10¹²Ω or less at 25° C. and 25% RH. Commonly, plastic cartridges are manufactured by using plastic into which carbon black or a pigment is incorporated in order to give a light-shielding property. The cartridge size can be a presently available 135 size. To miniaturize cameras, it is effective to decrease the diameter of a 25 mm cartridge of 135 size to 22 mm or less. The volume of a cartridge case is 30 cm³ or less, preferably 25 cm³ or less. The weight of plastic used in the cartridge and the cartridge case is preferably 5 to 15 g.

Furthermore, a cartridge which feeds a film by rotating a spool can be used in the present invention. It is also possible to use a structure in which a film leader is housed in a cartridge main body and fed through a port of the cartridge to the outside by rotating a spool shaft in the film feed direction. These structures are disclosed in U.S. Pat. No. 4,834,306 and U.S. Pat. No. 5,226,613, the disclosures of which are incorporated herein by reference. Photographic films used in the present invention can be so-called raw films before being developed or developed photographic films. Also, raw and developed photographic films can be accommodated in the same new cartridge or in different cartridges.

A color photographic light-sensitive material of the present invention is also suitably used as a negative film for Advanced Photo System (to be referred to as APS hereinafter). Examples are the NEXIA A, NEXIA F, and NEXIA H (ISO 200, 100, and 400, respectively) manufactured by Fuji Photo Film Co., Ltd. (to be referred to as Fuji Film hereinafter). These films are so processed as to have an APS format and set in an exclusive cartridge. These APS cartridge films are loaded into APS cameras such as the Fuji Film EPION Series (e.g., the EPION 300Z). A color photosensitive film of the present invention is also suited as a film with lens such as the Fuji Film FUJICOLOR UTSURUNDESU SUPER SLIM or the UTSURUNDESU ACE 800.

A photographed film is printed through the following steps in a mini-lab system.

(1) Reception (an exposed cartridge film is received from a customer)

(2) Detaching step (the film is transferred from the cartridge to an intermediate cartridge for development)

(3) Film development

(4) Reattaching step (the developed negative film is returned to the original cartridge)

(5) Printing (prints of three types C, H, and P and an index print are continuously automatically printed on color paper [preferably the Fuji Film SUPER FA8])

(6) Collation and shipment (the cartridge and the index print are collated by an ID number and shipped together with the prints)

As these systems, the Fuji Film MINI-LAB CHAMPION SUPER FA-298, FA-278, FA-258, FA-238 and the Fuji Film FRONTIER digital lab system are preferred.

Examples of a film processor for the MINI-LAB CHAMPION are the FP922AL, FP562B, FP562B,AL, FP362B, and FP362B,AL, and recommended processing chemicals are the FUJICOLOR JUST-IT CN-16L and CN-16Q .

Examples of a printer processor are the PP3008AR, PP3008A, PP1828AR, PP1828A, PP1258AR, PP1258A, PP728AR, and PP728A, and a recomended processing chemicals are the FUJICOLOR JUST-IT CP-47L and CP-40FAII. In the FRONTIER system, the SP-1000 scanner & image processor and the LP-1000P laser printer & paper processor or the LP-1000W laser printer are used. A detacher used in the detaching step and a reattacher used in the reattaching step are preferably the Fuji Film DT200 or DT100 and AT200 or AT100, respectively.

APS can also be enjoyed by PHOTO JOY SYSTEM whose main component is the Fuji Film Aladdin 1000 digital image workstation. For example, a developed APS cartridge film is directly loaded into the Aladdin 1000, or image information of a negative film, positive film, or print is input to the Aladdin 1000 by using the FE-550 35 mm film scanner or the PE-550 flat head scanner. Obtained digital image data can be easily processed and edited. This data can be printed out by the NC-550AL digital color printer using a photo-fixing heat-sensitive color printing system or the PICTOROGRAPHY 3000 using a laser exposure thermal development transfer system, or by existing laboratory equipment through a film recorder. The Aladdin 1000 can also output digital information directly to a floppy disk or Zip disk or to an CD-R via a CD writer.

In a home, a user can enjoy photographs on a TV set simply by loading a developed APS cartridge film into the Fuji Film PHOTO PLAYER AP-1. Image information can also be continuously input to a personal computer by loading a developed APS cartridge film into the Fuji Film PHOTO SCANNER AS-1. The Fuji Film PHOTO VISION FV-10 or FV-5 can be used to input a film, print, or three-dimensional object. Furthermore, image information recorded in a floppy disk, Zip disk, CR-R, or hard disk can be variously processed on a computer by using the Fuji Film PHOTO FACTORY application software. The Fuji Film NC-2 or NC-2D digital color printer using a photo-fixing heat-sensitive color printing system is suited to outputting high-quality prints from a personal computer.

To keep developed APS cartridge films, the FUJICOLOR POCKET ALBUM AP-5 POP L, AP-1 POP L, or AP-1 POP KG, or the CARTRIDGE FILE 16 is preferred.

Examples of the present invention will be described below. However, the present invention is not limited to these examples.

### EXAMPLE 1

Each of layers having compositions as the under-description was coated in piles on a cellulose triacetate film support on which under-coating was carried out, to prepare a multilayer color photosensitive material (sample 101).

Coating of Light-Sensitive Layer

Each of layers having compositions as the under-description was coated in piles to prepare a color negative film sample 101.

(Compositions of Light-Sensitive Layers)

The number corresponding to each component indicates the coating amount in units of g/m². The coating amount of a silver halide is indicated by the amount of silver.

(Sample 101)

1st Layer (1st Antihalation Layer)

| | | |
|---|---|---|
| Black colloidal silver | silver | 0.108 |
| Silver iodobromide emulsion grain | silver | 0.011 |
| (average grain diameter 0.07 μm, | | |
| silver iodide content 2 mol %) | | |
| Gelatin | | 0.900 |
| ExM-1 | | 0.040 |
| ExC-1 | | 0.002 |
| ExC-3 | | 0.002 |
| Cpd-2 | | 0.001 |
| F-8 | | 0.001 |
| HBS-1 | | 0.050 |
| HBS-2 | | 0.002 |

2nd Layer (2nd Antihalation Layer)

| | | |
|---|---|---|
| Black colloidal silver | silver | 0.058 |
| Gelatin | | 0.440 |
| ExY-1 | | 0.040 |
| ExF-1 | | 0.003 |
| F-8 | | 0.001 |
| Solid disperse dye ExF-7 | | 0.130 |
| HBS-1 | | 0.080 |

3rd Layer (Interlayer)

| | |
|---|---|
| ExC-2 | 0.045 |
| Cpd-1 | 0.092 |
| Polyethylaclyrate latex | 0.220 |
| HBS-1 | 0.120 |
| Gelatin | 0.740 |

4th Layer (Low-Speed Red-Sensitive Emulsion Layer)

| | | |
|---|---|---|
| Em-C | silver | 0.520 |
| Em-D | silver | 0.380 |
| Em-E | silver | 0.240 |
| ExC-1 | | 0.188 |
| ExC-2 | | 0.012 |
| ExC-3 | | 0.077 |
| ExC-4 | | 0.123 |
| ExC-5 | | 0.012 |
| ExC-6 | | 0.008 |
| ExC-8 | | 0.053 |
| ExC-9 | | 0.020 |
| ExY-3 | | 0.009 |
| Cpd-2 | | 0.025 |
| Cpd-4 | | 0.023 |
| Cpd-7 | | 0.015 |
| UV-2 | | 0.050 |
| UV-3 | | 0.080 |
| UV-4 | | 0.020 |
| HBS-1 | | 0.250 |
| HBS-5 | | 0.038 |
| Gelatin | | 2.100 |

5th Layer (Medium-Speed Red-Sensitive Emulsion Layer)

| | | |
|---|---|---|
| Em-B | silver | 0.332 |
| Em-C | silver | 0.332 |
| ExC-1 | | 0.140 |
| ExC-2 | | 0.080 |
| ExC-3 | | 0.028 |
| ExC-4 | | 0.110 |
| ExC-5 | | 0.018 |
| ExC-6 | | 0.012 |
| ExC-8 | | 0.019 |
| ExC-9 | | 0.004 |
| ExY-3 | | 0.007 |
| Cpd-2 | | 0.036 |
| Cpd-4 | | 0.028 |
| Cpd-7 | | 0.020 |
| HBS-1 | | 0.120 |
| Gelatin | | 1.290 |

6th Layer (High-Speed Red-Sensitive Emulsion Layer)

| | | |
|---|---|---|
| Em-A | silver | 1.000 |
| ExC-1 | | 0.240 |
| ExC-3 | | 0.030 |
| ExC-6 | | 0.022 |
| ExC-8 | | 0.110 |
| ExC-9 | | 0.024 |
| ExM-6 | | 0.060 |
| ExY-3 | | 0.014 |
| Cpd-2 | | 0.060 |
| Cpd-4 | | 0.079 |
| Cpd-7 | | 0.030 |
| HBS-1 | | 0.290 |
| HBS-2 | | 0.060 |
| Gelatin | | 1.920 |

7th Layer (Interlayer)

| | |
|---|---|
| Cpd-1 | 0.090 |
| Cpd-6 | 0.372 |
| Solid disperse dye ExF-4 | 0.032 |
| HBS-1 | 0.052 |
| Polyethylacrylate latex | 0.090 |
| Gelatin | 0.900 |

8th Layer (Layer for Donating Interlayer Effect to Red-Sensitive Layer)

| | | |
|---|---|---|
| Em-F | silver | 0.260 |
| Em-G | silver | 0.130 |
| Cpd-4 | | 0.030 |
| ExM-2 | | 0.140 |
| ExM-3 | | 0.016 |
| ExM-4 | | 0.010 |
| ExY-1 | | 0.017 |
| ExY-3 | | 0.005 |
| ExY-4 | | 0.041 |
| ExC-7 | | 0.010 |
| ExC-10 | | 0.007 |
| HBS-1 | | 0.222 |
| HBS-3 | | 0.003 |
| HBS-5 | | 0.030 |
| Gelatin | | 0.850 |

9th Layer (Low-Speed Green-Sensitive Emulsion Layer)

| | | |
|---|---|---|
| Em-J | silver | 0.463 |
| Em-K | silver | 0.310 |
| Em-L | silver | 0.150 |
| ExM-2 | | 0.245 |
| ExM-3 | | 0.050 |
| ExM-4 | | 0.120 |
| ExY-1 | | 0.010 |
| ExY-3 | | 0.006 |
| ExC-7 | | 0.004 |
| ExC-10 | | 0.002 |
| HBS-1 | | 0.330 |
| HBS-3 | | 0.008 |
| HBS-4 | | 0.200 |
| HBS-5 | | 0.050 |
| Cpd-5 | | 0.020 |
| Cpd-7 | | 0.020 |
| Gelatin | | 1.840 |

10th Layer (Medium-Speed Green-Sensitive Emulsion Layer)

| | | |
|---|---|---|
| Em-I | silver | 0.350 |
| Em-J | silver | 0.170 |
| ExM-2 | | 0.057 |
| ExM-3 | | 0.022 |
| ExM-4 | | 0.005 |
| ExM-5 | | 0.005 |
| ExY-3 | | 0.006 |
| ExC-6 | | 0.014 |
| ExC-7 | | 0.050 |
| ExC-8 | | 0.010 |
| ExC-10 | | 0.020 |
| HBS-1 | | 0.060 |
| HBS-3 | | 0.002 |
| HBS-4 | | 0.020 |
| HBS-5 | | 0.020 |
| Cpd-5 | | 0.020 |
| Cpd-7 | | 0.010 |
| Gelatin | | 0.650 |

11th Layer (High-Speed Green-Sensitive Emulsion Layer)

| | | |
|---|---|---|
| Em-H | silver | 1.000 |
| ExC-6 | | 0.003 |
| ExC-8 | | 0.014 |
| ExM-1 | | 0.017 |
| ExM-2 | | 0.025 |
| ExM-3 | | 0.020 |
| ExM-4 | | 0.005 |
| ExM-5 | | 0.005 |
| ExM-6 | | 0.060 |
| ExY-3 | | 0.008 |
| ExY-4 | | 0.005 |
| Cpd-3 | | 0.005 |
| Cpd-4 | | 0.007 |
| Cpd-5 | | 0.020 |
| Cpd-7 | | 0.020 |
| HBS-1 | | 0.149 |
| HBS-3 | | 0.003 |
| HBS-4 | | 0.020 |
| HBS-5 | | 0.037 |
| Polyethylacrylate latex | | 0.090 |
| Gelatin | | 1.200 |

12th Layer (Yellow Filter Layer)

| | |
|---|---|
| Cpd-1 | 0.090 |
| Solid disperse dye ExF-2 | 0.074 |
| Solid disperse dye ExF-5 | 0.008 |
| Oil-soluble dye ExF-6 | 0.008 |
| HBS-1 | 0.040 |
| Gelatin | 0.615 |

13th Layer (Low-Speed Blue-Sensitive Emulsion Layer)

| | | |
|---|---|---|
| Em-O | silver | 0.350 |
| Em-P | silver | 0.120 |
| Em-Q | silver | 0.008 |
| ExC-1 | | 0.022 |
| ExC-7 | | 0.006 |
| ExC-10 | | 0.003 |
| ExY-1 | | 0.003 |
| ExY-2 | | 0.350 |
| ExY-3 | | 0.007 |
| ExY-4 | | 0.050 |
| ExY-5 | | 0.410 |
| Cpd-2 | | 0.100 |
| Cpd-3 | | 0.004 |
| HBS-1 | | 0.220 |
| HBS-5 | | 0.070 |
| Gelatin | | 1.750 |

14th Layer (Medium-Speed Blue-Sensitive Emulsion Layer)

| | | |
|---|---|---|
| Em-N | silver | 0.500 |
| ExY-2 | | 0.041 |
| ExY-3 | | 0.006 |
| ExY-4 | | 0.040 |
| ExY-5 | | 0.050 |
| Cpd-2 | | 0.035 |
| Cpd-3 | | 0.001 |
| Cpd-7 | | 0.016 |
| HBS-1 | | 0.060 |
| Gelatin | | 0.350 |

15th Layer (High-Speed Blue-Sensitive Emulsion Layer)

| | | |
|---|---|---|
| Em-M | silver | 0.480 |
| ExY-2 | | 0.041 |
| ExY-3 | | 0.002 |
| ExY-4 | | 0.030 |
| ExY-5 | | 0.050 |
| Cpd-2 | | 0.035 |
| Cpd-3 | | 0.001 |
| Cpd-7 | | 0.016 |
| HBS-1 | | 0.060 |
| Gelatin | | 0.540 |

16th Layer (1st Protective Layer)

| | | |
|---|---|---|
| Silver iodobromide emulsion grain | silver | 0.323 |
| (average grain diameter 0.07 μm, | | |
| silver iodide content 2 mol%) | | |
| UV-1 | | 0.210 |
| UV-2 | | 0.127 |
| UV-3 | | 0.190 |
| UV-4 | | 0.020 |
| UV-5 | | 0.204 |
| ExF-8 | | 0.001 |
| ExF-9 | | 0.001 |
| ExF-10 | | 0.002 |
| ExF-11 | | 0.001 |
| F-11 | | 0.009 |
| S-1 | | 0.086 |
| HBS-1 | | 0.170 |
| HBS-4 | | 0.052 |
| Gelatin | | 2.150 |

17th Layer (2nd Protective Layer)

| | |
|---|---|
| H-1 | 0.400 |
| B-1 (diameter 1.7 μm) | 0.050 |
| B-2 (diameter 1.7 μm) | 0.150 |
| B-3 | 0.050 |
| S-1 | 0.200 |
| W-1 | 9.0 × 10⁻³ |
| Gelatin | 0.700 |

In addition to the above components, to improve the storage stability, processability, resistance to pressure, antiseptic and mildewproofing properties, antistatic properties, and coating properties, the individual layers contained W-1 to W-9, B-4 to B-6, F-1 to F-19, lead salt, platinum salt, iridium salt, and rhodium salt.

Preparation of Dispersions of Organic Solid Disperse Dyes

ExF-2 in the 12th layer was dispersed by the following method.

| | |
|---|---|
| Wet cake (containing 17.6 mass % | 1.210 kg |
| of water) of ExF-2 | |
| W-7 | 0.400 kg |
| F-15 | 0.006 kg |
| Water | 8.384 kg |
| Total | 10.000 kg |

(pH was adjusted to 7.2 by NaOH)

A slurry having the above composition was coarsely dispersed by stirring by using a dissolver. The resultant material was dispersed at a peripheral speed of 10 m/s, a discharge amount of 0.6 kg/min, and a packing ratio of 0.3-mm diameter zirconia beads of 80% by using an agitator mill, thereby obtaining a solid disperse dye ExF-2. The average grain size of the fine dye grains was 0.15 μm.

Following the same procedure as above, solid disperse dyes ExF-4 and ExF-7 were obtained. The average grain sizes of the fine dye grains were 0.28 and 0.49 μm, respectively. ExF-5 was dispersed by a microprecipitation dispersion method described in Example 1 of EP549,489A, the disclosure of which is incorporated herein by reference. The average grain size was found to be 0.06 μm.

The characteristics of emulsion used in examples of the present invention will be described in Tables 1 to 4.

TABLE 1
Characteristics of silver halide grains contained in Em-A to Em-Q

| Emulsion | | | ESD*¹ | ECD(μm)*²/ |
|---|---|---|---|---|
| name | Layer used | Grain shape | (μm) | VC(%)*³ |
| Em-A | High-speed red-sensitive layer | (111)main plane tabular grain | 1.30 | 3.50/32 |
| Em-B | Medium-speed red-sensitive layer | (111)main plane tabular grain | 0.95 | 2.20/32 |
| Em-C | Medium and low-speed red-sensitive | (111)main plane tabular grain | 0.69 | 1.30/35 |
| | layers | | | |
| Em-D | Low-speed red-sensitive layer | (111)main plane tabular grain | 0.48 | 0.89/17 |
| Em-E | Low-speed red-sensitive layer | (111)main plane tabular grain | 0.31 | 0.40/20 |
| Em-F | Layer for donating interlayer | (111)main plane tabular grain | 0.78 | 1.38/24 |
| | effect to red-sensitive layer | | | |
| Em-G | Layer for donating interlayer | (111)main plane tabular grain | 0.95 | 2.20/32 |
| | effect to red-sensitive layer | | | |
| Em-H | High-speed green-sensitive layer | (111)main plane tabular grain | 1.30 | 3.50/32 |
| Em-I | Medium-speed green-sensitive layer | (111)main plane tabular grain | 0.95 | 2.20/32 |
| Em-j | Medium and low-speed green- | (111)main plane tabular grain | 0.74 | 1.64/34 |
| | sensitive layers | | | |
| Em-K | Low-speed green-sensitive layer | (111)main plane tabular grain | 0.55 | 0.79/30 |
| Em-L | Low-speed green-sensitive layer | (111)main plane tabular grain | 0.44 | 0.53/30 |
| Em-M | High-speed blue-sensitive layer | (111)main plane tabular grain | 1.35 | 3.50/35 |
| Em-N | Medium-speed blue-sensitive layer | (111)main plane tabular grain | 1.30 | 2.20/24 |
| Em-O | Low-speed blue-sensitive layer | (111)main plane tabular grain | 0.81 | 1.10/30 |
| Em-P | Low-speed blue-sensitive layer | (111)main plane tabular grain | 0.40 | 0.55/32 |
| Em-Q | Low-speed blue-sensitive layer | (100)main plane cubic grain | 0.21 | 0.21/20 |

| | Av. | | | | | Number of |
|---|---|---|---|---|---|---|
| | thickness | | | | Annual ring | dislocation |
| Emulsion | (μm)/VC*4 | Av. | Ratio of tabular | Av. thickness of | structure of | lines per one |
| name | (%) | aspect ratio | grains*5 (%) | core portion (μm) | core portion | grain |
| Em-A | 0.12/14 | 30 | 91 | 0.09 | Absence | 10≦ |
| Em-B | 0.12/14 | 18 | 97 | 0.09 | Absence | 10≦ |
| Em-C | 0.10/15 | 13 | 90 | 0.07 | Absence | 10≦ |
| Em-D | 0.09/12 | 10 | 99 | — | — | 10≦ |
| Em-E | 0.09/9.3 | 4.5 | 98 | — | — | 10≦ |
| Em-F | 0.15/13 | 9.2 | 90 | 0.12 | Presence | 10≦ |
| Em-G | 0.12/14 | 18 | 97 | 0.09 | Absence | 10≦ |
| Em-H | 0.12/14 | 30 | 91 | 0.09 | Absence | 10≦ |
| Em-I | 0.12/14 | 18 | 97 | 0.09 | Absence | 10≦ |
| Em-J | 0.10/15 | 16 | 96 | 0.07 | Absence | 10≦ |
| Em-K | 0.14/13 | 5.5 | 97 | 0.11 | Presence | 10≦ |
| Em-L | 0.17/18 | 3.2 | 97 | 0.13 | Presence | 10≦ |
| Em-M | 0.13/21 | 27 | 90 | 0.09 | Presence | 10≦ |
| Em-N | 0.34/22 | 7 | 98 | 0.14 | Absence | 10≦ |
| Em-O | 0.23/18 | 4.7 | 97 | 0.13 | Presence | 10≦ |
| Em-P | 0.13/16 | 4.6 | 96 | 0.11 | Presence | 10≦ |
| Em-Q | 0.21/20 | 1 | — | — | — | — |

*¹ESD: average equivalent-sphere diameter
*²ECD: average equivalent-circular diameter
*³VC: variation coefficient
*4VC: variation coefficient
*5Ratio of tabular grains based on the total projected area occupied by all the grains (%)

TABLE 2
Composition structures of silver halide grains contained in Em-A to Em-Q

| | Characteristics of grains | Silver amount ratio of grain structure (%) and halogen |
|---|---|---|
| Emulsion | occupying 70% or more based | composition (listed in order from center of grain) |
| name | on the total projected area | < > indicates epitaxial junction portion |
| Em-A | (111)main plane tabular grain | (11%)AgBr/(35%)AgBr₉₇I₃/(18%)AgBr/(9%)AgBr₆₂I₃₈/(27%)AgBr |
| Em-B | (111)main plane tabular grain | (11%)AgBr/(35%)AgBr₉₇I₃/(18%)AgBr/(9%)AgBr₆₂I₃₈/(27%)AgBr |
| Em-C | (111)main plane tabular grain | (7%)AgBr/(31%)AgBr₉₇I₃/(16%)AgBr/(12%)AgBr₆₂I₃₈/(34%)AgBr |
| Em-D | (111)main plane tabular grain | (1%)AgBr/(77%)AgBr₉₉I₁/(9%)AgBr₉₅I₅/(13%)<AgBr₆₃Cl₃₅I₂> |
| Em-E | (111)main plane tabular grain | (57%)AgBr/(14%)AgBr₉₆I₄/(29%)<AgBr₅₇Cl₄₁I₂> |
| Em-F | (111)main plane tabular grain | (13%)AgBr/(36%)AgBr₉₇I₃/(7%)AgBr/(11%)AgBr₆₂I_{38/}(33%)AgBr |
| Em-G | (111)main plane tabular grain | (11%)AgBr/(35%)AgBr₉₇I₃/(18%)AgBr/(9%)AgI/(27%)AgBr |
| Em-H | (111)main plane tabular grain | (11%)AgBr/(35%)AgBr₉₇I₃/(18%)AgBr/(9%)AgI/(27%)AgBr |
| Em-I | (111)main plane tabular grain | (11%)AgBr/(35%)AgBr₉₇I₃/(18%)AgBr/(4%)AgI/(32%)AgBr |
| Em-J | (111)main plane tabular grain | (7%)AgBr/(31%)AgBr₉₇I₃/(15%)AgBr/(14%)AgBr₆₂I_{38/}(33%)AgBr |
| Em-K | (111)main plane tabular grain | (15%)AgBr/(44%)AgBr₉₇I₃/(11%)AgBr/(5%)AgI/(25%)AgBr |
| Em-L | (111)main plane tabular grain | (60%)AgBr/(2%)AgI/(38%)AgBr |
| Em-M | (111)main plane tabular grain | (1%)AgBr/(6%)AgBr₉₇I₃/(68%)AgBr₉₀I₁₀/(15%)AgBr/ |
| | | (10%)<AgBr₇₈Cl₂₀I₂> |
| Em-N | (111)main plane tabular grain | (8%)AgBr/(10%)AgBr₉₅I₅/(52%)AgBr₉₃I₇/(11%)AgBr/(2%)AgI/ |
| | | (17%)AgBr |
| Em-O | (111)main plane tabular grain | (12%)AgBr/(43%)AgBr₉₀I₁₀/(14%)AgBr/(2%)AgI/(29%)AgBr |
| Em-P | (111)main plane tabular grain | (58%)AgBr/(4%)AgI/(38%)AgBr |
| Em-Q | (100)main plane cubic grain | (6%)AgBr/(94%)AgBr₉₆I₄ |

TABLE 3
Characteristics of silver halide grains contained in Em-A to Em-Q

| | | | | | | (100) | |
|---|---|---|---|---|---|---|---|
| | Av. silver | Surface | Av. silver | Surface | Twin | face | Ratio*2 of |
| | iodide | silver | chloride | silver | plane | ratio in | grains |
| | content(mol %)/ | iodide | content (mol %)/ | chloride | spacing | side | satisfying |
| Emulsion | VC*1 of inter- | content | VC*1 of | content | (μm)/ | planes | requirement |
| name | grain(%) | (mol %) | inter-grain(%) | (mol %) | VC*1 (%) | (%) | A*3 (%) |
| Em-A | 4.5/10 | 3.90 | 0 | 0 | 0.011/30 | 20 | 55 |
| Em-B | 4.5/10 | 3.90 | 0 | 0 | 0.011/30 | 20 | 55 |
| Em-C | 5.5/11 | 5.00 | 0 | 0 | 0.010/30 | 30 | 75 |
| Em-D | 1.5/10 | 3.70 | 4.7/8.0 | 16 | 0.010/31 | 25 | — |
| Em-E | 1.1/11 | 5.00 | 12/9.0 | 23 | 0.009/29 | 25 | — |
| Em-F | 5.3/10 | 5.90 | 0 | 0 | 0.012/30 | 35 | 20 |
| Em-G | 4.5/10 | 3.90 | 0 | 0 | 0.011/30 | 20 | 55 |
| Em-H | 4.5/10 | 3.90 | 0 | 0 | 0.011/30 | 20 | 55 |
| Em-I | 5.1/10 | 3.90 | 0 | 0 | 0.012/30 | 20 | 60 |
| Em-J | 6.3/13 | 5.60 | 0 | 0 | 0.010/30 | 30 | 65 |
| Em-K | 6.3/12 | 7.39 | 0 | 0 | 0.016/32 | 20 | 15 |
| Em-L | 2.0/14 | 5.68 | 0 | 0 | 0.016/32 | 35 | 18 |
| Em-M | 7.1/10 | 3.80 | 5.4/8.0 | 10 | 0.012/30 | 30 | 85 |
| Em-N | 6.1/8.0 | 5.50 | 0 | 0 | 0.017/33 | 20 | 20 |
| Em-O | 6.3/9.0 | 1.90 | 0 | 0 | 0.019/30 | 30 | 15 |
| Em-P | 4.0/10 | 5.50 | 0 | 0 | 0.020/31 | 30 | 20 |
| Em-Q | 3.8/9.0 | 4.50 | 0 | 0 | — | — | — |

*1VC: variation coefficient
*2Ratio of grains satisfying requirement A to all grains in number(%)
*3It is a silver iodobromide grain or a silver iodochlorobromide grain having a (111) main plane in which an equivalent-circular diameter is 1.0 μm or more and the grain thickness is 0.15 μm or less, the grain having 10 or more dislocation lines. Further, the grain has a core portion having a thickness of 0.1 μm or less in which the core portion comprises silver iodobromide and does not contain an annual ring structure.

TABLE 4
Sensitizing dye and dopant used in Em-A to Em-O

| Emulsion | | Sensitizing | |
|---|---|---|---|
| name | Layer used | dye | Dopant |
| Em-A | High-speed red-sensitive layer | 2, 3, 14 | K₂IrCl₆, K₄Ru(CN)₆ |
| Em-B | Medium-speed red-sensitive layer | 2, 3, 14 | K₂IrCl₆, K₄Ru(CN)₆ |
| Em-C | Medium and low-speed red-sensitive | 1, 2, 3 | K₂IrCl₆, K₂IrCl₅(H₂O), K₄Ru(CN)₆ |
| | layers | | |
| Em-D | Low-speed red-sensitive layer | 2, 3, 14 | K₂IrCl₆, K₄Fe(CN)₆ |
| Em-E | Low-speed red-sensitive layer | 2, 3, 14 | K₂IrCl₆, K₄Fe(CN)₆ |
| Em-F | Layer for donating interlayer | 7, 8 | K₄Fe(CN)₆ |
| | effect to red-sensitive layer | | |
| Em-G | Layer for donating interlayer | 7, 8 | K₄Fe(CN)₆ |
| | effect to red-sensitive layer | | |
| Em-H | High-speed green-sensitive layer | 5, 6, 8 | K₄Ru(CN)₆ |
| Em-I | Medium-speed green-sensitive layer | 4, 5, 6, 8 | K₂IrCl₆, K₄Ru(CN)₆ |
| Em-J | Medium and low-speed green- | 4, 5, 6, 8 | K₂IrCl₆, K₄Fe(CN)₆ |
| | sensitive layers | | |
| Em-K | Low-speed green-sensitive layer | 4, 5, 6, 8, 13 | K₂IrCl₆ |
| Em-L | Low-speed green-sensitive layer | 6, 8, 13 | K₂IrCl₆, K₄Fe(CN)₆ |
| Em-M | High-speed blue-sensitive layer | 16 | — |
| Em-N | Medium-speed blue-sensitive layer | 16 | — |
| Em-O | Low-speed blue-sensitive layer | 9 | — |
| Em-P | Low-speed blue-sensitive layer | 9, 15 | — |
| Em-Q | Low-speed blue-sensitive layer | 12, 15 | K₂IrCl₆ |

Emulsions Em-A and H were prepared referring to the preparation process of emulsion 1-H described in Example of JP-A-2002-268162.

Emulsions Em-B to C, G, I to J and N were prepared referring to the preparation process of emulsion 1-F described in Example of JP-A-2002-268162.

Emulsions Em-F, K to L and O to P were prepared referring to the preparation process of emulsion 1-D described in Example of JP-A-2002-268162.

Emulsions Em-D to E were prepared referring to the preparation process of emulsion described in Example of JP-A-2002-278007.

Emulsion Em-M was prepared referring to the preparation process described in Examples Em-4 and Em-5 of JP-A-2004-37936.

Emulsion Em-Q was prepared referring to the preparation process described in Example Em-N of JP-A-2002-72429.

Emulsions Em-M to Q were sensitized by reduction at preparation of particles.

Compound 11 described in Example of U.S. Pat. No. 6,686,140 was added in emulsions Em-A, H and M to N.

The optimum amount of spectral sensitization dyes described in Table 4 was added to the emulsions and gold sensitization, sulfur sensitization and selenium sensitization were optimally carried out.

The sensitizing dyes used in examples of the present invention will be described below.

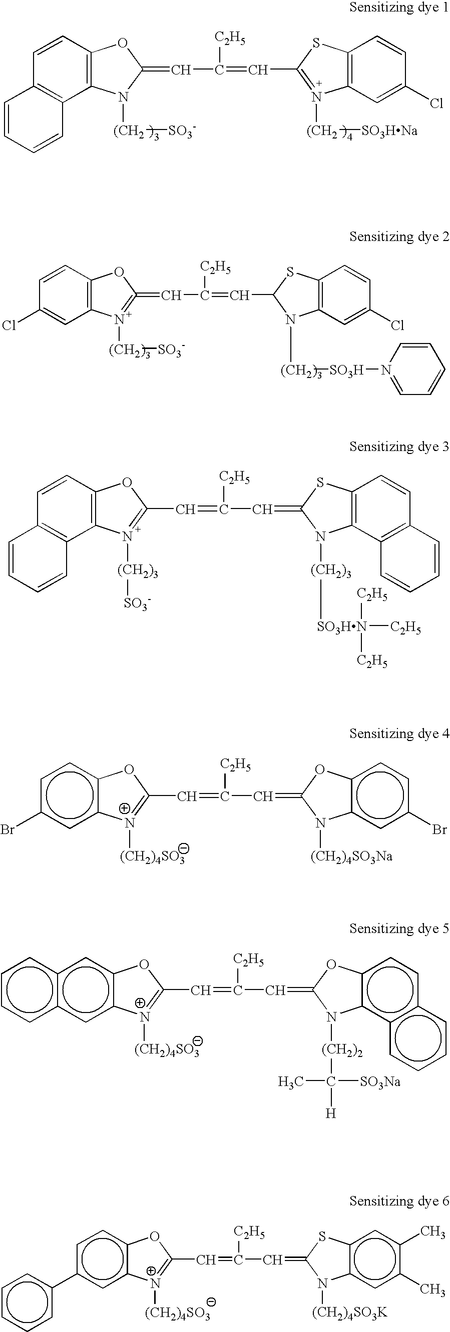

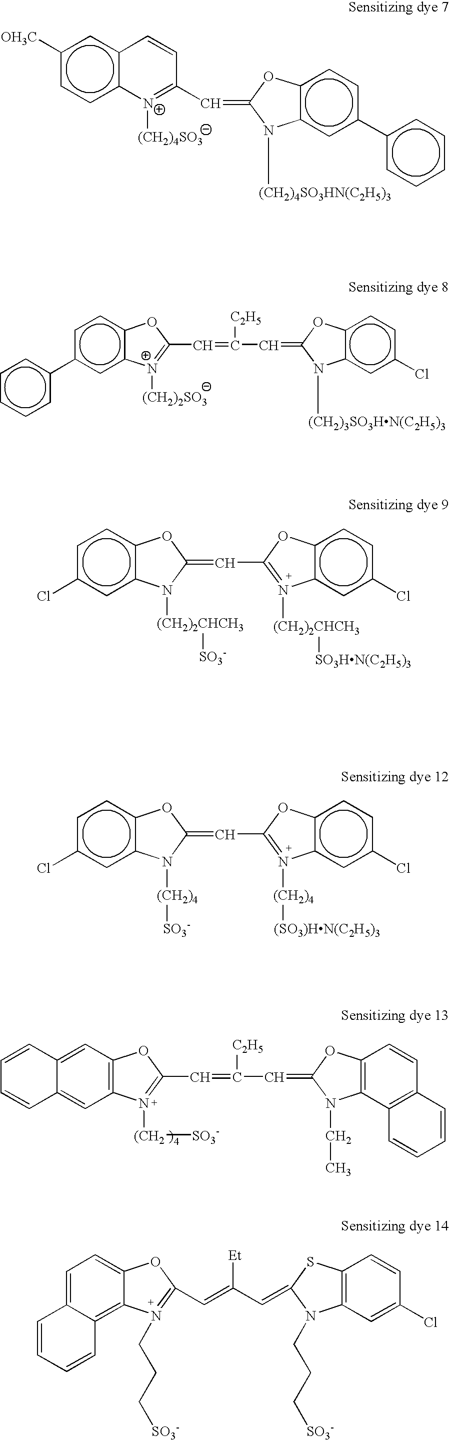

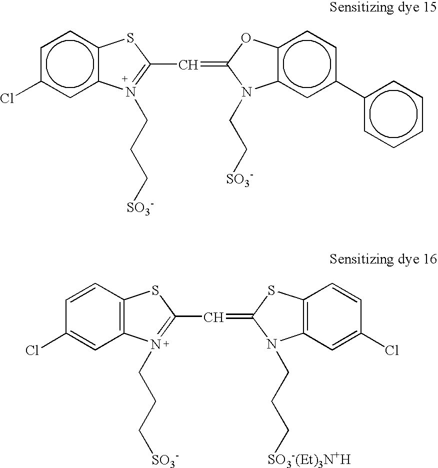

Other compounds used in examples of the present invention will be described below.

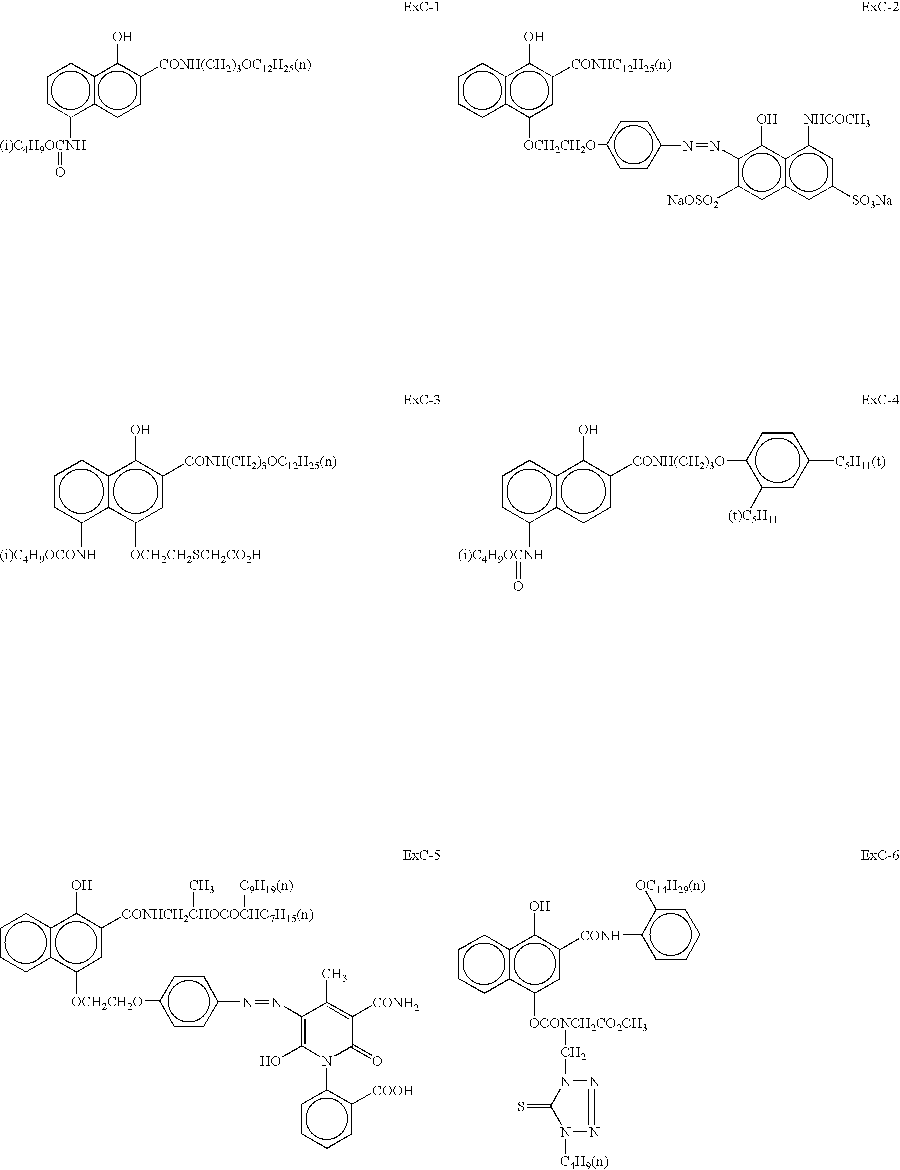

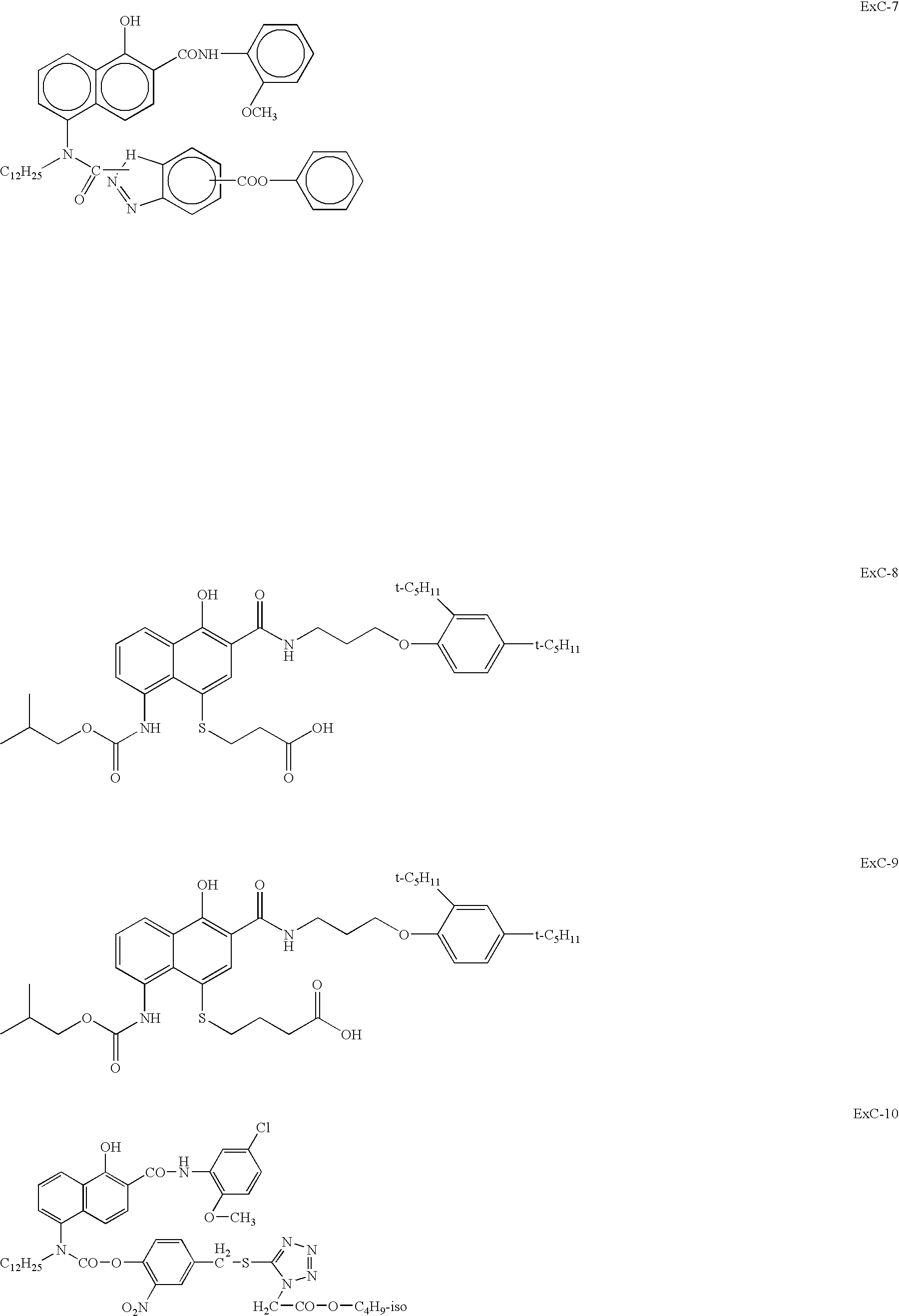

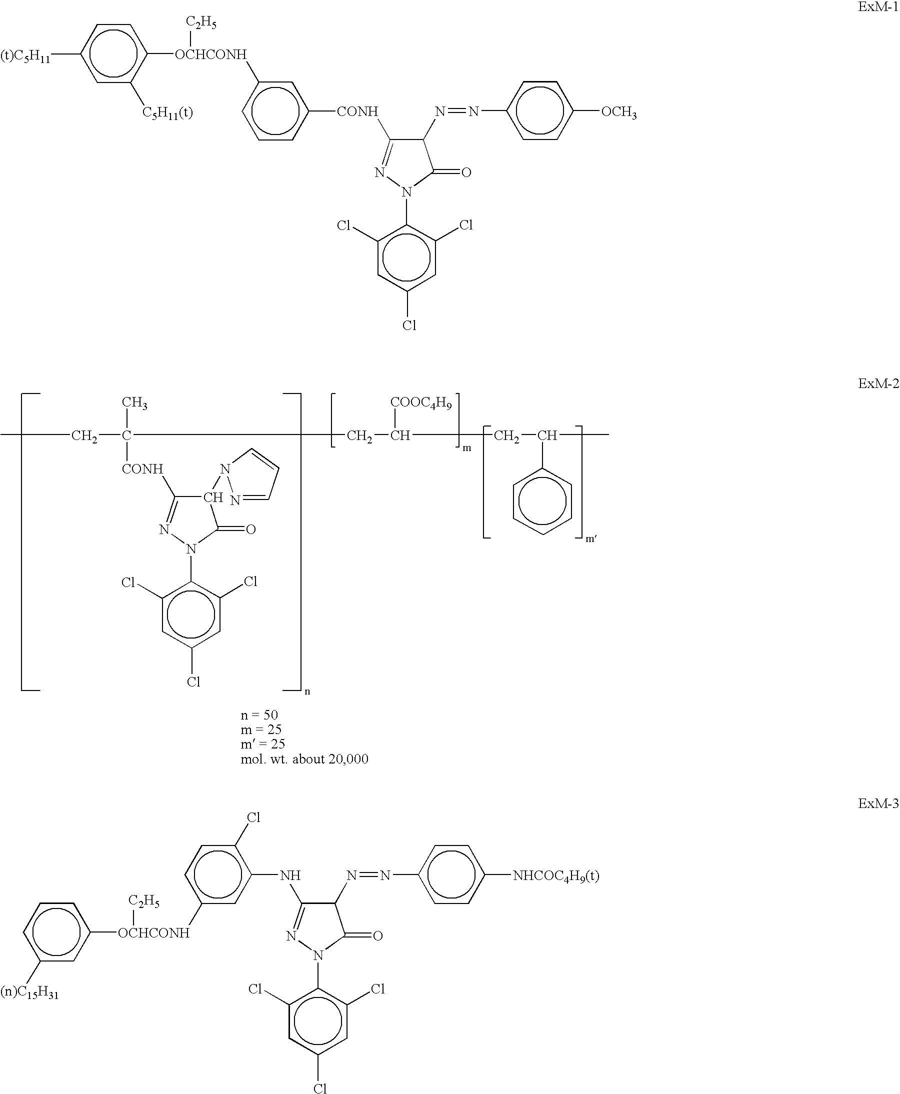

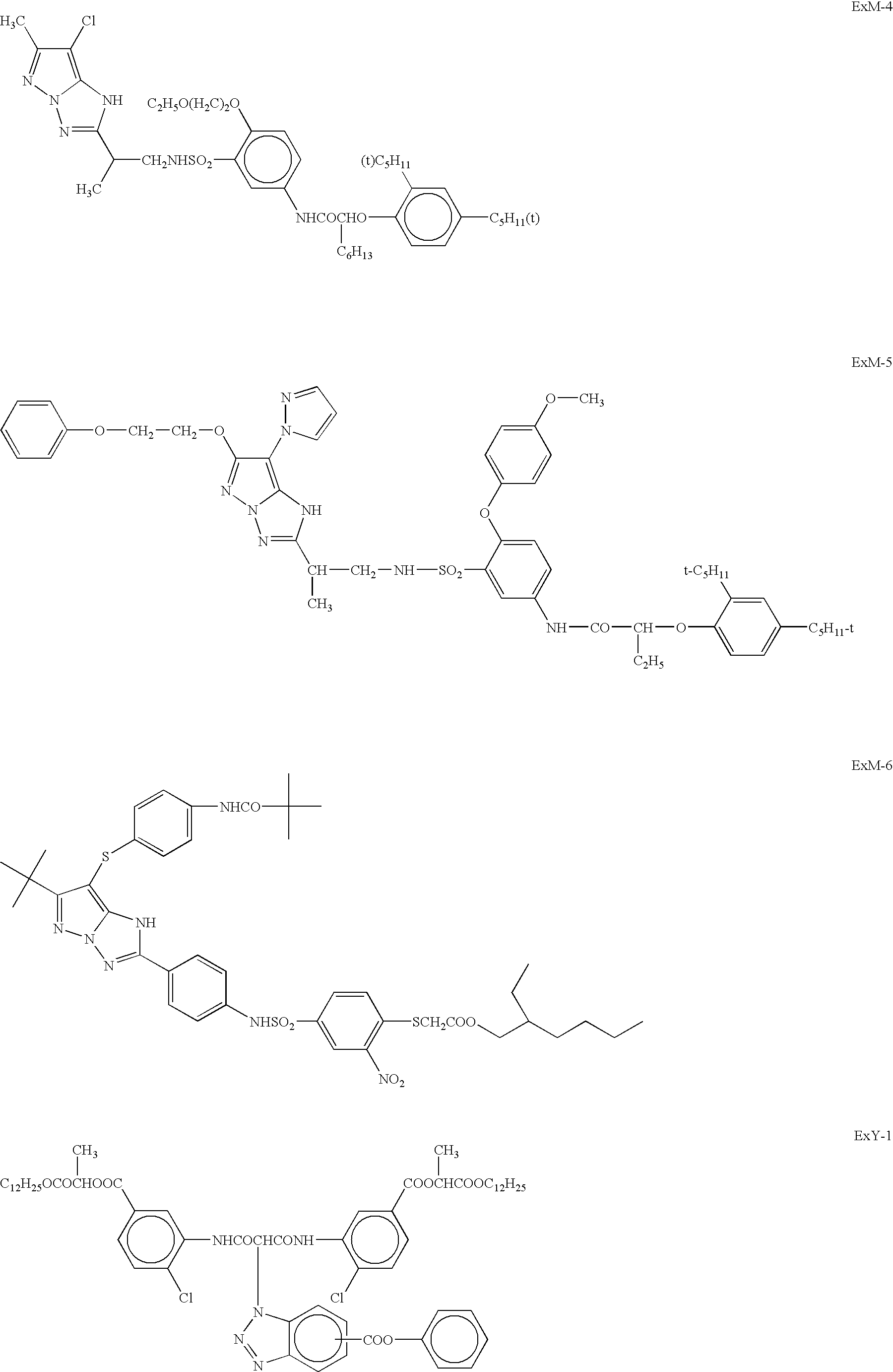

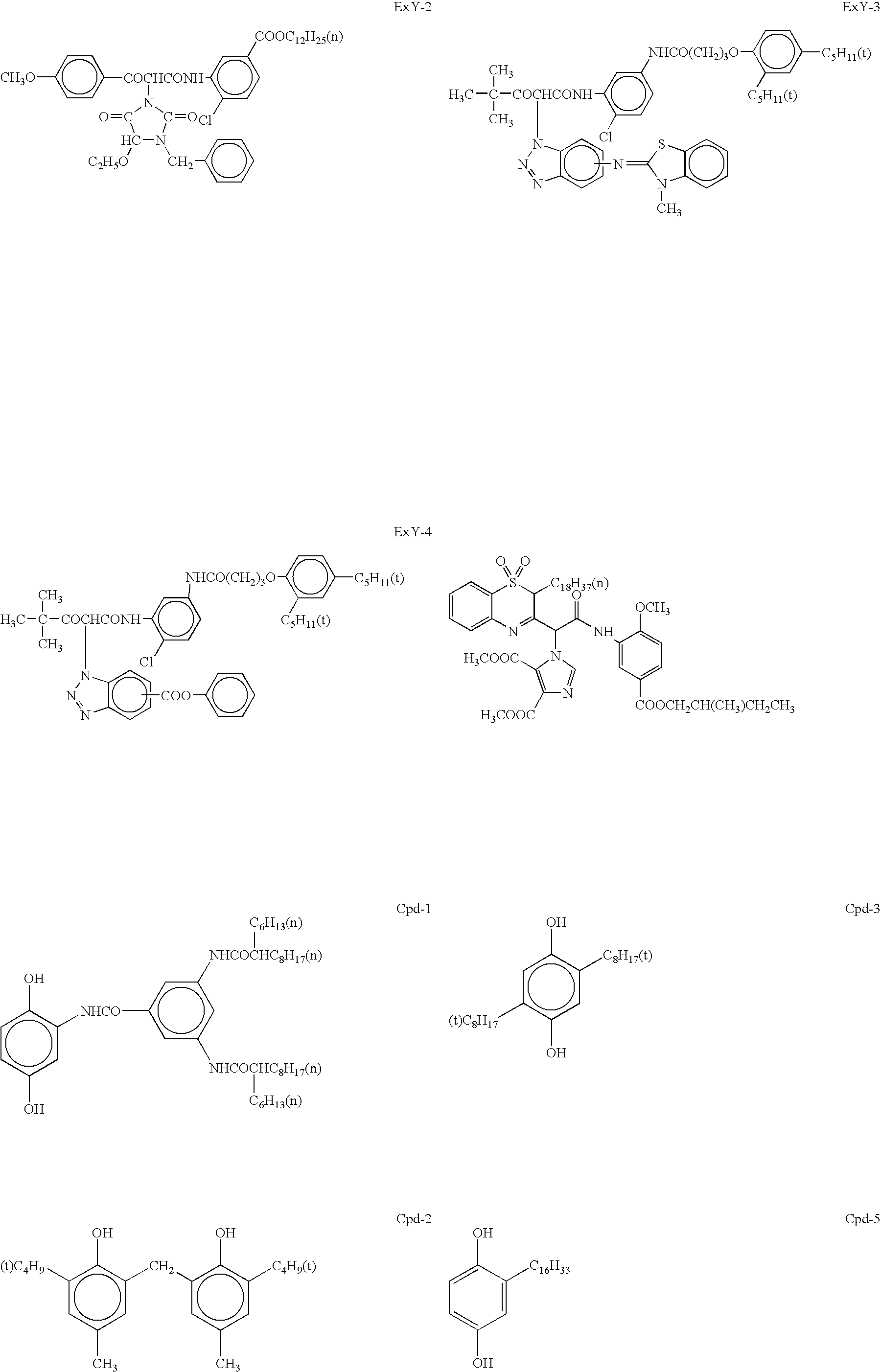

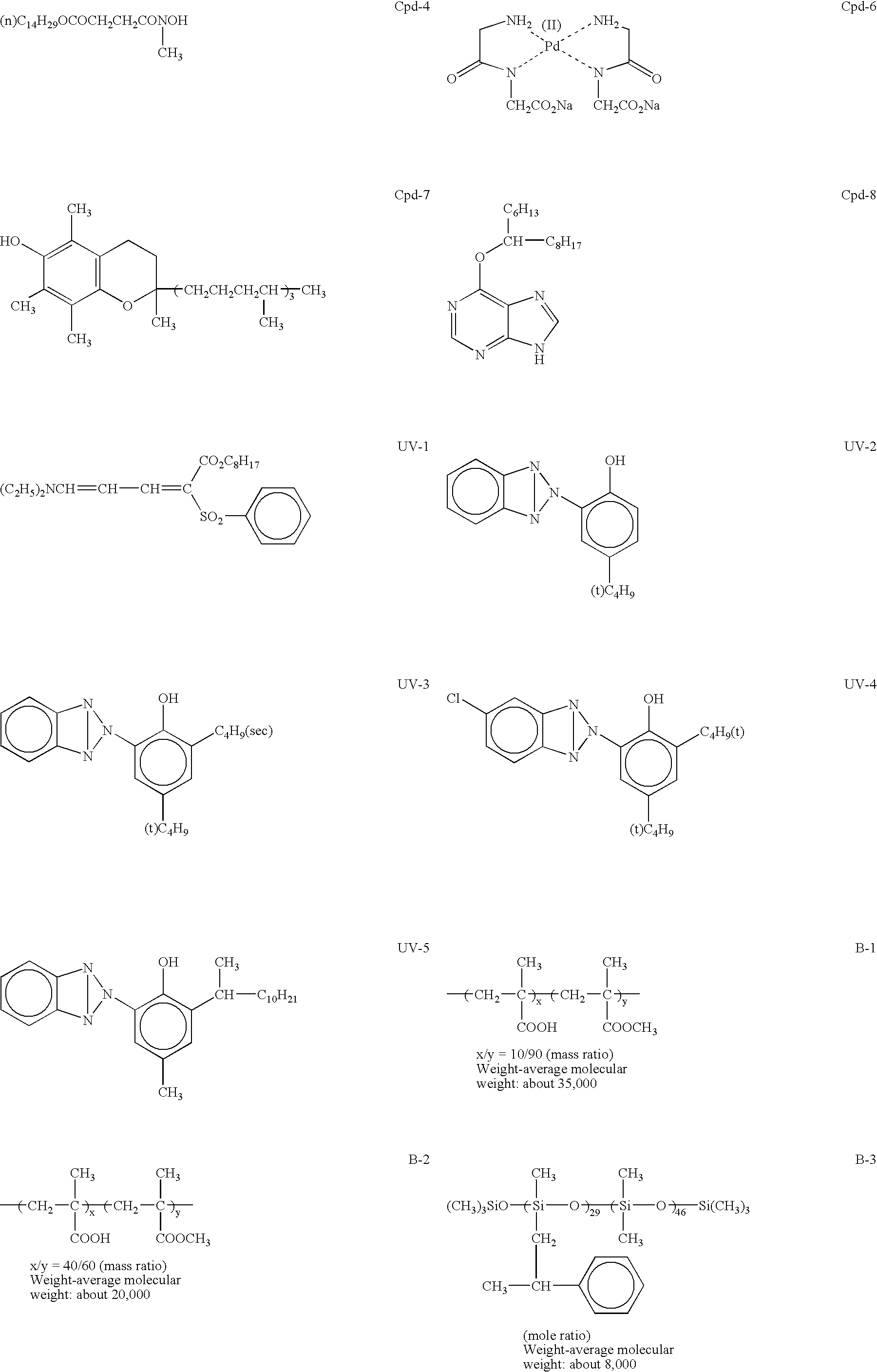

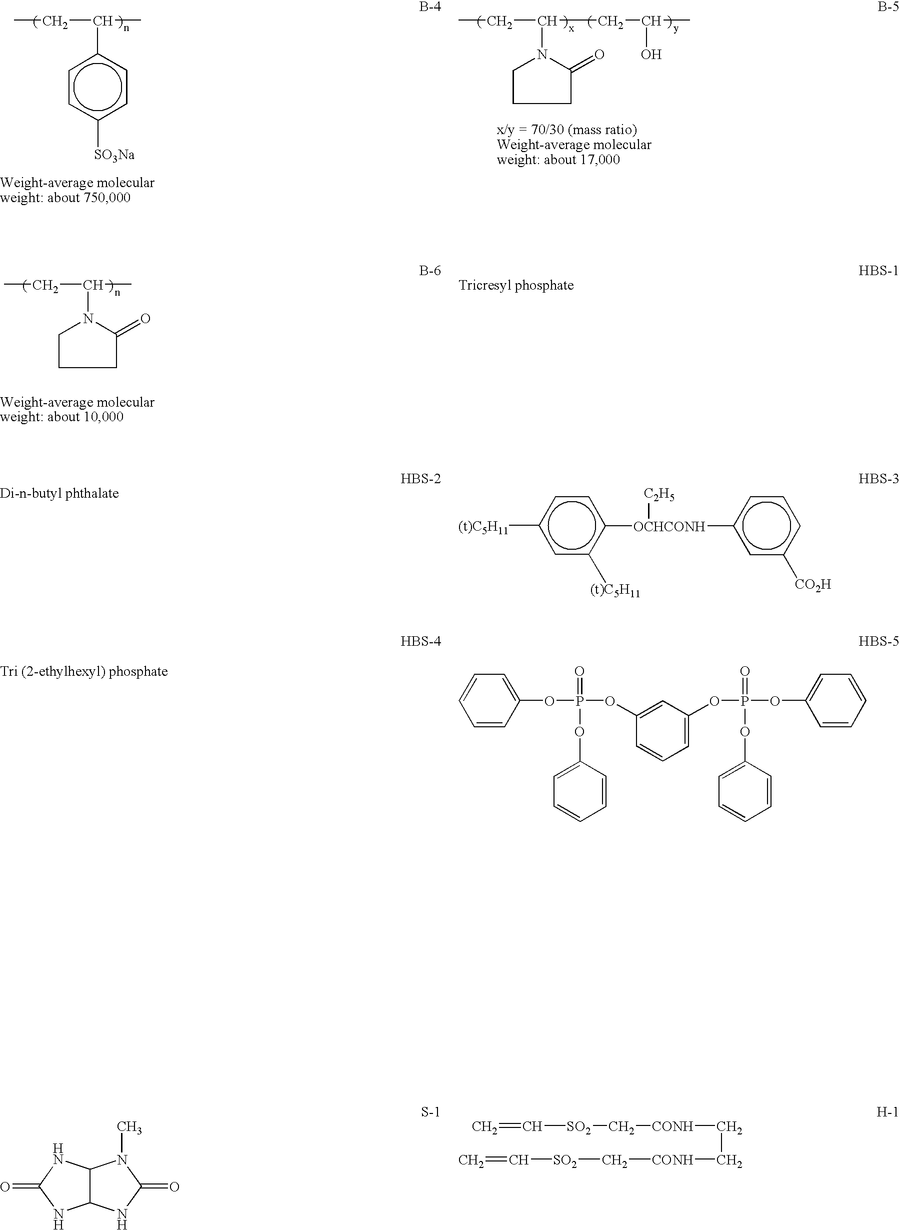

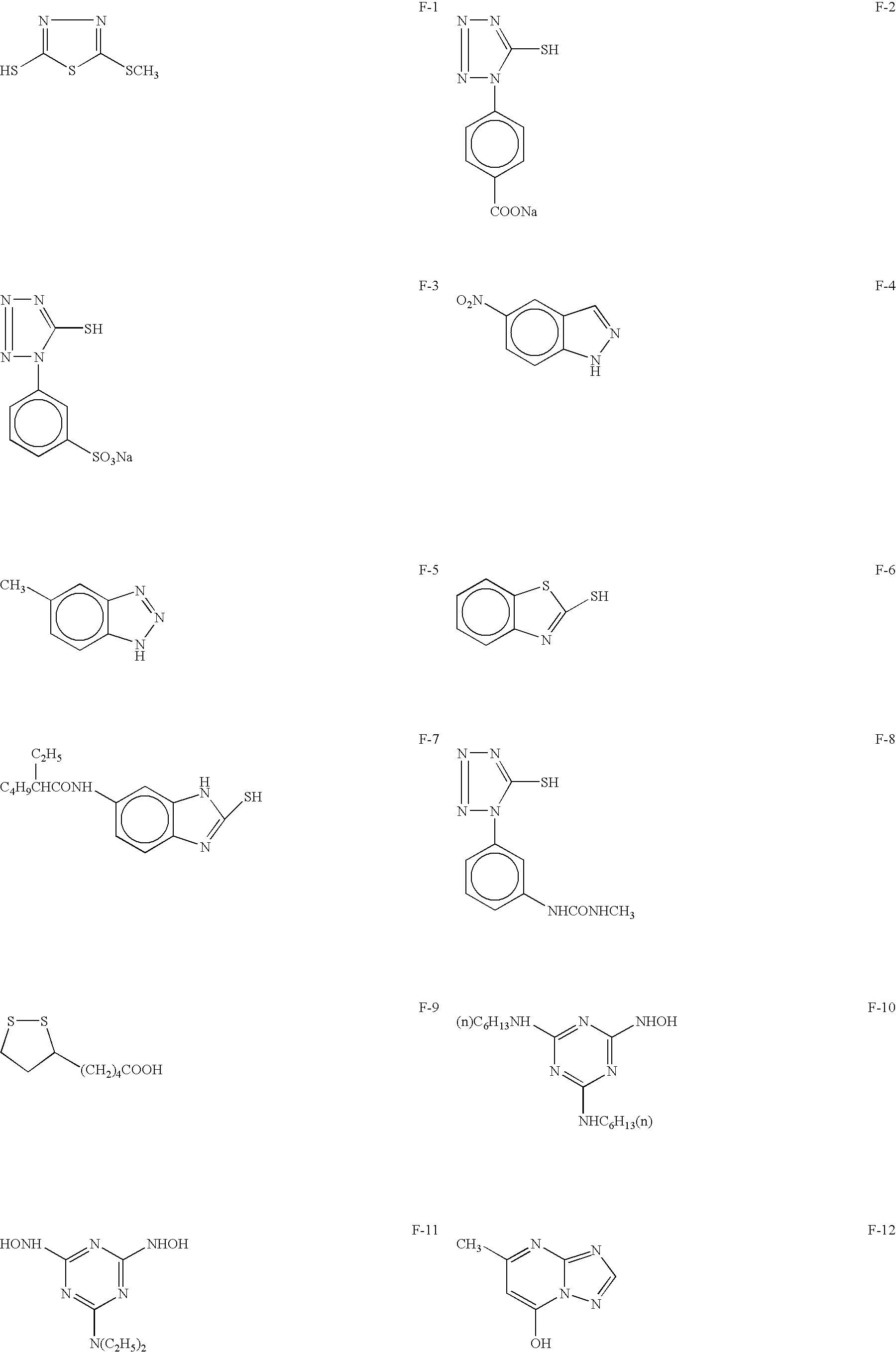

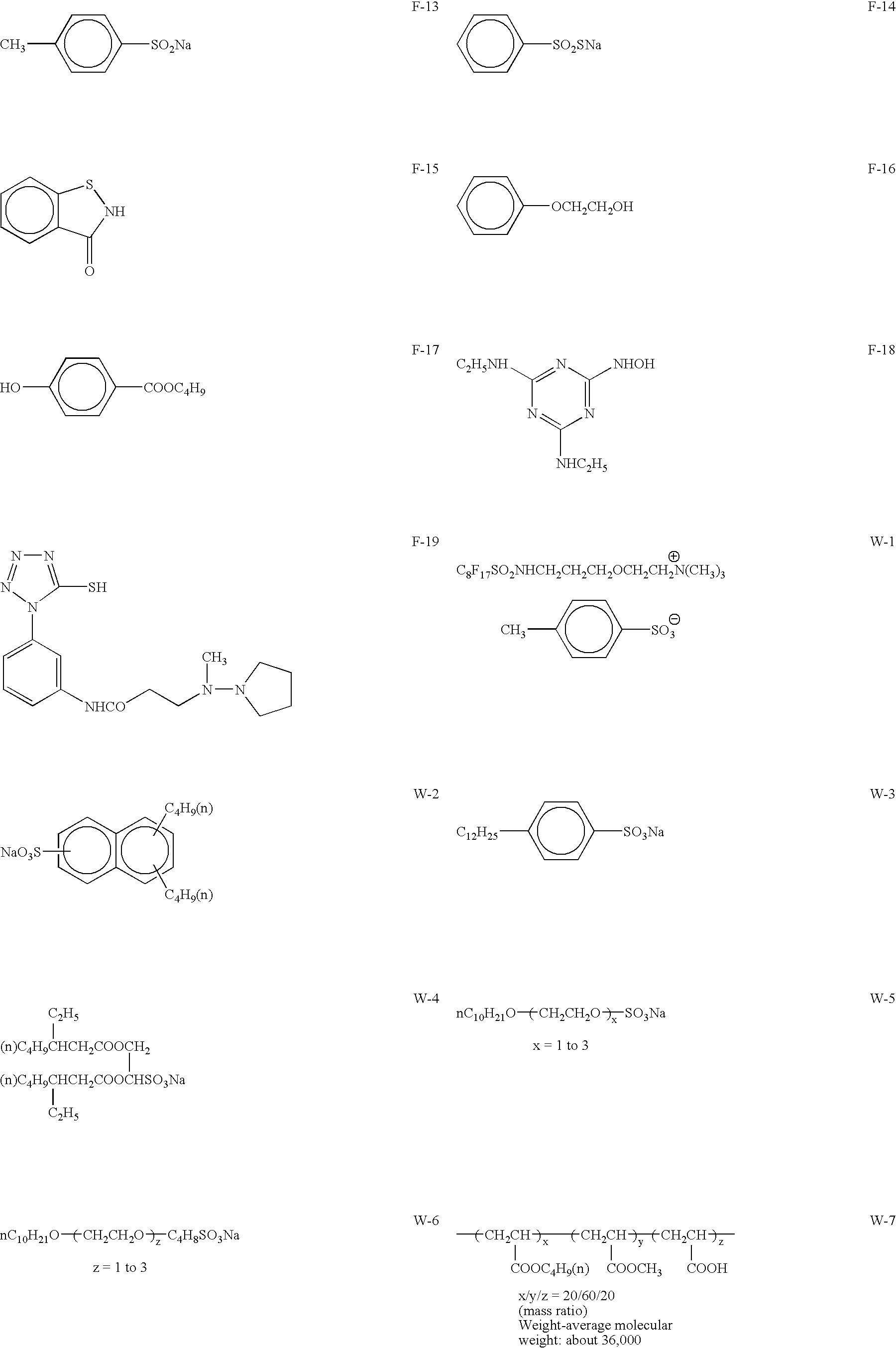

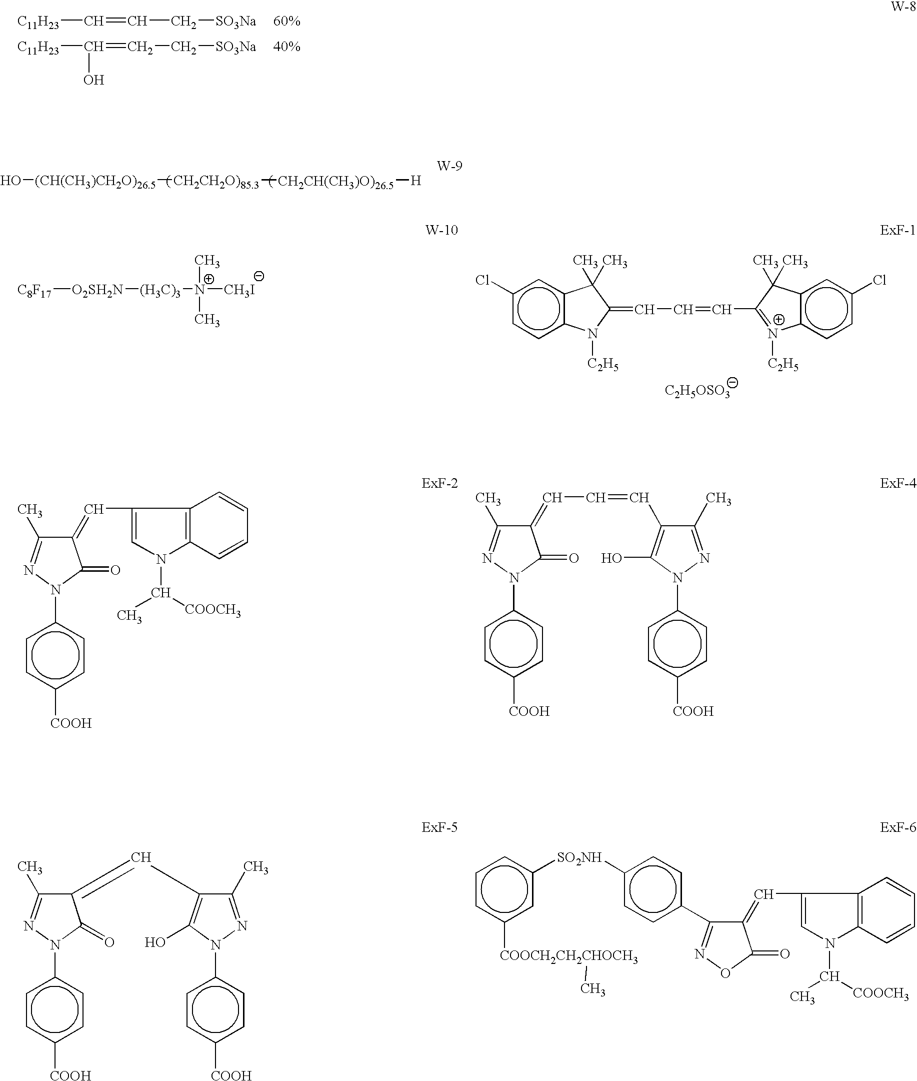

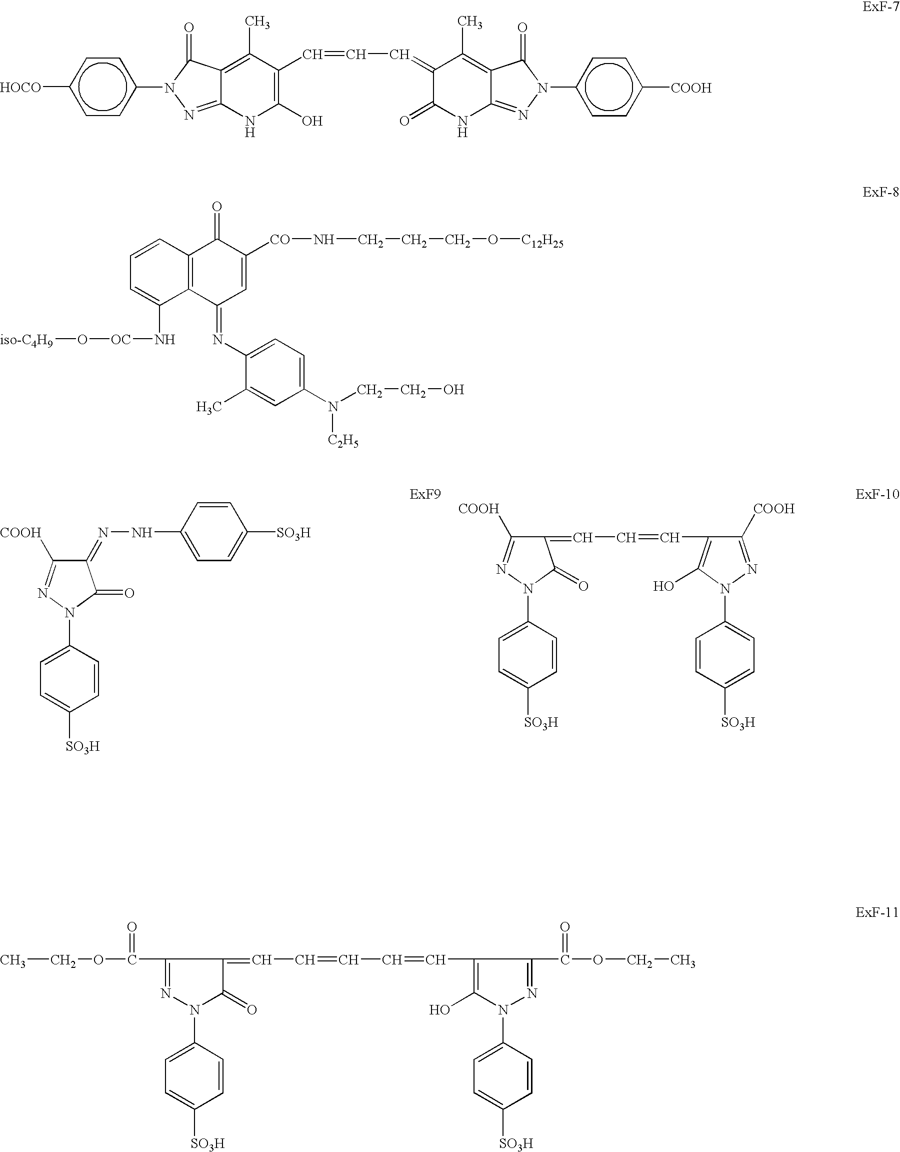

The above-mentioned silver halide color photosensitive material is referred to as the sample 101.

As sensitometry, ISO sensitivity which is the international standard is generally used at determining specific sensitivity in the industry but it is prescribed in the ISO sensitivity that the development of a photosensitive material is carried out at the 5th day after exposure and development processing is according to the assignment of respective companies.

In the present invention, time until development processing after exposure is shortened and the fixed development processing was designed to be carried out.

The determining method is substantially in accordance with JIS K 7614-1981 except that the development processing is completed within 30 min to 6 hr after exposure for sensitometry and that the development processing is performed according to Fuji Color standard processing recipe CN-16.

Samples 101 to 108 were exposed through, manufactured by Fuji Photo Film Co., Ltd., gelatin filter SC-39 and continuous wedge for 1/100 sec.

The samples after the exposure were processed in the following manner.

(Processing Procedure)

| Step | Processing time | | Processing temp. |
|---|---|---|---|
| Color development: | 3 min 15 | sec | 38° C. |
| Bleaching: | 3 min 00 | sec | 38° C. |
| Washing: | 30 | sec | 24° C. |
| Fixing: | 3 min 00 | sec | 38° C. |
| Washing (1): | 30 | sec | 24° C. |
| Washing (2): | 30 | sec | 24° C. |
| Stabilization: | 30 | sec | 38° C. |
| Drying: | 4 min 20 | sec | 55° C. |

The composition of the processing solution for use in each of the above steps is as follows:

| | (Unit: g) | |
|---|---|---|
| (Color developer) | | |
| Diethylenetriaminepentaacetic acid | 1.0 | |
| 1-Hydroxyethylidene-1,1-diphosphonic acid | 2.0 | |
| Sodium sulfite | 4.0 | |
| Potassium carbonate | 30.0 | |
| Potassium bromide | 1.4 | |
| Potassium iodide | 1.5 | mg |
| Hydroxylamine sulfate | 2.4 | |
| 4-(N-ethyl-N-β-hydroxyethylamino)-2-methylaniline | 4.5 | |
| sulfate | | |
| Water | q.s. ad 1.0 | L |
| pH | 10.05. | |
| (adjusted with potassium hydroxide and sulfuric acid) | | |
| (Bleaching solution) | | |
| Ethylenediaminetetraacetic acid ferric ammonium | 100.0 | |
| trihydrate salt | | |
| Ethylenediaminetetraacetic acid disodium salt | 10.0 | |
| 3-Mercapto-1,2,4-triazole | 0.03 | |
| Ammonium bromide | 140.0 | |
| Ammonium nitrate | 30.0 | |
| Aq. ammonia (27%) | 6.5 | mL |
| Water | q.s. ad 1.0 | L |
| pH (adjusted with aq. ammonia and nitric acid) | 6.0. | |
| (Fixer) | | |
| Ethylenediaminetetraacetic acid disodium salt | 0.5 | |
| Ammonium sulfite | 20.0 | |
| Aq. soln. of ammonium thiosulfate (700 g/L) | 295.0 | mL |
| Acetic acid (90%) | 3.3 | |
| Water | q.s. ad 1.0 | L |
| pH (adjusted with aq. ammonia and nitric acid) | 6.7 | |
| (Stabilizer) | | |
| p-Nonylphenoxypolyglycidol | 0.2 | |
| (glycidol av. polymn. deg. 10) | | |
| Ethylenediaminetetraacetic acid | 0.05 | |
| 1,2,4-Triazole | 1.3 | |
| 1,4-Bis(1,2,4-triazol-1-ylmethyl)piperazine | 0.75 | |
| Hydroxyacetic acid | 0.02 | |
| Hydroxyethylcellulose | 0.1 | |
| (Daicel Chemical Industries, Ltd. HEC SP-2000) | | |
| 1,2-Benzoisothiazolin-3-one | 0.05 | |
| Water | q.s. ad 1.0 | L |
| pH | 8.5. | |

The specified photographic speed of sample 101 determined by the above-mentioned method was ISO 2500.

(Preparation of samples 102 to 113)

Modification below was carried out for the sample 101. The equal mass of W-1 which was added to the 17^{th} layer (the second protective layer) was changed to the compound (B) shown in Table 5 and the compound (A) shown in Table 5 was added to the described layer to prepare the samples 102 to 113.

The evaluation of sensitivity measurement, charge adjusting ability test, high speed coating fitness test and storability was carried out for the above samples.

(Sensitivity)

The sensitivity of the respective samples was determined in the same manner as the fore-mentioned specific photo sensitivity.

(Evaluation of Charge Adjusting Ability Test)

Each of the samples was processed to 135 format, one stored in a film patrone (cartridge) was installed in a camera, high speed winding-up was carried out under environment of a temperature of 15° C. and a humidity of 15%, and after development was carried out by the under-mentioned treatment, fogging was visually observed.

(Evaluation of High Speed Coating Fitness Test)

The particle diameter of B-1 of the 17^{th} layer was changed to 3 μm, and after the solution was coated at 1 m/sec by a slide bead coating system, it was immediately dried and the number of splashes which were generated on the surface of the coating film was visually measured and indicated by the frequency of splashes. The frequency of splashes was that the number of splashes of each of the samples against the number of splashes of the sample 101 was shown by percentage, and when it was 100 or less, it was judges as effective for suppressing splashes.

(Evaluation of Storability)

Storability was evaluated by the difference (fog density) between the density of non exposure portion which was measured when a raw sample was left alone under forcible deterioration conditions of 50° C. and 60% for 14 days and the density of non exposure portion which was measured when it was not left alone under the forcible deterioration conditions.

Each of fog density in yellow density, magenta density and cyan density in each of the samples was measured and a value with the highest fog density among respective values was referred to as the evaluation value of the storability of each of the samples. The smaller the value is, the smaller the fog increase at aging is and preferable.

TABLE 5

| | Compound (A) | | | | | | specific | Static- | | Storage |
|---|---|---|---|---|---|---|---|---|---|---|
| Sample | | | Layer added and | | | Compound (B) | sensi- | induced | | Change |
| No. | Compound | Clog P | addition amount | | | 17th layer | tivity | fog*1 | Splash | of fog |
| 101 | — | — | — | — | — | W-1 | 2500 | ◯ | 100 | ±0 |
| Comp. | | | | | | Comp.compound | | | | |
| 102 | Cpd-8 | 8.6 | 3rd layer | 7th layer | 12th layer | — | 2800 | ◯ | 125 | +0.10 |
| Comp. | Comp.compound | | 0.015 g/m² | 0.032 g/m² | 0.032 g/m² | | | | | |
| 103 | Cpd-8 | 8.6 | 3rd layer | 7th layer | 12th layer | W-1 | 2800 | X | 151 | +0.12 |
| Comp. | Comp.compound | | 0.015 g/m² | 0.032 g/m² | 0.032 g/m² | Comp.compound | | | | |
| 104 | Cpd-8 | 8.6 | 3rd layer | 7th layer | 12th layer | W-14 | 2800 | X | 135 | +0.12 |
| Comp. | Comp.compound | | 0.015 g/m² | 0.032 g/m² | 0.032 g/m² | Comp.compound | | | | |
| 105 | Cpd-8 | 8.6 | 3rd layer | 7th layer | 12th layer | FA-4 | 2800 | ◯ | 115 | +0.10 |
| Comp. | Comp.compound | | 0.015 g/m² | 0.032 g/m² | 0.032 g/m² | | | | | |
| 106 | IV-13 | 9.1 | 6th layer | 11th layer | 15th layer | W-1 | 3150 | X | 135 | +0.01 |
| Comp. | | | 0.060 g/m² | 0.060 g/m² | 0.040 g/m² | Comp.compound | | | | |
| 107 | — | — | — | — | — | FA-4 | 2500 | X | 75 | ±0 |
| Comp. | | | | | | | | | | |
| 108 | (1) | −0.029 | 3rd layer | 16th layer | — | FA-4 | 3525 | ◯ | 88 | +0.03 |
| Inv. | | | 0.040 g/m² | 0.100 g/m² | | | | | | |
| 109 | IV-13 | 9.1 | 6th layer | 11th layer | 15th layer | FA-4 | 3375 | ◯ | 80 | +0.01 |
| Inv. | | | 0.060 g/m² | 0.060 g/m² | 0.040 g/m² | | | | | |
| 110 | V-2 | 12.4 | 6th layer | 11th layer | 15th layer | FA-4 | 3150 | ◯ | 82 | +0.02 |
| Inv. | | | 0.050 g/m² | 0.050 g/m² | 0.040 g/m² | | | | | |
| 111 | (1) | −0.03 | 3rd layer | 16th layer | — | FA-4 | 3775 | ◯ | 86 | +0.03 |
| Inv. | | | 0.040 g/m² | 0.100 g/m² | | | | | | |
| | IV-13 | 9.1 | 6th layer | 11th layer | 15th layer | | | | | |
| | | | 0.040 g/m² | 0.040 g/m² | 0.040 g/m² | | | | | |
| 112 | (18) | 8.7 | 6th layer | 11th layer | 15th layer | FB-1 | 3375 | ◯ | 77 | +0.02 |
| Inv. | | | 0.080 g/m² | 0.080 g/m² | 0.060 g/m² | | | | | |
| 113 | IV-46 | 6.0 | 6th layer | 11th layer | 15th layer | FC-2 | 3000 | ◯ | 75 | +0.02 |
| Inv. | | | 0.080 g/m² | 0.080 g/m² | 0.060 g/m² | | | | | |

*1◯: Static-induced fog was generated. X: static-induced fog was not generated.

The result of the sensitivity, charge adjusting ability property, high speed coating fitness and storability of the samples 101 to 113 is shown in Table 5.

It is grasped from Table 5 that a comparative compound Cpd-8 which is used for high sensitization is fragile in constitution in splashes and storability from the result of the sample 102, but it was cleared from the samples 103 and 104 that static-induced fog was generated in combination with surfactants W-1 and W-10 which were conventionally used, unexpectedly.

On the other hand, the compounds (A-1) and (A-2) which are used for high sensitization in the present invention cannot achieve the subject in the present invention by using in combination with a conventional surfactant compound W-1 as grasped from the result of the sample 106, but it was cleared from the samples 108 to 113 that remarkable effect appeared for static-induced fog, splashes and storability by using in combination with the compound (B) of the present invention, although they were high sensitivity.

Further, it was indicated in comparison of the sample 113 with the sample 109 of the present invention that the compound (IV-13 for IV-46) having a larger value of ClogP than 6 exhibited remarkable effect in the compound selected from the compound (A-2) of the present invention.

### EXAMPLE 2

Each of samples 201 to 207 was prepared in like manner as the samples 101 to 107 described in Example 1 except that the support was changed to a support shown below, and when evaluation was carried out in like manner as the method of Example 1, the samples of the invention exhibited also preferable results in the Example.

(i) First Layer and Undercoat Layer

Glow discharge was performed on the two surfaces of a 90-μm thick polyethylenenaphthalate support at a processing ambient pressure of 26.6 Pa, an H₂O partial pressure in the ambient gas of 75%, a discharge frequency of 30 kHz, an output of 2,500 W, and a processing intensity of 0.5 kV·A·min/m². One surface (back surface) of this support was coated with 5 mL/m² of a coating solution having the following composition as a first layer by using a bar coating method described in JP-B-58-4589, the disclosure of which is incorporated herein by reference.

| | | |
|---|---|---|
| Gelatin | 0.5 | parts by mass |
| Water | 49 | parts by mass |
| Polyglycerolpolyglycidyl ether | 0.16 | parts by mass |
| Poly(polymerization degree 20) | 0.1 | part by mass |
| oxyethylenesorbitanmonolaurate | | |

In addition, after the first layer was formed by coating, the support was wound on a stainless-steel core 20 cm in diameter and heated at 110° C. (Tg of PEN support: 119° C.) for 48 hr so as to be given thermal hysteresis, thereby performing annealing. After that, the side (emulsion surface side) of the support away from the first layer side was coated with 10 mL/m² of a coating solution having the following composition as an undercoat layer for emulsions, by using a bar coating method.

| | |
|---|---|
| Gelatin | 1.01 parts by mass |
| Salicylic acid | 0.30 parts by mass |
| Resorcin | 0.40 parts by mass |
| Poly(polymerization degree 10) | 0.11 parts by mass |
| oxyethylenenonylphenyl ether | |
| Water | 3.53 parts by mass |
| Methanol | 84.57 parts by mass |
| n-Propanol | 10.08 parts by mass |

Furthermore, second and third layers to be described later were formed in this order on the first layer by coating. Subsequently, the opposite side was coated with multiple layers of a color negative light-sensitive material having a composition to be described later, thereby making a transparent magnetic recording medium having silver halide emulsion layers.

(ii) Second Layer (Transparent Magnetic Recording Layer)

(1) Dispersion of Magnetic Substance

1,100 parts by mass of a Co-deposited γ-Fe₂O₃ magnetic substance (average long axis length: 0.25 μm, S_{BET}: 39 m²/g, Hc: 6.56×10⁴ A/m, as: 77.1 Am²/kg, or: 37.4 Am²/kg), 220 parts by mass of water, and 165 parts by mass of a silane coupling agent [3-(poly(polymerization degree 10)oxyethynyl)oxypropyl trimethoxysilane] were added and well kneaded for 3 hr by an open kneader. This coarsely dispersed viscous solution was dried at 70° C. for 24 hr to remove water and heated at 110° C. for 1 hr to form surface-treated magnetic grains.

These grains were again kneaded for 4 hr by the following formulation by using an open kneader.

| | |
|---|---|
| Above-mentioned surface-treated | 855 g |
| magnetic grains | |
| Diacetylcellulose | 25.3 g |
| Methylethylketone | 136.3 g |
| Cyclohexanone | 136.3 g |

The resultant material was finely dispersed at 2,000 rpm for 4 hr by the following formulation by using a sand mill (¼ G sand mill). Glass beads 1 mm in diameter were used as media.

| | |
|---|---|
| Above-mentioned kneaded solution | 45 g |
| Diacetylcellulose | 23.7 g |
| Methylethylketone | 127.7 g |
| Cyclohexanone | 127.7 g |

Furthermore, magnetic substance-containing intermediate solution was formed by the following formulation.

(2) Formation of Magnetic Substance-Containing Intermediate Solution

| | |
|---|---|
| Above-mentioned magnetic substance | 674 g |
| finely dispersed solution | |
| Diacetylcellulose solution | 24,280 g |
| (solid content 4.34%, solvent: | |
| methylethylketone/cyclohexanone = 1/1) | |
| Cyclohexanone | 46 g |

These materials were mixed, and the mixture was stirred by a disperser to form a “magnetic substance-containing intermediate solution”.

An α-alumina polishing material dispersion of the present invention was formed by the following formulation.

(a) Sumicorundum AA-1.5 (Average Primary Grain Size 1.5 μm, Specific Surface Area 1.3 m²/g)

Formation of Grain Dispersion

| | | |
|---|---|---|
| Sumikorandom AA-1.5 | 152 | g |
| Silane coupling agent KBM 903 | 0.48 | g |
| (manufactured by Shin-Etsu Silicone) | | |
| Diacetylcellulose solution | 227.52 | g |
| (solid content 4.5%, solvent: | | |
| methylethylketone/cyclohexanone = 1/1) | | |

The above formulation was finely dispersed at 800 rpm for 4 hr by using a ceramic-coated sand mill (¼ G sand mill). Zirconia beads 1 mm in diameter were used as media.

(b) Colloidal Silica Grain Dispersion (Fine Grains)

“MEK-ST” manufactured by Nissan Chemical Industries, Ltd. was used.

“MEK-ST” was a colloidal silica dispersion containing methylethylketone as a dispersion medium and having an average primary grain size of 0.015 um. The solid content is 30%.

(3) Formation of Second Layer Coating Solution

| | | |
|---|---|---|
| Above-mentioned magnetic substance- | 19,053 | g |
| containing intermediate solution | | |
| Diacetylcellulose solution | 264 | g |
| (solid content 4.5%, solvent: | | |
| methylethylketone/cyclohexanone = 1/1) | | |
| Colloidal silicon dispersion “MEK-ST” | 128 | g |
| [dispersion b] (solid content 30%) | | |
| AA-1.5 dispersion [dispersion a] | 12 | g |
| Millionate MR-400 (manufactured by | 203 | g |
| Nippon Polyurethane K.K.) diluted solution | | |
| (solid content 20%, diluent solvent: | | |
| methylethylketone/cyclohexanone = 1/1) | | |
| Methylethylketone | 170 | g |
| Cyclohexanone | 170 | g |

A coating solution formed by mixing and stirring the above materials was coated in an amount of 29.3 mL/m² by using a wire bar. The solution was dried at 110° C. The thickness of the dried magnetic layer was 1.0 μm.

(iii) Third layer (higher fatty acid ester slipping agent-containing layer)

(1) Formation of Undiluted Dispersion

A solution A presented below was dissolved at 100° C. and added to a solution B. The resultant solution mixture was dispersed by a high-pressure homogenizer to form an undiluted dispersion of a slipping agent.

Solution A

| | |
|---|---|
| Compound below | 399 parts by mass |
| C₆H₁₃CH(OH)(CH₂)₁₀COOC₅₀H₁₀₁ | |
| Compound below | 177 parts by mass |
| n-C₅₀H₁₀₁O(CH₂CH₂O)₁₆H | |
| Cyclohexanone | 830 parts by mass |

Solution B

| | |
|---|---|
| Cyclohexanone | 8,600 parts by mass |

(2) Formation of Spherical Inorganic Grain Dispersion

A spherical inorganic grain dispersion [c1] was formed by the following formulation.

| | |
|---|---|
| Isopropyl alcohol | 93.54 parts by mass |
| Silane coupling agent KBM903 | 5.53 parts by mass |
| (manufactured by Shin-Etsu Silicone) | |
| compound 1-1: | |
| (CH₃O)₃Si—(CR₂)₃—NH₂) | |
| Compound 1 | 2.93 parts by mass |
| 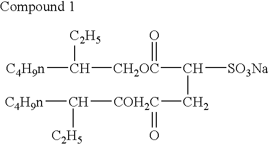 | |
| SEAHOSTAR KEP50 | 88.00 parts by mass |
| (amorphous spherical silica, | |
| average grain size 0.5 μm, | |
| manufactured by NIPPON SHOKUBAI Co., | |
| Ltd.) | |
| The above formulation was stirred | |
| for 10 mm, and the following was | |
| further added. | |
| Diacetone alcohol | 252.93 parts by mass |

Under ice cooling and stirring, the above solution was dispersed for 3 hr by using the “SONIFIER450 (manufactured by BRANSON K.K.)” ultrasonic homogenizer, thereby completing the spherical inorganic grain dispersion c1.

(3) Formation of Spherical Organic Polymer Grain Dispersion

A spherical organic polymer grain dispersion [c2] was formed by the following formulation.

| | |
|---|---|
| XC99-A8808 (manufactured by TOSHIBA SILICONE | 60 parts by mass |
| K.K., spherical crosslinked polysiloxane grain, | |
| average grain size 0.9 μm) | |
| Methylethylketone | 120 parts by mass |
| Cyclohexanone | 120 parts by mass |
| (solid content 20%, solvent: | |
| methylethylketone/cyclohexanone = 1/1) | |

Under ice cooling and stirring, the above solution was dispersed for 2 hr by using the “SONIFIER450 (manufactured by BRANSON K.K.)” ultrasonic homogenizer, thereby completing the spherical organic polymer grain dispersion c2.

(4) Formation of Third Layer Coating Solution

The following components were added to 542 g of the aforementioned slipping agent undiluted dispersion to form a third layer coating solution.

| | | |
|---|---|---|
| Diacetone alcohol | 5,950 | g |
| Cyclohexanone | 176 | g |
| Ethyl acetate | 1,700 | g |
| Above-mentioned SEEHOSTA KEP50 | 53.1 | g |
| dispersion [c1] | | |
| Above-mentioned spherical organic | 300 | g |
| polymer grain dispersion [c2] | | |
| FC431 | 2.65 | g |
| (manufactured by 3M K.K., solid content 50% | | |
| solvent: ethyl acetate) | | |
| BYK310 | 5.3 | g |
| (manufactured by BYK Chemi Japan K.K., | | |
| solid content 25%) | | |

The above third layer coating solution was coated in an amount of 10.35 mL/m² on the second layer, dried at 110° C., and further dried at 97° C. for 3 min.

What is claimed is:

1. A silver halide color photosensitive material comprising a support and, superimposed thereon, at least one red-sensitive layer, at least one green-sensitive layer, at least one blue-sensitive layer and at least one protective layer, containing at least one compound selected from the below defined compound (A-1) and/or (A-2) which does not substantially react with a developing agent oxidation product, and which is capable of substantially enhancing the sensitivity of the silver halide photosensitive material by addition thereof as compared with that exhibited when the compound is not added, and at least one compound represented by the below defined general formula (B),
compound (A-1): a heterocyclic compound having 1 or 2 hetero atoms; and
compound (A-2): a compound selected from an oxadiazole derivative, a thiadiazole derivative and 1,2,4-triazole derivative having an amino group, and
general formula (B): Rf-X-M
wherein Rf represents an alkyl group having 1 to 6 carbons which is substituted with at least one fluorine atom; X represents a divalent coupling group or a single bond; and M represents an anionic group, a cationic group or a betaine group.

2. The silver halide color photosensitive material according to claim 1, having an ISO sensitivity of 800 or more.

3. The silver halide color photosensitive material according to claim 1, wherein the ClogP of compound (A-2) is 6.2 or more.

4. The silver halide color photosensitive material according to claim 3, wherein the ClogP of compound (A-2) is 7.8 or more.

5. The silver halide color photosensitive material according to claim 4, having an ISO sensitivity of 800 or more.
